(19) United States
(12) Patent Application Publication
(10) Pub. No.: US 2026/0320781 A1
(43) Pub. Date: Oct. 15, 2026

(54) SYSTEMS AND METHODS FOR CELL MORPHOLOGY ANALYSIS

(71) Applicant: Deepcell, Inc., Menlo Park, CA (US)

(72) Inventors: Stéphane C. BOUTET, Burlingame, CA (US); Andreja JOVIC, Sunnyvale, CA (US); Cristian L. LUENGO HENDRIKS, Broomfield, CO (US); Anastasia MAVROPOULOS, Daly City, CA (US); Senzeyu ZHANG, San Francisco, CA (US); Ryan C. CARELLI, Jersey City, NJ (US); Kevin B. JACOBS, Beachwood, OH (US)

(21) Appl. No.: 19/384,165

(22) Filed: Nov. 10, 2025

Related U.S. Application Data
(63) Continuation of application No. PCT/US24/26761, filed on Apr. 29, 2024.
(60) Provisional application No. 63/502,044, filed on May 12, 2023.
(60) Provisional application No. 63/467,112, filed on May 17, 2023.
(60) Provisional application No. 63/546,373, filed on Oct. 30, 2023.
(60) Provisional application No. 63/615,859, filed on Dec. 29, 2023.

(51) Int. Cl. G06T 7/00; G06N 3/0464; G06T 7/155

(52) U.S. Cl. CPC G06T 7/0012; G06N 3/0464; G06T 7/155; G06T 2207/10056; G06T 2207/20081

(57) ABSTRACT

A method of processing images, comprises providing one or more cell images to a plurality of encoders comprising a machine learning encoder and a computer vision encoder; extracting a set of machine learning (ML)-based features using the machine learning encoder, and extracting a set of cell morphometric features using the computer vision encoder; and using the machine learning encoder and the computer vision encoder to respectively encode the set of ML-based features and the set of cell morphometric features into a plurality of multi-dimensional vectors that represent morphology of at least one cell in the one or more cell images.

### CROSS-REFERENCE TO RELATED APPLICATIONS

This application is a continuation of International Patent Application No. PCT/US24/26761, filed Apr. 29, 2024, which claims the benefit of U.S. Provisional Patent Application No. 63/502,044, filed May 12, 2023, U.S. Provisional Patent Application No. 63/467,112, filed May 17, 2023, U.S. Provisional Patent Application No. 63/546,373, filed Oct. 30, 2023, and U.S. Provisional Patent Application No. 63/615,859, filed Dec. 29, 2023, each of which is entirely incorporated by reference herein.

### BACKGROUND

Analysis of a cell (e.g., determination of a type or a state of the cell) may be accomplished by examining, for example, one or more fluorescent images of the cell or sequencing data of the cell (e.g., gene fragment analysis, whole-genome sequencing, whole-exome sequencing, RNA-seq, etc.). Such methods may be used to identify cell type (e.g., stem cell or differentiated cell) or cell state (e.g., healthy or disease state). In some examples, cells may be directed through a flow channel for at least a portion of the analysis.

### SUMMARY

Examples herein provide systems and methods for cell morphology analysis. Provided below are several examples that may be employed in any combination to achieve the benefits as described herein.

Example 1. A method of processing images, comprising:
providing one or more cell images to a plurality of encoders comprising a machine learning encoder and a computer vision encoder;
extracting a set of machine learning (ML)-based features using the machine learning encoder, and extracting a set of cell morphometric features using the computer vision encoder; and
using the machine learning encoder and the computer vision encoder to respectively encode the set of ML-based features and the set of cell morphometric features into a plurality of multi-dimensional vectors that represent morphology of at least one cell in the one or more cell images.

Example 2. The method of example 1, wherein the machine learning encoder comprises a deep learning encoder.

Example 3. The method of example 1, wherein the plurality of multi-dimensional vectors comprises different numbers of the ML-based features and the cell morphometric features.

Example 4. The method of example 1, wherein the plurality of multi-dimensional vectors comprises a same number each of the ML-based features and the cell morphometric features.

Example 5. The method of any one of examples 1 to 5, wherein the ML-based features are not human-interpretable.

Example 6. The method of any one of examples 1 to 6, wherein the cell morphometric features are human-interpretable.

Example 7. The method of example 6, wherein the cell morphometric features comprise cell position, cell shape, pixel intensity, texture, focus, or any combination thereof.

Example 8. The method of any one of examples 1 to 7, wherein cells in the one or more cell images are unstained.

Example 9. The method of any one of examples 1 to 8, wherein the one or more cell images are brightfield cell images.

Example 10. The method of any one of examples 1 to 9, wherein the machine learning encoder uses a convolutional neural network or a vision transformer.

Example 11. The method of any one of examples 1 to 10, wherein the computer-vision encoder uses a human-constructed algorithm.

Example 12. The method of any one of examples 1 to 11, wherein the machine learning encoder extracts n ML-based features, the computer-vision encoder extracts m cell morphometric features, wherein the multi-dimensional vectors have n+m dimensions, and wherein n and m are positive integers.

Example 13. The method of example 12, wherein within each of the multi-dimensional vectors, each dimension of the n+m dimensions is an element of that multi-dimensional vector.

Example 14. The method of example 13, wherein the element is a numeric value.

Example 15. The method of any one of examples 1 to 14, wherein the ML-based features are orthogonal to one another.

Example 16. The method of any one of examples 1 to 15, wherein the ML-based features are orthogonal to the cell morphometric features.

Example 17. The method of any one of examples 1 to 16, wherein the cell morphometric features are selected from the group consisting of position features, cell shape features, pixel intensity features, texture features, and focus features.

Example 18. The method of example 17, wherein the position features are selected from the group consisting of: centroid X axis and centroid Y axis.

Example 19. The method of example 17 or example 18, wherein the cell shape features are selected from the group consisting of: area, perimeter, maximum caliper distance, minimum caliper distance, maximum radius, minimum radius, long ellipse axis, short ellipse axis, ellipse elongation, ellipse similarity, roundness, circle similarity, and convex shape.

Example 20. The method of any one of examples 17 to 19, wherein the pixel intensity features are selected from the group consisting of: mean pixel intensity, standard deviation of pixel intensity, pixel intensity 25th percentile, pixel intensity 75th percentile, positive fraction, and negative fraction.

Example 21. The method of any one of examples 17 to 20, wherein the texture features are selected from the group consisting of: small set of connected bright pixels, integral; small set of connected dark pixels, integral; large set of connected bright pixels, integral; large set of connected dark pixels, integral; image moments; local binary patterns-center; local binary patterns-periphery; image sharpness; image focus; ring width; and ring intensity.

Example 22. A method of processing, the method comprising:
using a machine learning encoder to extract a set of machine learning (ML)-based features from a cell image;
using a computer vision encoder to extract a set of cell morphometric features from the cell image; and
using the set of ML-based features and the set of cell morphometric features to generate a feature vector that represents morphology of the cell.

Example 23. A method for assessing, the method comprising:
extracting, from image data of a plurality of cells, a multi-dimensional vector for a cell of the plurality of cells, wherein the multi-dimensional vector comprises (i) a set of machine-learning (ML)-based features extracted using a machine learning encoder and (ii) a set of cell morphometric features extracted using a computer vision encoder;
reducing a dimensionality of the multi-dimensional vector to generate a lower dimensional vector; and
using at least in part the lower-dimensional vector to assess a similarity between the cell and an additional cell of the plurality of cells.

Example 24. The method of example 23, wherein the similarity is assessed in a feature space corresponding to the lower-dimensional vector.

Example 25. The method of example 23 or example 24, wherein the dimensionality of the multi-dimensional vector is reduced using a dimension reduction technique.

Example 26. The method of example 25, wherein the dimension reduction technique is selected from the group consisting of missing value ratio, low variance filter, high correlation filter, random forest, backward feature elimination, forward feature selection, factor analysis, principal component analysis (PCA), independent component analysis, methods based on projections, t-distributed stochastic neighbor embedding (t-SNE), and uniform manifold approximation and projection (UMAP).

Example 27. The method of example 26, wherein the dimension reduction technique is PCA.

Example 28. The method of any one of examples 23 to 27, wherein the lower-dimensional vector comprises three or more dimensions.

Example 29. The method of any one of examples 23 to 28, further comprising generating, using at least in part on the assessing, a cell cluster map comprising a plurality of shapes representing the plurality of cells, wherein the plurality of shapes is arranged in a plurality of clusters using at least the similarity.

Example 30. The method of example 29, wherein the lower-dimensional vector and the cell cluster map are generated by using different dimension reduction techniques.

Example 31. The method of example 29 or example 30, wherein the cell cluster map is generated by using UMAP.

Example 32. The method of any one of examples 29 to 31, further comprising standardizing the multi-dimensional vector via a feature scaling technique.

Example 33. The method of example 32, wherein the feature scaling technique is selected from the group consisting of min-max normalization, mean normalization, and z-score normalization.

Example 34. The method of any one of examples 23 to 33, wherein the image data comprises a label free image of each of the plurality of cells.

Example 35. A method of classifying, the method comprising:
extracting, from image data of a plurality of cells, a multi-dimensional vector for each cell of the plurality of cells, wherein the multi-dimensional vector comprises (i) a set of machine-learning (ML)-based features extracted via a machine learning encoder and (ii) a set of cell morphometric features extracted via a computer vision encoder; and
using at least in part the one or more ML-based features and the morphometric features to classify the plurality of cells into a plurality of subsets of melanoma cells comprising a first subset with a first level of cell pigmentation and a second subset with a second level of cell pigmentation, wherein the first level and the second level are different.

Example 36. The method of example 35, further comprising automatically generating a cell cluster map comprising a plurality of shapes representing the plurality of cells, wherein the plurality of shapes is arranged in a plurality of clusters that corresponds to the plurality of subsets of melanoma cells.

Example 37. The method of example 35 or example 36, further comprising sorting the first subset and the second subset into different sub-channels of a flow channel in fluid communication with the plurality of cells.

Example 38. The method of any one of examples 35 to 37, wherein the image data comprises a label-free image of each of the plurality of cells.

Example 39. A method of processing one or more cell images, comprising:
providing the one or more cell images to a plurality of encoders comprising a machine learning encoder and a computer vision encoder;
extracting a set of machine learning (ML)-based features via the machine learning encoder, and extracting a set of cell morphological features via the computer vision encoder; and
using the machine learning encoder and the computer vision encoder to respectively encode the set of ML-based features and the set of cell morphological features into a plurality of multi-dimensional vectors that represent morphology of at least one cell in the one or more cell images.

Example 40. The method of example 39, wherein the machine learning encoder comprises a deep learning encoder.

Example 41. The method of example 39, wherein the plurality of multi-dimensional vectors comprise different numbers of the ML-based features and the cell morphological features.

Example 42. The method of example 39, wherein the plurality of multi-dimensional vectors comprise a same number each of the ML-based features and the cell morphological features.

Example 43. A method for assessing similarity between cells, the method comprising:
(a) obtaining image data of a plurality of cells;
(b) extracting, from the image data, a multi-dimensional vector for a cell of the plurality of cells, wherein the multi-dimensional vector comprises a plurality of vectors, and each vector of the multi-dimensional vector represents a unique morphological information of the cell;
(c) reducing a dimensionality of the multi-dimensional vector to generate a lower-dimensional vector; and

(d) using at least in part the lower-dimensional vector to assess a similarity between the cell and an additional cell of the plurality of cells.

Example 44. The method of example 43, wherein the similarity is assessed in a feature space corresponding to the lower-dimensional vector.

Example 45. The method of any one of examples 43 to 44, wherein, in (c), the dimensionality of the multi-dimensional vector is reduced using a dimension reduction technique.

Example 46. The method of any one of examples 43 to 45, wherein the dimension reduction technique is selected from the group consisting of missing value ratio, low variance filter, high correlation filter, random forest, backward feature elimination, forward feature selection, factor analysis, principal component analysis (PCA), independent component analysis, methods based on projections, t-distributed stochastic neighbor embedding (t-SNE), and uniform manifold approximation and projection (UMAP).

Example 47. The method of any one of examples 43 to 46, wherein the dimension reduction technique is PCA.

Example 48. The method of any one of examples 43 to 47, wherein the lower-dimensional vector comprises three or more dimensions.

Example 49. The method of any one of the preceding claims, further comprising generating, using at least in part on the assessing, a cell cluster map comprising a plurality of shapes representing the plurality of cells, wherein the plurality of shapes is arranged in a plurality of clusters based on the similarity.

Example 50. The method of example 49, wherein the lower-dimensional vector and the cell cluster map are generated by using different dimension reduction techniques.

Example 51. The method of claim 49 or example 50, wherein the cell cluster map is generated by using UMAP.

Example 52. The method of any one of examples 43 to 51, wherein the multi-dimensional vector comprises (i) a set of machine-learning (ML)-based features extracted via a machine learning encoder and/or (ii) a set of cell morphological features extracted via a computer vision encoder.

Example 53. The method of any one of examples 43 to 52, further comprising, prior to (c), standardizing the multi-dimensional vector via a feature scaling technique.

Example 54. The method of example 53, wherein the feature scaling technique is selected from the group consisting of min-max normalization, mean normalization, and z-score normalization.

Example 55. The method of any one of examples 43 to 54, wherein the image data comprises a label-free image of each of the plurality of cells.

Example 56. A method classifying a plurality of cells, the method comprising:
(a) obtaining image data of the plurality of cells;
(b) processing the image data to extract one or more machine learning (ML)-based features associated with the plurality of cells; and
(c) using at least in part the one or more ML-based features to classify the plurality of cells into a plurality of subsets of melanoma cells comprising a first subset with a first level of cell pigmentation and a second subset with a second level of cell pigmentation, wherein the first level and the second level are different.

Example 57. The method of example 56, further comprising automatically generating a cell cluster map comprising a plurality of shapes representing the plurality of cells, wherein the plurality of shapes is arranged in a plurality of clusters that corresponds to the plurality of subsets of melanoma cells.

Example 58. The method of examples 56 to 57, further comprising sorting the first subset and the second subset into different sub-channels of a flow channel in fluid communication with the plurality of cells.

Example 59. The method of any one of examples 56 to 58, wherein the ML-based feature comprises a plurality of different ML-based features.

Example 60. The method of any one of examples 56 to 59, wherein the extracting is performed by a ML encoder.

Example 61. The method of any one of examples 56 to 60, further comprising:
in (b), extracting a morphological feature via a computer vision encoder; and
in (c), using the ML-based features and the morphological feature to classify the plurality of cells into the plurality of subsets of melanoma cells.

Example 62. The method of example 61, wherein the morphological features comprise a plurality of different morphological features.

Example 63. The method of any one of examples 56 to 62, wherein the image data comprises a label-free image of each of the plurality of cells.

Example 64. A method of processing, the method comprising:
using a machine learning encoder to extract respective sets of machine learning (ML)-based features from respective images of cells having Clustered Regularly Interspaced Short Palindromic Repeats (CRISPR) perturbations;
using a computer vision encoder to extract respective sets of cell morphometric features from the respective images;
using the respective sets of ML-based features and the respective sets of cell morphometric features to generate respective multi-dimensional feature vectors that represent morphologies of the cells; and
using the respective feature vectors to screen the CRISPR perturbations.

Example 65. The method of example 64, wherein the images are of viable cells.

Example 66. The method of example 64 or example 65, wherein the images are of unstained cells.

Example 67. The method of any one of examples 64 to 66, wherein cells of a first subset of the cells have a first CRISPR perturbation, and wherein cells of a second subset of the cells lack the first CRISPR perturbation.

Example 68. The method of example 67, wherein the cells of the second subset of the cells have a second CRISPR perturbation that is different from the first CRISPR perturbation.

Example 69. The method of any one of examples 64 to 68, further comprising:
reducing dimensionalities of the multi-dimensional feature vectors to generate lower-dimensional vectors; and
using the lower-dimensional vectors to screen the CRISPR perturbations.

Example 70. The method of any one of examples 64 to 69, further comprising:
flowing the cells through a microfluidic platform; and
generating the respective images of the cells within the microfluidic platform.

Example 71. The method of example 70, further comprising collecting the cells after generating the respective images of the cells.

Example 72. The method of example 70 or example 71, further comprising sorting the cells into a plurality of collection wells using morphologies of the cells.

Example 73. The method of example 72, further comprising performing cell-level phenotyping on the sorted cells.

Example 74. The method of example 73, wherein the cell-level phenotyping comprises a multi-omic assay.

Example 75. The method of any one of examples 72 to 74, further comprising performing single-cell RNA sequencing on the sorted cells.

Example 76. The method of any one of examples 64 to 75, further comprising functionally screening the cells.

Example 77. The method of any one of examples 64 to 76, further comprising identifying genes or proteins that are common in a selected population of the cells and not in other cells.

Example 78. The method of example 77, wherein identifying the genes or proteins comprises using genomics data, transcriptomics data, proteomics data, or metabolomics data.

Example 79. The method of any one of examples 64 to 78, wherein the respective images are brightfield cell images.

Example 80. The method of any one of examples 64 to 79, wherein the machine learning encoder uses a convolutional neural network.

Example 81. The method of any one of examples 64 to 80, wherein the computer-vision encoder uses a human-constructed algorithm.

Example 82. The method of any one of examples 64 to 81, wherein the machine learning encoder extracts n ML-based features, the computer-vision encoder extracts m cell morphological features, and wherein the multi-dimensional vectors have n+m dimensions.

Example 83. The method of example 82, wherein within each of the multi-dimensional vectors, each dimension of the n+m dimensions is an element of that multi-dimensional vector.

Example 84. The method of example 83, wherein the element is a numeric value.

Example 85. The method of any one of examples 64 to 84, wherein the ML-based features are orthogonal to one another.

Example 86. The method of any one of examples 64 to 85, wherein the ML-based features are orthogonal to the cell morphological features.

Example 87. The method of any one of examples 64 to 86, wherein the cell morphometric features are selected from the group consisting of position features, cell shape features, pixel intensity features, texture features, and focus features.

Example 88. A method of processing, the method comprising:
using a machine learning encoder to extract respective sets of machine learning (ML)-based features from respective images of non-viable cells in different states than one another;
using a computer vision encoder to extract respective sets of cell morphometric features from the respective images;
using the respective sets of ML-based features and the respective sets of cell morphometric features to generate respective multi-dimensional feature vectors that represent morphologies of the cells; and
using the respective feature vectors to characterize the states of the non-viable cells.

Example 89. The method of example 88, wherein the non-viable cells are undergoing necrosis, are in an early apoptotic state, or are in a late apoptotic state.

Example 90. The method of example 88 or example 89, wherein the images are of unstained cells.

Example 91. The method of any one of examples 88 to 90, further comprising:
reducing dimensionalities of the multi-dimensional feature vectors to generate lower-dimensional vectors; and
using the lower-dimensional vectors to characterize the states of the non-viable cells.

Example 92. The method of any one of examples 88 to 91, further comprising:
flowing the cells through a microfluidic platform; and generating the respective images of the cells within the microfluidic platform.

Example 93. The method of example 92, further comprising collecting the cells after generating the respective images of the cells.

Example 94. The method of example 92 or example 93, further comprising sorting the cells into a plurality of collection wells using morphologies of the cells.

Example 95. The method of example 94, further comprising performing cell-level phenotyping on the sorted cells.

Example 96. The method of example 95, wherein the cell-level phenotyping comprises a multi-omic assay.

Example 97. The method of any one of examples 94 to 96, further comprising performing single-cell RNA sequencing on the sorted cells.

Example 98. The method of any one of examples 88 to 97, further comprising functionally screening the cells.

Example 99. The method of any one of examples 88 to 98, further comprising identifying genes or proteins that are common in a selected population of the cells and not in other cells.

Example 100. The method of example 99, wherein identifying the genes or proteins comprises using genomics data, transcriptomics data, proteomics data, or metabolomics data.

Example 101. The method of any one of examples 88 to 100, wherein the respective images are brightfield cell images.

Example 102. The method of any one of examples 88 to 101, wherein the machine learning encoder uses a convolutional neural network.

Example 103. The method of any one of examples 88 to 102, wherein the computer-vision encoder uses a human-constructed algorithm.

Example 104. The method of any one of examples 88 to 103, wherein the machine learning encoder extracts n ML-based features, the computer-vision encoder extracts m cell morphological features, and wherein the multi-dimensional vectors have n+m dimensions.

Example 105. The method of example 104, wherein within each of the multi-dimensional vectors, each dimension of the n+m dimensions is an element of that multi-dimensional vector.

Example 106. The method of example 105, wherein the element is a numeric value.

Example 107. The method of any one of examples 88 to 106, wherein the ML-based features are orthogonal to one another.

Example 108. The method of any one of examples 88 to 107, wherein the ML-based features are orthogonal to the cell morphological features.

Example 109. The method of any one of examples 88 to 108, wherein the cell morphometric features are selected from the group consisting of position features, cell shape features, pixel intensity features, texture features, and focus features.

Additional aspects, examples, and advantages of the present disclosure will become readily apparent to those skilled in this art from the following detailed description, wherein only illustrative examples of the present disclosure are shown and described. As will be realized, the present disclosure is capable of other and different examples, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in their entirety. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

Certain features of the examples described herein are set forth with particularity in the appended claims. A better understanding of the features and advantages of the present examples will be obtained by reference to the following detailed description that sets forth illustrative examples, in which the principles of the present disclosure are utilized, and the accompanying drawings (“FIG.” herein), of which:

FIG. 1 illustrates an example workflow of extracting features associated with cell morphology from cell images using the human foundation model, in accordance with some examples of the present disclosure.

FIG. 2A illustrates cell classes, numbers of images used as training dataset to train a classifier using features extracted using the human foundation model, numbers of images processed by the human foundation model as test dataset, and corresponding representative cell images, in accordance with some examples of the present disclosure.

FIG. 2B illustrates an example morphology Uniform Manifold Approximation and Projections (UMAP) of different cell lines and polystyrene beads as control, in accordance with some examples of the present disclosure.

FIG. 2C illustrates an example confusion matrix between predicted cell classes classified using features extracted using the human foundation model and actual cell classes, in accordance with some examples of the present disclosure.

FIG. 2D illustrates example density plots of four differential features generated by the human foundation model for different cell lines and polystyrene beads as control, in accordance with some examples of the present disclosure.

FIG. 3 illustrates an example system for cell morphology analysis, in accordance with some examples of the present disclosure.

FIG. 4 illustrates an example interaction between a microfluidic platform, the human foundation model, and the data suite, in accordance with some examples of the present disclosure.

FIG. 5 illustrates an example system for cell morphology analysis, in accordance with some examples of the present disclosure.

FIG. 6A illustrates an example workflow from high-throughput imaging to cell characterization, classification and sorting based on cell morphology analysis, in accordance with some examples of the present disclosure.

FIG. 6B illustrates another example workflow from sample preparation to cell characterization and sorting based on cell morphology profiling, in accordance with some examples of the present disclosure.

FIG. 7 illustrates example characterization of cancer cells based on cell morphology profiling, in accordance with some examples of the present disclosure.

FIG. 8A illustrates an example morphology UMAP from cell image feature embeddings colored by cell types, in accordance with some examples of the present disclosure.

FIG. 8B illustrates an example morphology UMAP colored by cluster imputed using Leiden algorithm, with randomly selected representative images from each cluster shown, in accordance with some examples of the present disclosure.

FIG. 9A illustrates an example morphology UMAP of a heterogeneous collection of melanoma cell lines and immune/stromal cells derived from patient biopsies in consistency with FIG. 8A, in accordance with some examples of the present disclosure.

FIG. 9B illustrates an example re-projected morphology UMAP using filtered data from FIG. 9A showing only melanoma cells colored by cell lines, in accordance with some examples of the present disclosure.

FIG. 9C illustrates an example morphology UMAP colored by cluster imputed using Leiden algorithm, with randomly selected representative images from each cluster shown and pixel density plot of three selected clusters, in accordance with some examples of the present disclosure.

FIG. 10A illustrates an example morphology UMAP of cells based on multi-dimensional embeddings where the cells resided in a NSCLC DTC biopsy sample, in accordance with some examples of the present disclosure.

FIG. 10B illustrates six example morphologically distinct clusters isolated by the platform as described herein via user-defined sorting and processed for copy number variation (CNV) profiling, in accordance with some examples of the present disclosure.

FIG. 11A illustrates example bulk RNA-sequence analysis of cells resided in a NSCLC DTC biopsy sample, in accordance with some examples of the present disclosure.

FIG. 11B illustrates example principal component analysis (PCA) performed on each morphology cluster, in accordance with some examples of the present disclosure.

FIG. 12 illustrates an example flow of operations in a method of processing images.

FIG. 13 illustrates an example flow of operations in a method for assessing.

FIG. 14 illustrates an example flow of operations in a method for classifying.

FIG. 15 schematically illustrates an example method for classifying a cell.

FIG. 16 schematically illustrates, in one example, different ways of representing analysis data of image data of cells.

FIG. 17 schematically illustrates, in one example, different representations of analysis of image data of a population of cells.

FIG. 18 schematically illustrates, in one example, a method for a user to interact with a method for analyzing image data of cells.

FIG. 19 schematically illustrates, in one example, a cell analysis platform for analyzing image data of one or more cells.

FIG. 20 schematically illustrates, in one example, an example microfluidic system for sorting one or more cells.

FIGS. 21A-21F schematically illustrate, in one example, an example system for classifying and sorting one or more cells.

FIGS. 22A-22E schematically illustrate operations that may be performed in an example method.

FIG. 23 shows a computer system, in one example, that is programmed or otherwise configured to implement methods provided herein.

### DETAILED DESCRIPTION

While various examples provided herein have been shown and described herein, it will be obvious to those skilled in the art that such examples are provided by way of illustration only. Numerous variations, changes, and substitutions may occur to those skilled in the art without departing from the present disclosure. It should be understood that various alternatives to the examples of the present disclosure described herein may be employed.

Unless defined otherwise, all technical and scientific terms used herein have the same meaning as commonly understood by one of ordinary skill in the art to which the present disclosure belongs. In case of conflict, the present application including the definitions will control. Also, unless otherwise required by context, singular terms shall include pluralities and plural terms shall include the singular.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to about 1, about 2, or about 3 is equivalent to greater than or equal to about 1, greater than or equal to about 2, or greater than or equal to about 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to about 3, about 2, or about 1 is equivalent to less than or equal to about 3, less than or equal to about 2, or less than or equal to about 1.

The term “morphology” or “morphological characteristic” or “morphological feature” of a cell as used herein generally refers to the form, structure, and/or configuration of the cell. The term “morphometric feature” is intended to refer to a quantitative representation of a morphological feature of a cell, and in some cases the terms “morphological feature” and “morphometric feature” are used interchangeably herein. The morphology of a cell may comprise one or more aspects of a cell's appearance, such as, for example, shape, size, arrangement, form, structure, pattern(s) of one or more internal and/or external parts of the cell, or shade (e.g., color, greyscale, etc.). Non-limiting examples of a shape of a cell may include, but are not limited to, circular, elliptic, shmoo-like, dumbbell, star-like, flat, scale-like, columnar, invaginated, having one or more concavely formed walls, having one or more convexly formed walls, prolongated, having appendices, having cilia, having angle(s), having corner(s), etc. A morphological feature of a cell may be visible with treatment of a cell (e.g., small molecule or antibody staining). In another example, the morphological feature of the cell need not require any treatment to be visualized in an image or video.

The terms “unstructured” or “unsorted,” as used interchangeably herein, generally refers to a mixture of cells (e.g., an initial mixture of cells) that is not substantially sorted (or rearranged) into separate partitions. An unstructured population of cells may comprise at least two types of cells that may be distinguished by exhibiting different properties (e.g., one or more physical properties, such as one or more different morphological characteristics as disclosed herein). The unstructured population of cells may be a random (or randomized) mixture of the at least two types of cells. The cells as disclosed herein may be viable cells. A viable cell, as disclosed herein, may be a cell that is not undergoing necrosis or a cell that is not in an early or late apoptotic state. Assays for determining cell viability may include, e.g., as using propidium iodide (PI) staining which may be detected by flow cytometry. In another example, the cells need not be viable (e.g., fixed cells).

A “viable cell” as disclosed herein may be characterized by exhibiting one or more characteristics (e.g., morphology, one or more gene expression profiles, etc.) that is substantially unaltered (or that is not substantially impacted by) by any operation or process of the methods disclosed herein (e.g., partitioning). In some examples, a characteristic of a viable cell may be a gene transcript accumulation rate, which may be characterized by a change in transcript levels of a same gene (e.g., a same endogenous gene) between mother and daughter cells over the time between cell divisions, as ascertained by single cell sequencing, polymerase chain reaction (PCR), etc.

The term, “high throughput”, when referring to a platform, system, model, and the like, means that such a platform, system, model, etc., is capable of generating an embedding for at least one image within a desired time, such as but not limited to approximately 5 ms to 30 ms. In some aspects, a high-throughput setting may also include components to process approximately 10,000 frames/see and/or approximately 1000 images/see while being configured to correct per-pixel variation in background offset, camera gain, and/or illumination for the processed frames. As used herein, “high-throughput” systems may require relatively low-latency.

Relative terms, such as “about,” “substantially,” or “approximately” are used to include small variations with specific numerical values (e.g., +/−x %,), as well as including the situation of no variation (+/−0%). In some examples, the numerical value x is less than or equal to 10—e.g., less than or equal to 5, to 2, to 1, or smaller, including 0.

The term “real time” or “real-time,” as used interchangeably herein, generally refers to an event (e.g., an operation, a process, a method, a technique, a computation, a calculation, an analysis, an optimization, etc.) that is performed using recently obtained (e.g., collected or received) data. Examples of the event may include, but are not limited to, analysis of a one or more images of a cell to classify the cell, updating one or more deep learning algorithms (e.g., neural networks) for classification and sorting, controlling actuation of one or more valves by at a sorting bifurcation, etc. In some examples, a real time event may be performed almost immediately or within a short enough time span, such as within at least about 0.0001 ms, for example at least about 0.0005 ms, at least about 0.001 ms, at least about 0.005 ms, at least about 0.01 ms, at least about 0.05 ms, at least about 0.1 ms, at least about 0.5 ms, at least about 1 ms, at least about 5 ms, at least about 0.01 seconds, at least about 0.05 seconds, at least about 0.1 seconds, at least about 0.5 seconds, at least about 1 second, or more. In some examples, a real time event may be performed almost immediately or within a short enough time span, such as within at most about 1 second, for example at most about 0.5 seconds, at most about 0.1 seconds, at most about 0.05 seconds, at most about 0.01 seconds, at most about 5 ms, at most about 1 ms, at most about 0.5 ms, at most about 0.1 ms, at most about 0.05 ms, at most about 0.01 ms, at most about 0.005 ms, at most about 0.001 ms, at most about 0.0005 ms, at most about 0.0001 ms, or less. In some examples, any of the operations of a computer processor as provided herein may be performed (e.g., automatically performed) in real-time.

As used herein, an “encoder” refers to a type of model that transforms or “encodes” an image into a vector. Nonlimiting examples of encoders include machine learning-based models, and computer vision models.

### Overview

Morphology is an important cell property associated with identity, state, and function, but in some instances it is characterized crudely in a few standard dimensions such as diameter, perimeter, or area, or with subjective qualitative descriptions. In comparison, the present disclosure provides a method of processing that includes using a machine learning encoder to extract a set of ML-based features from a cell images, using a computer vision encoder to extract a set of cell morphometric features from the cell image, and using the set of ML-based features and the set of cell morphometric features to generate a feature vector that represents morphology of the cell. The feature vector may be used in a variety of practical applications, e.g., in a manner such as described in the nonlimiting examples provided herein.

In one example, tumors are composed of heterogeneous assortments of cells with distinct genetic and phenotypic characteristics that may drive therapeutic resistance, immune evasion, and disease progression. The advent of single cell technologies has enabled deep profiling of individual cells within a tumor microenvironment, leading to a better understanding of tumor biology and subsequently more effective cancer treatment strategies. While profiling technologies such as flow cytometry and single cell sequencing yields insight on tumor composition, cells are sometimes no longer amenable to additional downstream studies after being subjected to antibody staining or destructive analytical processes such as cell lysis. Current sorting methods such as fluorescence-activated cell sorting (FACS) rely on a limited set of biomarkers, which may not cover the full extent or be readily available for all distinct cell properties. Additionally, dependence on antibodies, dyes/stains, and biomarkers to denote cell identity may inadvertently create sampling bias by depleting biomarker-negative but potentially biologically interesting cell populations.

Cell morphology information has historically been used for cell and disease characterization but has been difficult to objectively and reproducibly quantify. Cell morphology in many instances is studied qualitatively through microscopes, which may be inherently slow, difficult to scale, and relies on human interpretation.

The present disclosure provides multi-dimensional morphology analysis (e.g., profiling) enabled by machine learning and computer vision morphometrics. The present disclosure has the benefit of enabling higher resolution and biological insight while reducing labor-intensive cell processing manipulations. The multi-dimensional morphology profiling and sorting of unlabeled single cells using machine learning, advanced imaging, and microfluidics may be used to assess population heterogeneity beyond biomarkers.

In some examples, the present disclosure provides a method for cell morphology analysis. In some examples, the method may combine deep learning and computer vision methods to extract features from cell images. A deep learning model used in the method may provide quantitative descriptions of cell features using one or more neural network. A computer vision model used in the method may provide a quantitative assessment of cell and biological features using discrete image analysis algorithms. The method as described herein may allow for extracting and interpreting cell morphology features with a multidimensional, unbounded, and quantitative assessment.

In some examples, the present disclosure provides a system for cell morphology analysis. In some examples, the system may comprise a benchtop single-cell imaging and sorting system for high-dimensional morphology analysis. The system may combine label-free imaging, deep learning, computer vision morphometrics, and gentle cell sorting to leverage multidimensional single cell morphology as a quantitative readout. The system may capture high-resolution brightfield cell images, from which features (e.g., dimensional embedding vectors) may be extracted representing the morphology of the cells.

The system and method may combine label-free imaging, deep learning, computer vision morphometrics, and gentle cell sorting to harness multi-dimensional single cell morphology as a quantitative biological readout. The systems and methods disclosed herein have a variety of potential uses. For example, the combination of deep learning and computer vision morphometrics may allow cell characterization and sorting based on multi-dimensional morphometric and deep learning derived features, which may be used to identify and enrich cancer cells in heterogeneous populations. Quantitative multi-dimensional morphology information at single cell level may provide additional information to resolve cancer heterogeneity. The system and method may extract pigmentation features from the morphology profiling and based on which, assess melanoma cells. Cell populations may be characterized with specific morphological profiles have distinct molecular profiles, and morphologically distinct cells (e.g., normal vs. tumor) may be distinguished over each other.

The system and method may provide a relatively fast workflow for cell morphology analysis. For example, it may only take a few hours from preparing cell samples to generating publishable figures representing cell morphology. The systems and methods may be used in a variety of applications including but not limited to cancer research, developmental biology, cell and gene therapies, and drug and functional screening. In some examples, the systems and methods as described herein may be used in drug and Clustered Regularly Interspaced Short Palindromic Repeats (CRISPR) perturbation screening, using cell morphology as a novel biomarker for the screening. The systems and methods as described herein may be used in sample-level profiling, including but not limited to heterogeneous sample evaluation and characterization, disease detection and enrichment, and sample clean-up. In other examples, the systems and methods as described herein may be used in cell-level phenotyping, including cell health status, cell state characterization, and multi-omic integration.

### Human Foundation Model (HFM)

In some examples the present disclosure may provide a human foundation model (“HFM”) for cell morphology analysis (e.g., profiling). The human foundation model may combine a deep learning model and a computer vision model and extract cell features from cell images. In some examples, the deep learning model may process cell images as input and provide quantitative descriptions of cell features. The deep learning model may extract deep learning features that are information-rich metrics of cell morphology with powerful discriminative capabilities. The deep learning features may not be human-interpretable. The computer vision model may process cell images as input and provide morphometric features that are human-interpretable, quantitative metrics of cell morphology including cell size, shape, texture, and intensity. The morphometrics may be computationally generated using discrete computer vision algorithms. When some of the morphometrics are too computationally intensive to compute in real time, the deep learning model may overcome the limitation of the computer vision model by imputing the most computationally intensive morphometrics into the human foundation model. By combining deep learning and morphometric features, the human foundation model as described herein may provide both accuracy and interpretability in real-time feature extraction, cell classification and sorting. The human foundation model may also have strong generalization capabilities that enable hypothesis-free sample exploration and efficient generation of application-specific models.

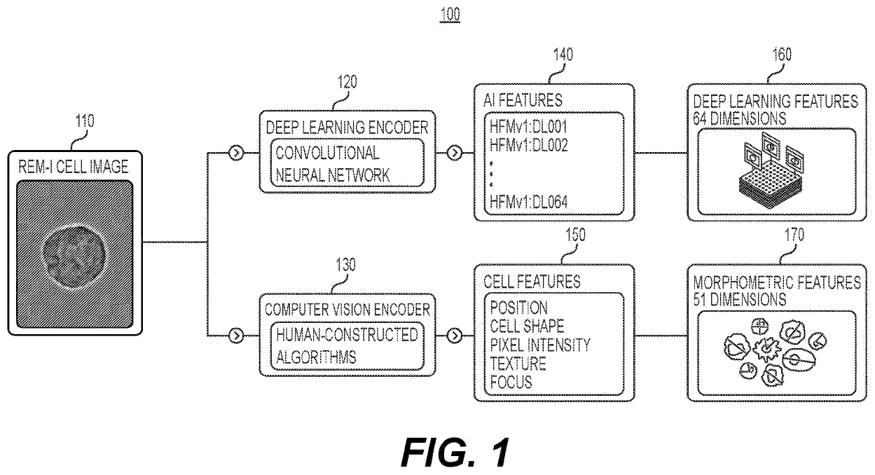

FIG. 1 illustrates an example workflow of extracting features associated with cell morphology from cell images using the human foundation model, in accordance with some examples of the present disclosure. The human foundation model may process cell images 110 and generate features therefrom. In some examples, cells that are under analysis may be unstained, and the cell images 110 may be brightfield cell images.

In some examples, the human foundation model may comprise a deep learning model 120 and a computer vision model 130. The deep learning model 120 may comprise a deep learning encoder, for example, a convolutional neural network. The deep learning model 120 may process cell images 110 as input and extract artificial intelligence (AI) features 140 therefrom. In some examples, the AI features 140 may comprise deep learning features 160, e.g., features that are extracted using a deep learning algorithm, such as a convolutional neural network or vision transformer, with other nonlimiting examples being provided elsewhere herein. In some examples, the dimensions of the deep learning features may be in a range of between about 1 and about 10, between about 1 and about 20, between about 1 and about 50, between about 1 and about 80, between about 1 and about 100, between about 1 and about 200, between about 1 and about 500, between about 1 and about 800, between about 1 and about 1,000, between about 1 and about 2,000, between about 1 and about 5,000, between about 1 and about 8,000, between about 1 and about 10,000, between about 1 and about 20,000, between about 1 and about 50,000, between about 1 and about 80,000, or between about 1 and about 100,000, or any value between any of the aforementioned numbers. The AI features 140 may include any suitable number of deep learning features 160. For example, the number of deep learning features 160 may be in the range of about 1 to about 1 million—e.g., at least about 5, at least about 10, at least about 50, at least about 100, at least about 500, at least about 1,000, at least about 5,000, at least about 10,000, at least about 50,000, at least about 100,000, or more. As one example, the deep learning model 120 may extract between about 5 and about 1000 deep learning features 160, e.g., between about 10 and about 500 deep learning features, e.g., between about 50 and about 100 deep learning features, from each cell image. In some examples, in a data set comprising a plurality of deep learning features of the cell(s), each feature may be referred to as a dimension (e.g., a deep learning dimension). Any range of dimensions of the deep learning features may be contemplated, for example from 1 through any number greater than about 100,000. As illustrated in FIG. 1, as one nonlimiting example, the deep learning model 120 generates about 64-dimensional deep learning features 160.

In some examples, the computer vision model 130 may comprise a computer vision encoder including human-constructed algorithm(s), which in some cases may be referred to as “rule-based morphometrics.” The computer vision model 130 may process cell images 110 as input and extract cell features 150 therefrom. In some examples, the cell features 150 may comprise one or more of cell position, cell shape, pixel intensity, texture, or focus, or combinations thereof. The cell features 150 may comprise morphometric features 170. Nonlimiting examples of morphometric features 170 are provided below in Table 2. The dimensions of the morphometric features 170 may be in a range of between about 1 and about 10, between about 1 and about 20, between about 1 and about 50, between about 1 and about 80, between about 1 and about 100, between about 1 and about 200, between about 1 and about 500, between about 1 and about 800, between about 1 and about 1,000, between about 1 and about 2,000, between about 1 and about 5,000, between about 1 and about 8,000, between about 1 and about 10,000, between about 1 and about 20,000, between about 1 and about 50,000, between about 1 and about 80,000, or between about 1 and about 100,000, or any value between any of the aforementioned numbers. The cell features 150 may include any suitable number of morphometric features 170, for example, at least about 1 feature, for example, at least about 5 features, or at least about 10 features, or at least about 50 features, or at least about 100 features, or at least about 500 features, or at least about 1,000 features, or at least about 5,000 features, or at least about 10,000 features, or at least about 50,000 features, or at least about 100,000 features, or more. In some cases, in a data set comprising a plurality of computer vision features of the cell(s), each feature may be referred to as a dimension (e.g., computer vision-based dimension). Any range of dimensions of the morphometric features may be contemplated, for example from 1 through any number greater than 100,000. As one example, the computer vision model 130 may extract between about 5 and about 1000 morphometric features, e.g., between about 10 and about 500 morphometric features, e.g., between about 50 and about 100 features, and any values in between any of the aforementioned ranges, from each cell image. As illustrated in FIG. 1, in one nonlimiting example, the computer vision model generates about 51-dimensional morphometric features 170.

In some examples, the human foundation model may encode the deep learning features 160 and morphometric features 170 into multidimensional numerical vectors representing the cell morphology. For example, the machine learning encoder 120 may extract n ML-based features 160, the computer-vision encoder 130 may extract m cell morphological features 170, and the multi-dimensional feature vectors may have ntm dimensions. In one nonlimiting example, 64-dimensional deep learning features 160 and 51-dimensional morphometric features 170 may be encoded into 115-dimensional embedding vectors representing the cell morphology. Within each of the multi-dimensional feature vectors, each dimension of the n+m dimensions may be an element of that multi-dimensional feature vector. The element may be a numeric value. In some examples, the ML-based features 160 may be orthogonal to one another. In some examples, the ML-based features 160 may be orthogonal to the cell morphological features 170. Further details regarding example data structures (e.g., multi-dimensional vectors) for encoding ML-based features 160 and morphometric features 170 are provided further below.

In some examples, the human foundation model may generate one or more morphology maps based on one or more of deep learning features 160 and morphometric features 170, and in some examples based on a plurality of deep learning features and a plurality of morphometric features (e.g., based on a multi-dimensional vector that represents morphology of a cell). The generation of a morphology map may be referred to as reducing dimensionalities of multi-dimensional feature vectors to generate lower-dimensional vectors. A cell morphology map may be a visual (e.g., graphical) representation of one or more clusters of datapoints. The cell morphology map may be a 1-dimensional (1D) representation (e.g., based on one morphological property as one parameter or dimension) or a multi-dimensional representation, such as a 2-dimensional (2D) representation (e.g., based on two morphological properties as two parameters or dimensions), a 3-dimensional (3D) representation (e.g., based on three morphological properties as three parameters or dimensions), a 4-dimensional (4D) representation, etc. In some examples, one morphological property of a plurality of morphological properties used for blotting the cell morphology map may be represented as a non-axial parameter (e.g., non-x, y, or z axis), such as, distinguishable colors (e.g., heatmap), numbers, letters (e.g., texts of one or more languages), and/or symbols (e.g., a square, oval, triangle, square, etc.). For example, a heatmap may be used as colorimetric scale to represent the classifier prediction percentages for each cell against a cell class, cell type, or cell state.

The cell morphology map may be generated based on one or more morphological features (e.g., characteristics, profiles, fingerprints, etc.) from the processed image data. Non-limiting examples of one or more morphological properties of a cell, as disclosed herein, that may be extracted from one or more images of the cell may include, but are not limited to (i) shape, curvature, size (e.g., diameter, length, width, circumference), area, volume, texture, thickness, roundness, etc. of the cell or one or more components of the cell (e.g., cell membrane, nucleus, mitochondria, etc.), (ii) number or positioning of one or more contents (e.g., nucleus, mitochondria, etc.) of the cell within the cell (e.g., center, off-centered, etc.), and (iii) optical characteristics of a region of the image(s) (e.g., unique groups of pixels within the image(s)) that correspond to the cell or a portion thereof (e.g., light emission, transmission, reflectance, absorbance, fluorescence, luminescence, etc.).

One or more dimensions of the cell morphology map may be represented by various approaches (e.g., dimensionality reduction approaches), such as, for example, principal component analysis (PCA), multidimensional scaling (MDS), t-distributed stochastic neighbor embedding (t-SNE), and uniform manifold approximation and projection (UMAP). For example, UMAP may be a machine learning technique for dimension reduction. UMAP may be constructed from a theoretical framework based in Riemannian geometry and algebraic topology. UMAP may be utilized for a practical scalable algorithm that applies to real world data, such as morphological properties of one or more cells.

### Training of Deep Learning Model of HFM

The deep learning model of the human foundation model may be trained using a plurality of cell images from different types of biological samples and thus, be able to detect differences in cell morphology without labeled training data. In some examples, the deep learning model 120 of the human foundation model 160 may be trained using any suitable number of images of cells, for example between about 1 and about 200, about 1 to about 500, between about 1 and about 800, between about 1 and about 1,000, between about 1 and about 2,000, between about 1 and about 5,000, between about 1 and about 8,000, between about 1 and about 10,000, between about 1 and about 20,000, between about 1 and about 50,000, between about 1 and about 80,000, between about 1 and about 100,000, between about 1 and about 200,000, between about 1 and about 500,000, between about 1 and about 800,000, between about 1 and about 1,000,000, between about 1 and about 2,000,000, between about 1 and about 5,000,000, between about 1 and about 8,000,000, or between about 1 and about 10,000,000 images of cells. Any range of the number of cell images as training dataset may be contemplated, for example from about 1 through any number greater than about 10,000,000. As one example, the deep learning model 120 of the human foundation model is trained using a training dataset that includes at least about 10,000 images of cells—e.g., at least about 100,000 images of cells, at least about 1,000,000 images of cells, at least about 5,000,000 images of cells, at least about 10,000,000 images of cells, at least about 100,000,00 images of cells, at least about 1 billion, or more, images of cells. For example, the deep learning model 120 may be trained using between about 5,000,000 and about 1 billion images of cells. The training set may include, or may consist essentially of (and in some examples may consist of), images of cells that are not physically stained and that are not computationally labeled in any manner. As such, in some examples the deep learning model 120 learns to recognize features from the cell images in a self-supervised manner.

In some examples, the human foundation model may comprise parameters in a range of between about 1 and about 1,000, between about 1 and about 2,000, between about 1 and about 5,000, between about 1 and about 8,000, between about 1 and about 10,000, between about 1 and about 20,000, between about 1 and about 50,000, between about 1 and about 80,000, between about 1 and about 100,000, between about 1 and about 200,000, between about 1 and about 500,000, between about 1 and about 800,000, between about 1 and about 1,000,000, between about 1 and about 2,000,000, between about 1 and about 5,000,000, between about 1 and about 8,000,000, between about 1 and about 10,000,000, between about 1 and about 20,000,000, between about 1 and about 50,000,000, between about 1 and about 80,000,000, between about 1 and about 100,000,000, or between about 1 and about 500,000,000. Any range of the number of parameters may be contemplated, for example from 1 through any number greater than 500,000,000. Some or all of the parameters may be optimized during the training process. For example, a neural network may include millions or billions of floating-point numbers connected by mathematical operations. These numbers in some instances may be called “parameters” or “weights”. In some examples, parameters are adjusted (“trained”) to transform an image of a cell into a vector (for example classification probabilities, or feature vector, depending on the use-case of the neural network). In some examples, a neural network for computer vision applications such as provided herein may have a number of parameters ranging from 1 million to upwards of 10 billion.

In some examples, the deep learning model (e.g., backbone model) of the human foundation model, which extracts image features, may be based on a convolutional neural network architecture, a vision transformer architecture, or both. The training process may apply a self-supervised learning approach that learns image features without labels and generate deep learning embeddings (vectors) that are orthogonal to each other and orthogonal to morphometric features. As used herein, embeddings that are “orthogonal” may be perpendicular to another embedding vector or set of embedding vectors. For example, vectors are considered to be orthogonal to each other if they are at right angles in n-dimensional space, where n is the size or number of elements in each vector. In some examples, “orthogonal” embeddings may have a covariance of about 0 and may be perfectly or completely orthogonal (e.g., have exactly a covariance of 0) or may be substantially orthogonal with a covariance that is greater than but close to 0. In some aspects, “orthogonal” embeddings include features that are “independent” of one another, meaning, that the presence or absence of one feature does not affect the presence or absence of any of the other feature. For example, a vector is orthogonal if the dot product with another vector is zero.

### Examples of Machine Learning Models for Feature Extraction

In some examples, analysis of imaging data as disclosed herein (e.g., particle imaging data, such as cell imaging data) may be performed using artificial intelligence, such as one or more machine learning algorithms.

The machine learning model (e.g., a metamodel) may be trained by using a learning model and applying learning algorithms (e.g., machine learning algorithms) on a training dataset (e.g., a dataset comprising unlabeled cell images). In some examples, given a set of training examples/cases, each marked for belonging to a specific class (e.g., specific cell type or class), a training algorithm may build a machine learning model capable of assigning features within images of cells into one category or the other, e.g., to make the model a non-probabilistic machine learning model. In some examples, the machine learning model may be used to create a new category to assign new examples/cases into the new category. In some examples, a machine learning model may be the actual trained model that is generated based on the training model.

The machine learning algorithm as disclosed herein may be configured to extract one or more morphological features of a cell from the image data of the cell. The machine learning algorithm may form a new data set based on the extracted morphological features, and the new data set need not contain the original image data of the cell. In some examples, replicas of the original images in the image data may be stored in a database disclosed herein, e.g., prior to using any of the new images for training, e.g., to keep the integrity of the images of the image data. In some examples, processed images of the original images in the image data may be stored in a database disclosed herein during or subsequent to the classifier training. In some examples, any of the newly extracted morphological features as disclosed herein may be utilized as new molecular markers for a cell or population of cells of interest to the user. A cell analysis platform as disclosed herein may be operatively coupled to one or more databases comprising non-morphological data of cells processed (e.g., genomics data, transcriptomics data, proteomics data, metabolomics data), a selected population of cells exhibiting the newly extracted morphological feature(s) may be further analyzed by their non-morphological properties to identify proteins or genes of interest that are common in the selected population of cells but not in other cells, thereby determining such proteins or genes of interest to be new molecular markers that may be used to identify such selected population of cells.

Non-limiting examples of machine learning algorithms for training a machine learning model may include supervised learning, unsupervised learning, semi-supervised learning, reinforcement learning, self-learning (also referred to as self-supervised learning), feature learning, anomaly detection, association rules, etc. In some examples, a machine learning model may be trained by using one or more learning models on such training dataset. Non-limiting examples of learning models may include artificial neural networks (e.g., convolutional neural networks, U-net architecture neural network, etc.), backpropagation, boosting, decision trees, support vector machines, regression analysis, Bayesian networks, genetic algorithms, kernel estimators, conditional random field, random forest, ensembles of machine learning models, minimum complexity machines (MCM), probably approximately correct learning (PACT), etc.

In some examples, the neural networks are designed by the modification of neural networks such as AlexNet, VGGNet, GoogLeNet, ResNet (residual networks), DenseNet, and Inception networks. In some examples, the enhanced neural networks are designed by modification of ResNet (e.g. ResNet 18, ResNet 34, ResNet 50, ResNet 101, and ResNet 152) or inception networks. In some examples, the modification may include a series of network surgery operations that are mainly carried out to improve including inference time and/or inference accuracy.

In some examples, a Vision Transformer may be used in addition to, or as an alternative neural network architecture to, a CNN. In some examples, the present machine learning machine learning model may include a hybrid architecture that incorporates that incorporates aspects of both a CNN and a Vision Transformer. In other examples, the present machine learning machine learning model may include a Vision Transformer which is used as a drop-in replacement for a CNN and is trained using the same procedure as would be used to train a CNN. In some examples, the Vision Transformer may function as an encoder (and in all respects may have the same function as the model as a feature extractor). In some examples, the Vision Transformer is configured to process tiles of images sequentially using interleaved self-attention operations with multilayer perceptrons (MLP). Nonlimiting examples of Vision Transformers and their use in encoding images are described in Dosovitskiy et al., “An image is worth 16×16 words: Transformers for image recognition at scale,” International Conference on Learning Representations (ICLR) (2021) (21 pages available at arxiv.org/abs/2010.11929), the entire contents of which are incorporated by reference herein.

The machine learning algorithm as disclosed herein may utilize one or more clustering algorithms to determine that objects (e.g., features) in the same cluster may be more similar (in one or more morphological features) to each other than those in other clusters. Non-limiting examples of the clustering algorithms may include, but are not limited to, connectivity models (e.g., hierarchical clustering), centroid models (e.g. K-means algorithm), distribution models (e.g., expectation-maximization algorithm), density models (e.g., density-based spatial clustering of applications with noise (DBSCAN), ordering points to identify the clustering structure (OPTICS)), subspace models (e.g., biclustering), group models, graph-based models (e.g., highly connected subgraphs (HCS) clustering algorithms), single graph models, and neural models (e.g., using unsupervised neural network). The machine learning algorithm may utilize a plurality of models, e.g., in equal weights or in different weights. In some examples, the graph-based models may include graph-based clustering algorithms that use modularity, e.g., such as described in the following references, the entire contents of each of which are incorporated by reference herein: Blondel et al., “Fast unfolding of communities in large networks,” Journal of Statistical Mechanics: Theory and Experiment 2008: P10008 (2008); and Traag et al., “From Louvain to Leiden: guaranteeing well-connected communities,” Scientific Reports 9:5233, 12 pages, (2019).

In some examples, unsupervised and self-supervised approaches may be used to expedite labeling of image data of cells (extract features from cells). For the example of unsupervised, an embedding for a cell image may be generated. For example, the embedding may be a representation of the image in a space with reduced dimensions than the original image data. Such embeddings may be used to cluster images that are similar to one another. Thus, the labeler may be configured to batch-label the cells and increase the throughput as compared to manually labeling one or more cells.

In some examples, for the example of self-supervised learning, additional meta information (e.g., additional non-morphological information) about the sample (e.g., what disease is known or associated with the patient who provided the sample) may be used for labeling of image data of cells.

In some examples, embedding generation may use a neural net trained on predefined cell types. To generate the embeddings described herein, an intermediate layer of the neural net that is trained on predetermined image data (e.g., image data of known cell types and/or states) may be used. By providing enough diversity in image data/sample data to the trained model, this method may provide an accurate way to cluster future cells.

In some examples, embedding generation may use neural nets trained for different tasks. To generate the embeddings described herein, an intermediate layer of the neural net that is trained for a different task (e.g., a neural net that is trained on a canonical dataset such as ImageNet). Without wishing to be bound by any particular theory, this may allow to focus on features that matter for image classification (e.g., edges and curves) while removing a bias that may otherwise be introduced in labeling the image data.

In some examples, autoencoders may be used for embedding generation. To generate the embeddings described herein, autoencoders may be used, in which the input and the output may be substantially the same image and the squeeze layer may be used to extract the embeddings. The squeeze layer may force the model to learn a smaller representation of the image, which smaller representation may have sufficient information to recreate the image (e.g., as the output).

In some examples, for clustering-based labeling of image data or cells, as disclosed herein, an expanding training data set may be used. With the expanding training data set, one or more revisions of labeling (e.g., manual relabeling) may be needed to, e.g., avoid the degradation of model performance due to the accumulated effect of mislabeled images. Such manual relabeling may be intractable on a large scale and ineffective when done on a random subset of the data. Thus, to systematically surface images for potential relabeling, for example, similar embedding-based clustering may be used to identify labeled images that may cluster with members of other classes. Such examples are likely to be enriched for incorrect or ambiguous labels, which may be removed (e.g., automatically or manually).

In some examples, adaptive image augmentation may be used. In order to make the models disclosed herein more robust to artifacts in the image data, (1) one or more images with artifacts may be identified, and (2) such images identified with artifacts may be added to training pipeline (e.g., for training the model). Identifying the image(s) with artifacts may comprise: (1a) while imaging cells, one or more additional sections of the image frame may be cropped, which frame(s) being expected to contain just the background without any cell; (2a) the background image may be checked for any change in one or more characteristics (e.g., optical characteristics, such as brightness); and (3a) flagging/labeling one or more images that have such change in the characteristic(s). Adding the identified images to training pipeline may comprise: (2a) adding the one or more images that have been flagged/labeled as augmentation by first calculating an average feature of the changed characteristic(s) (e.g., the background median color); (2b) creating a delta image by subtracting the average feature from the image data (e.g., subtracting the median for each pixel of the image); and (3c) adding the delta image to the training pipeline.

In any of the methods or platforms disclosed herein, the model(s) may be validated (e.g., for the ability to demonstrate accurate cell classification performance). Non-limiting examples of validation metrics that may be utilized may include, but are not limited to, threshold metrics (e.g., accuracy, F-measure, Kappa, Macro-Average Accuracy, Mean-Class-Weighted Accuracy, Optimized Precision, Adjusted Geometric Mean, Balanced Accuracy, etc.), the ranking methods and metrics (e.g., receiver operating characteristics (ROC) analysis or “ROC area under the curve (ROC AUC)”), and the probabilistic metrics (e.g., root-mean-squared error). For example, the model(s) may be determined to be balanced or accurate when the ROC AUC is greater than about 0.5, greater than about 0.55, greater than about 0.6, greater than about 0.65, greater than about 0.7, greater than about 0.75, greater than about 0.8, greater than about 0.85, greater than about 0.9, greater than about 0.91, greater than about 0.92, greater than about 0.93, greater than about 0.94, greater than about 0.95, greater than about 0.96, greater than about 0.97, greater than about 0.98, greater than about 0.99, or more.

As noted further above, the output of the machine learning encoder (model) may include, or may consist essentially of, or may consist of, at least one multidimensional vector (which may also be referred to herein as an embedding). Elements of the vector(s) for a given image may correspond to the values of respective features that the machine learning encoder extracted from that image. Table 1 below describes example machine learning dimensions (In one example, deep learning dimensions), which correspond to different features that the machine learning encoder extracts from images. In some examples, the machine learning encoder extracts n ML-based features from each image (where n is a positive integer), and outputs an array of length n, which array may be considered to be an n-dimensional vector. For the illustrative machine learning dimensions listed in Table 1, the output of the deep learning encoder may have the format:
[V₁ V₂ V₃ . . . Vₙ],
   where the subscripts 1 . . . n correspond to the respective deep learning dimension numbers, and wherein the letter V represents the value of the feature in that image that the deep learning encoder calculated. The value of n may be in any suitable range, e.g., may be between about 5 and about 1000, e.g., between about 10 and about 500, e.g., between about 50 and about 100, or range in between any of the aforementioned values. In the nonlimiting example shown in Table 1, n is equal to 64.

TABLE 1
Example Deep learning derived features generated
by the human foundation model.

| Deep learning | |
|---|---|
| dimension | |
| number | Description |
| HFMv1:DL001 | 1^{st} quantitative description of cell |
| | features derived from the HFM model |
| HFMv1:DL002 | 2^{nd} quantitative description of cell |
| | features derived from the HFM model |
| . . . | . . . |
| HFMv1:DL064 | 64^{th} quantitative description of cell |
| | features derived from the HFM model |

In one example, the ML-based features are not human-interpretable. In one example, because the ML-based features are identified using machine learning, AI, or both, the features are not human-interpretable. For example, the elements of the vector generated by the machine learning encoder may have numeric values, such as [0.1 4 2.3 . . . 10], that correspond to the quantitative “amount” of certain features that the machine learning encoder has identified as being present or not in a given image. However, in some examples it may not be possible to precisely identify the meaning of these features, for example as they may correspond to complex features that are identified by neurons of a convolutional neural network.

### Cell Classification

In some examples, analysis of imaging data as disclosed herein (e.g., particle imaging data, such as cell imaging data) may be performed using artificial intelligence, such as one or more machine learning algorithms. In some examples, one or more machine learning models may be used to automatically sort or categorize particles (e.g., cells) in the imaging data into one or more classes (e.g., one or more physical characteristics or morphological features, as used interchangeably herein). In some examples, cell imaging data may be analyzed using the machine learning algorithm(s) to classify (e.g., sort) a cell (e.g., a single cell) in a cell image or video. In some examples, cell imaging data may be analyzed using the machine learning algorithm(s) to determine a focus score of a cell (e.g., a single cell) in a cell image or video. In some examples, cell imaging data may be analyzed using the machine learning algorithm(s) to determine a relative distance between (i) a first plane of cells exhibiting first similar physical characteristic(s) and (ii) a second plane of cells exhibiting second similar physical characteristic(s), which first and second planes denote fluid streams flowing substantially parallel to each other in a channel. In some examples, one or more cell morphology maps as disclosed herein may be used to train one or more machine learning models (e.g., at least about 1, for example at least about 2, at least about 3, at least about 4, at least about 5, at least about 6, at least about 7, at least about 8, at least about 9, at least about 10, or more machine learning models) as disclosed herein. Each machine learning model may be trained to analyze one or more images of a cell (e.g., to extract one or more morphological features of the cell) and categorize (or classify) the cell into one or more determined class or categories of a cell (e.g., based on a type of state of the cell). In another example, the machine learning model may be trained to create a new category to categorize (or classify) the cell into the new category, e.g., when determining that the cell is morphologically distinct than any pre-existing categories of other cells.

In some examples, the entire process of cell focusing as disclosed herein (e.g., partitioning of cells into one or more planar currents flowing through the channel) may be accomplished based on de novo AI-mediated analysis of each cell (e.g., using analysis of one or more images of each cell using machine learning algorithm). This may be a complete AI or a full AI approach for cell sorting and analysis. In another example, a hybrid approach may be utilized, wherein AI-mediated analysis may analyze cells and one or more heterologous markers that are co-partitioned with the cells (e.g., into the same planar current flowing through the channel), confirm or determine the co-partitioning, after which a more conventional approach (e.g., imaging to detect presence of the heterologous markers, such as fluorescent imaging) may be utilized to sort a subsequent population of cells and the heterologous markers that are co-partitioned into the same planar current.

The machine learning model (e.g., a metamodel) may be trained by using a learning model and applying learning algorithms (e.g., machine learning algorithms) on a training dataset (e.g., a dataset comprising examples of specific classes). In some examples, given a set of training examples/cases, each marked for belonging to a specific class (e.g., specific cell type or class), a training algorithm may build a machine learning model capable of assigning new examples/cases (e.g., new datapoints of a cell or a group of cells) into one category or the other, e.g., to make the model a non-probabilistic machine learning model. In some examples, the machine learning model may be used to create a new category to assign new examples/cases into the new category. In some examples, a machine learning model may be the actual trained model that is generated based on the training model.

The machine learning algorithm as disclosed herein may be configured to extract one or more morphological features of a cell from the image data of the cell. The machine learning algorithm may form a new data set based on the extracted morphological features, and the new data set need not contain the original image data of the cell. In some examples, replicas of the original images in the image data may be stored in a database disclosed herein, e.g., prior to using any of the new images for training, e.g., to keep the integrity of the images of the image data. In some examples, processed images of the original images in the image data may be stored in a database disclosed herein during or subsequent to the classifier training. In some examples, any of the newly extracted morphological features as disclosed herein may be utilized as new molecular markers for a cell or population of cells of interest to the user. As cell analysis platform as disclosed herein may be operatively coupled to one or more databases comprising non-morphological data of cells processed (e.g., genomics data, transcriptomics data, proteomics data, metabolomics data), a selected population of cells exhibiting the newly extracted morphological feature(s) may be further analyzed by their non-morphological properties to identify proteins or genes of interest that are common in the selected population of cells but not in other cells, thereby determining such proteins or genes of interest to be new molecular markers that may be used to identify such selected population of cells.

In some examples, a machine learning model may be trained by applying machine learning algorithms on at least a portion of one or more cell morphology maps as disclosed herein as a training dataset. Non-limiting examples of machine learning algorithms for training a machine learning model may include supervised learning, unsupervised learning, semi-supervised learning, reinforcement learning, self-learning, feature learning, anomaly detection, association rules, etc. In some examples, a machine learning model may be trained by using one or more learning models on such training dataset. Non-limiting examples of learning models may include artificial neural networks (e.g., convolutional neural networks, U-net architecture neural network, etc.), backpropagation, boosting, decision trees, support vector machines, regression analysis, Bayesian networks, genetic algorithms, kernel estimators, conditional random field, random forest, ensembles of machine learning models, minimum complexity machines (MCM), probably approximately correct learning (PACT), etc.

In some examples, the neural networks are designed by the modification of neural networks such as AlexNet, VGGNet, GoogLeNet, ResNet (residual networks), DenseNet, and Inception networks. In some examples, the enhanced neural networks are designed by modification of ResNet (e.g. ResNet 18, ResNet 34, ResNet 50, ResNet 101, and ResNet 152) or inception networks. In some examples, the modification comprises a series of network surgery operations that are mainly carried out to improve including inference time and/or inference accuracy.

In some examples, a Vision Transformer may be used in addition to, or as an alternative neural network architecture to, a CNN. In some examples, the present machine learning machine learning model may include a hybrid architecture that incorporates that incorporates aspects of both a CNN and a Vision Transformer. In other examples, the present machine learning machine learning model may include a Vision Transformer which is used as a drop-in replacement for a CNN and is trained using the same procedure as would be used to train a CNN. In some examples, the Vision Transformer may function as an encoder (and in all respects may have the same function as the model as a feature extractor). In some examples, the Vision Transformer is configured to process tiles of images sequentially using interleaved self-attention operations with multilayer perceptrons (MLP). Nonlimiting examples of Vision Transformers and their use in encoding images are described in Dosovitskiy et al., “An image is worth 16×16 words: Transformers for image recognition at scale,” International Conference on Learning Representations (ICLR) (2021) (21 pages available at arxiv.org/abs/2010.11929), the entire contents of which are incorporated by reference herein.

The machine learning algorithm as disclosed herein may utilize one or more clustering algorithms to determine that objects (e.g., cells) in the same cluster may be more similar (in one or more morphological features) to each other than those in other clusters. Non-limiting examples of the clustering algorithms may include, but are not limited to, connectivity models (e.g., hierarchical clustering), centroid models (e.g. K-means algorithm), distribution models (e.g., expectation-maximization algorithm), density models (e.g., density-based spatial clustering of applications with noise (DBSCAN), ordering points to identify the clustering structure (OPTICS)), subspace models (e.g., biclustering), group models, graph-based models (e.g., highly connected subgraphs (HCS) clustering algorithms), single graph models, and neural models (e.g., using unsupervised neural network). The machine learning algorithm may utilize a plurality of models, e.g., in equal weights or in different weights. In some examples, the graph-based models may include graph-based clustering algorithms that use modularity, e.g., such as described in the following references, the entire contents of each of which are incorporated by reference herein: Blondel et al., “Fast unfolding of communities in large networks,” Journal of Statistical Mechanics: Theory and Experiment 2008: P10008 (2008); and Traag et al., “From Louvain to Leiden: guaranteeing well-connected communities,” Scientific Reports 9:5233, 12 pages, (2019).

In some examples, unsupervised and self-supervised approaches may be used to expedite labeling of image data of cells. For the example of unsupervised, an embedding for a cell image may be generated. For example, the embedding may be a representation of the image in a space with reduced dimensions than the original image data. Such embeddings may be used to cluster images that are similar to one another. Thus, the labeler may be configured to batch-label the cells and increase the throughput as compared to manually labeling one or more cells.

In some examples, for the example of self-supervised learning, additional meta information (e.g., additional non-morphological information) about the sample (e.g., what disease is known or associated with the patient who provided the sample) may be used for labeling of image data of cells.

In some examples, embedding generation may use a neural net trained on predefined cell types. To generate the embeddings described herein, an intermediate layer of the neural net that is trained on predetermined image data (e.g., image data of known cell types and/or states) may be used. In some examples, by providing enough diversity in image data or sample data to the trained model, this method may have a benefit of providing an accurate way to cluster future cells.

In some examples, embedding generation may use neural nets trained for different tasks. To generate the embeddings described herein, an intermediate layer of the neural net that is trained for a different task (e.g., a neural net that is trained on a canonical dataset such as ImageNet). Without wishing to be bound by any particular theory, this may allow the system to focus on features that matter for image classification (e.g., edges and curves) while removing a bias that may otherwise be introduced in labeling the image data.

In some examples, autoencoders may be used for embedding generation. To generate the embeddings described herein, autoencoders may be used, in which the input and the output may be substantially the same image and the squeeze layer may be used to extract the embeddings. The squeeze layer may force the model to learn a smaller representation of the image, which smaller representation may have sufficient information to recreate the image (e.g., as the output).

In some examples, for clustering-based labeling of image data or cells, as disclosed herein, an expanding training data set may be used. With the expanding training data set, one or more revisions of labeling (e.g., manual relabeling) may be needed to, e.g., avoid the degradation of model performance due to the accumulated effect of mislabeled images. Such manual relabeling may be intractable on a large scale and ineffective when done on a random subset of the data. Thus, in some examples, to systematically surface images for potential relabeling, similar embedding-based clustering may be used to identify labeled images that may cluster with members of other classes. Such examples are likely to be enriched for incorrect or ambiguous labels, which may be removed (e.g., automatically or manually).

In some examples, adaptive image augmentation may be used. In order to make the models disclosed herein more robust to artifacts in the image data, (1) one or more images with artifacts may be identified, and (2) such images identified with artifacts may be added to training pipeline (e.g., for training the model). Identifying the image(s) with artifacts may comprise: (1a) while imaging cells, one or more additional sections of the image frame may be cropped, which frame(s) being expected to contain just the background without any cell; (2a) the background image may be checked for any change in one or more characteristics (e.g., optical characteristics, such as brightness); and (3a) flagging/labeling one or more images that have such change in the characteristic(s). Adding the identified images to training pipeline may comprise: (2a) adding the one or more images that have been flagged/labeled as augmentation by first calculating an average feature of the changed characteristic(s) (e.g., the background median color); (2b) creating a delta image by subtracting the average feature from the image data (e.g., subtracting the median for each pixel of the image); and (3c) adding the delta image to the training pipeline.

In any of the methods or platforms disclosed herein, the model(s) may be validated (e.g., for the ability to demonstrate accurate cell classification performance). Non-limiting examples of validation metrics that may be utilized may include, but are not limited to, threshold metrics (e.g., accuracy, F-measure, Kappa, Macro-Average Accuracy, Mean-Class-Weighted Accuracy, Optimized Precision, Adjusted Geometric Mean, Balanced Accuracy, etc.), the ranking methods and metrics (e.g., receiver operating characteristics (ROC) analysis or “ROC area under the curve (ROC AUC)”), and the probabilistic metrics (e.g., root-mean-squared error). For example, the model(s) may be determined to be balanced or accurate when the ROC AUC is greater than about 0.5—e.g., greater than about 0.55, greater than about 0.6, greater than about 0.65, greater than about 0.7, greater than about 0.75, greater than about 0.8, greater than about 0.85, greater than about 0.9, greater than about 0.91, greater than about 0.92, greater than about 0.93, greater than about 0.94, greater than about 0.95, greater than about 0.96, greater than about 0.97, greater than about 0.98, greater than about 0.99, or higher.

### Computer Vision Model of HFM

The computer vision model of the human foundation model may include a set of rules to identify cell morphometric features within an image, and to encode those features into a multidimensional vector. In some examples, the rules may be human defined, and may correspond to features that may be understood by a human.

As noted further above, the output of the computer vision encoder (model) may include, or may consist essentially of, or may consist of, at least one multidimensional vector (which may also be referred to herein as an embedding). Elements of the vector(s) for a given image may correspond to the values of respective features that the computer vision encoder extracted from that image. Because the features are human defined, the features may be human-interpretable. Table 2 below describes example computer vision dimensions (morphometric features), which correspond to different features that the computer vision encoder may extract from images.

From Table 2, it may be understood that morphometric features may be categorized into different groups. For example, cell morphometric features may be selected from the group consisting of position features, cell shape features, pixel intensity features, texture features, and focus features. In some examples, position features may be selected from the group consisting of: centroid X axis and centroid Y axis, where Table 2 provides respective example descriptions for such features. In some examples, cell shape features may be selected from the group consisting of: area, perimeter, maximum caliper distance, minimum caliper distance, maximum radius, minimum radius, long ellipse axis, short ellipse axis, ellipse elongation, ellipse similarity, roundness, circle similarity, and convex shape, where Table 2 provides respective example descriptions for such features. In some examples, pixel intensity features are selected from the group consisting of: mean pixel intensity, standard deviation of pixel intensity, pixel intensity 25th percentile, pixel intensity 75th percentile, positive fraction, and negative fraction, where Table 2 provides respective descriptions for such features. In some examples, texture features may be selected from the group consisting of: small set of connected bright pixels, integral; small set of connected dark pixels, integral; large set of connected bright pixels, integral; large set of connected dark pixels, integral; image moments; local binary patterns-center; local binary patterns-periphery; image sharpness; image focus; ring width; and ring intensity.

In some examples, the computer vision encoder extracts m morphometric features from each image (where m is a positive integer), and outputs an array of length m, which array may be considered to be an m-dimensional vector. For the illustrative computer vision dimensions listed in Table 2, the output of the computer vision encoder may have the format:
[W₁ W₂ W₃ . . . Wₘ],
   where the subscripts 1 . . . m correspond to the respective computer vision dimension numbers, and wherein the letter W represents the value of the feature in that image that the computer vision encoder calculated. The value of m may be in any suitable range, e.g., may be between about 5 and about 1000, e.g., between about 10 and about 500, e.g., between about 50 and about 100. In the nonlimiting example shown in Table 2, m is equal to 51.

Because the morphometric features represent features that are visible by both human and computer vision, the features may be human-interpretable. For example, the elements of the vector generated using the computer vision encoder may have numeric values, such as [5 0.8 1.4 . . . 3.7], that correspond to the quantitative “amount” of certain features that the computer vision encoder has identified as being present or not in a given image. The meanings of these features also may be understood by a human. For example, based on Table 2 it may be understood that the value of the first element (e.g., 5) is the centroid X axis in μm of the image (meaning the X axis position of the cell relative to the camera's field of view), the value of the third element (e.g., 1.4) is the cell area in μm², and so on.

The computer vision encoder may be implemented using any suitable combination of hardware and software. In one example, the system component which is implementing the HFM may include a processor and a computer-readable medium (such as a non-volatile computer-readable medium) that includes instructions for causing the processor to respectively process cell images using a computer vision encoder. The computer vision encoder may be configured to quantify the characteristics (e.g., to measure dimensions or intensities) of different features within respective cell images, and to output a vector the dimensions (elements) of which correspond to the measured values of those respective characteristics.

### Encoding ML-Based Features and Cell Morphometric Features

As noted elsewhere herein, the set of ML-based features extracted using the machine learning encoder and the set of cell morphometric features extracted using the computer vision encoder may be used to respectively encode the set of ML-based features and the set of cell morphometric features into a plurality of multi-dimensional vectors that represent morphology of a cell in a cell image. In examples in which the machine learning encoder extracts n ML-based features, and the computer-vision encoder extracts m cell morphological features, the multi-dimensional vectors may have n+m dimensions, where n and m are positive integers. Within each of the multi-dimensional vectors, each dimension of the n+m dimensions may be an element of that multi-dimensional vector, e.g., a numeric value. In one example, continuing with the example provided above, the ML-based features and the cell morphometric features may be concatenated to generate a multi-dimensional vector having the format:

[V₁ V₂ V₃ . . . Vₙ W₁ W₂ W₃ . . . Wₘ], where, similarly as above, the subscripts 1 . . . n correspond to the respective deep learning dimension numbers, the letter V represents the value of the feature in that image that the deep learning encoder calculated, the subscripts 1 . . . m correspond to the respective computer vision dimension numbers, and the letter W represents the value of the feature in that image that the computer vision encoder calculated. Note that the value of m may be the same as the value of n, in which example the plurality of multi-dimensional vectors extracted using the machine learning encoder and the computer vision encoder may include a same number of each of the ML-based features and the cell morphological features. In another example, the value of m may be different than the value of n, in which example the plurality of multi-dimensional vectors extracted using the machine learning encoder and the computer vision encoder may include a different number of each of the ML-based features and the cell morphological features. It will further be appreciated that in some examples, an array of length (n+m), or vector of length (n+m), may be interpreted as being a plurality of multi-dimensional vectors, each such vector having one or more elements.

In one example, in a manner such as noted further above, the ML-based features may be orthogonal to one another. By this, it is meant that the ML-based features may all be different than one another, and may all be uncorrelated to one another. For example, ML-based feature V₁ may be different than, and uncorrelated to, each of ML-based features V₂ . . . Vₙ. In some examples, the ML-based features may be orthogonal to the cell morphological features.

### System for Cell Morphology Analysis

Cell morphology may be highly indicative of a cell's phenotype and function, but it is also highly dynamic and complex. Traditional analysis of cell morphology by human eyes has significant limitations. Other methods of assessing and characterizing cell morphology are also limited to imaging or sorting with cell labels.

Some examples of the present disclosure provide a quantitative, high-dimensional, unbiased platform to assess cell morphology and magnify insights into a cell's phenotype and functions. In some examples, the system as described herein may provide imaging of single cells and label-free sorting in one platform. For example, the system may directly capture high-resolution brightfield images of cells in real time. The system may also enable cell sorting based on their morphology without involving any cell labels. The cells may remain viable and minimally perturbed after the sorting process. In addition, the system may allow collection of sorted cells for downstream analysis, for example, single-cell RNA sequencing.

The system may comprise, or be compatible with, the human foundation model for high-dimensional morphological feature analysis. In some examples, the system may comprise or be compatible with a data suite that may allow users to store, visualize, and analyze images and high-dimensional data. Hence, the system may enable the end-to-end process including cell imaging, morphology analysis, sorting, and classification. In some examples, the system may comprise a microfluidic platform. When cells flow through the microfluidic platform, the system may capture high-resolution brightfield images of each individual cell. The images may be processed by the human foundation model for extracting high-dimensional features corresponding to the cells. The system may sort the cells in different categories, based on the distinct morphological features. The imaging, single-cell morphology analysis, sorting, and classification may occur in real time.

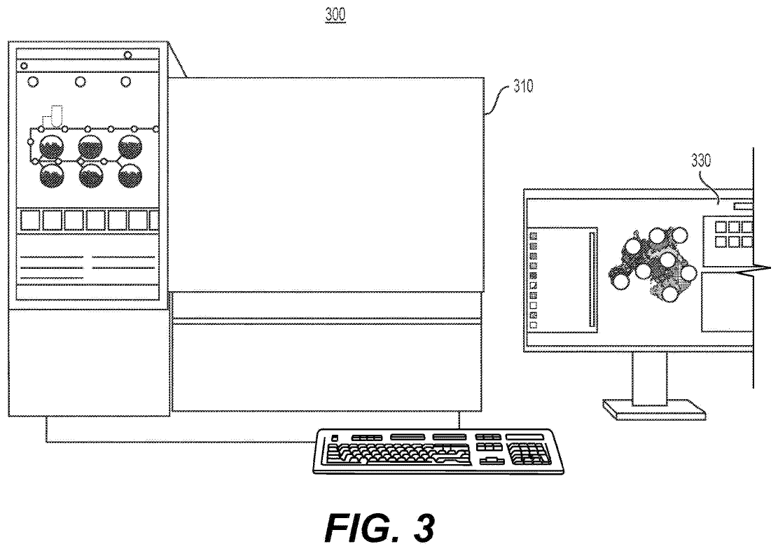

FIG. 3 illustrates an example system for cell morphology analysis, in accordance with some examples of the present disclosure. The system 300 may comprise a benchtop microfluidic platform 310 that captures high-resolution brightfield images of single cells and sort cells in a label-free manner. System 300 also may include data suite 330, which may be implemented using (and integrated with) microfluidic platform 310, or may be implemented using a separate device. Tables 3 and 4, provided further below, list example parameters, specifications, and components of system 300.

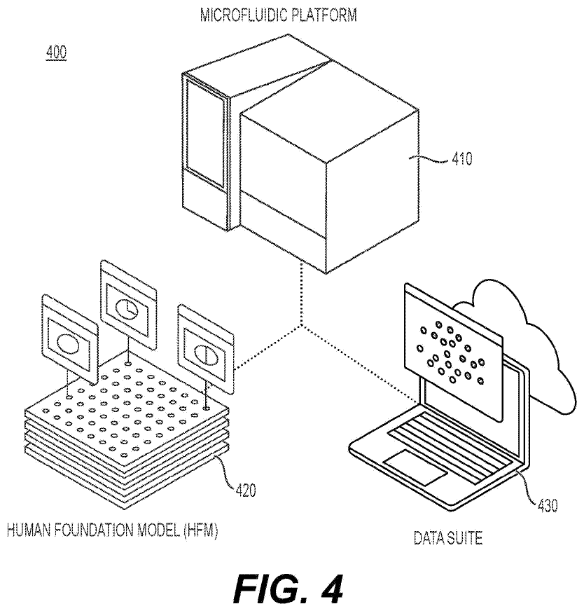

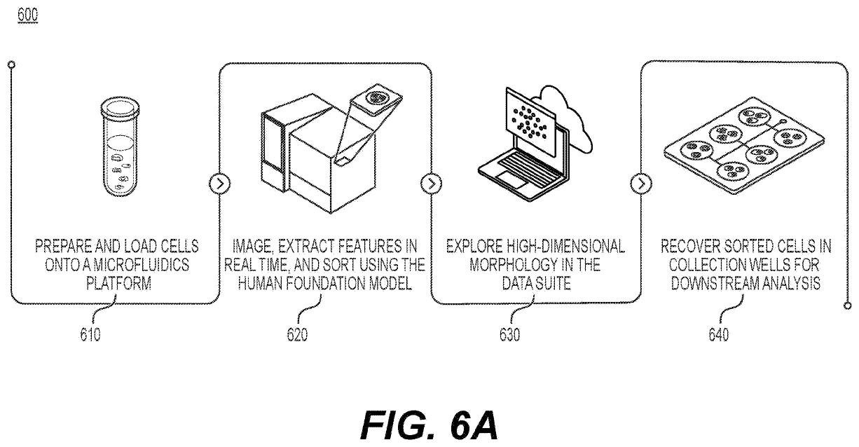

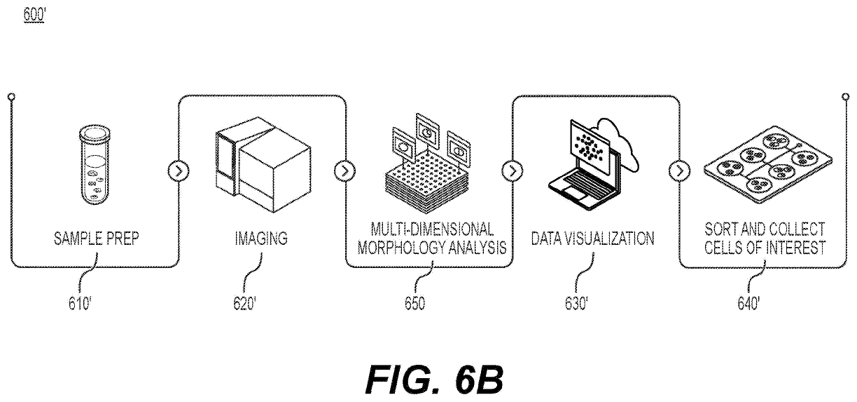

FIG. 4 illustrates system 400 which includes, and illustrates the interaction between, a microfluidic platform 410 (e.g., corresponding to microfluidic platform 310 illustrated in FIG. 3), the human foundation model 410, and a data suite 430, in accordance with some examples of the present disclosure. The system 400 for cell morphology analysis may comprise a microfluidic platform 410, which may comprise or be compatible with the human foundation model 420 and the data suite 430. Example interactions between the microfluidic platform 410, the human foundation model 420, and the data suite 430 will be described in further detail elsewhere herein, including below in accordance with FIGS. 6A-6B.

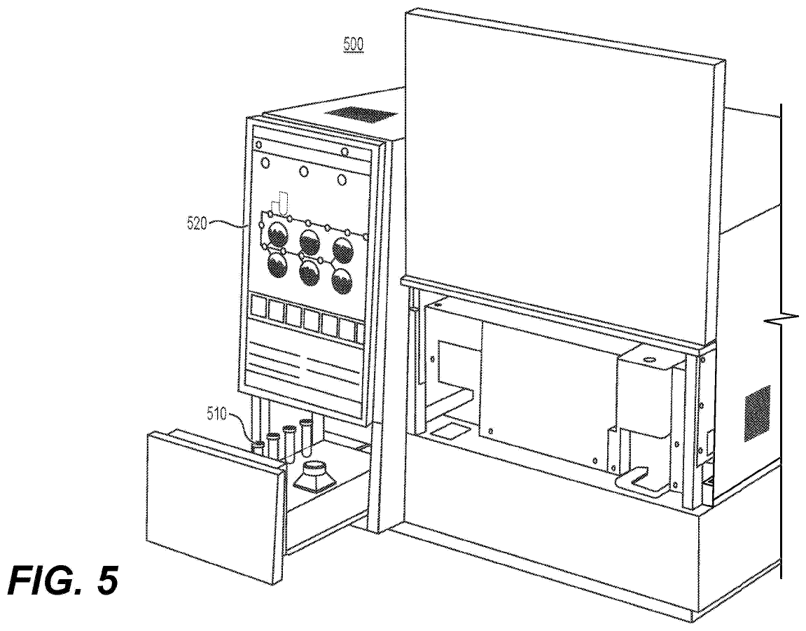

FIG. 5 illustrates an example system for cell morphology analysis, in accordance with some examples of the present disclosure. The system 500 may include a benchtop microfluidic platform that uses a set of reagents and chips for imaging and sorting, and may correspond to microfluidic platform 310 illustrated in FIG. 3. Reagents may be placed in the reagent drawer 510 and chips are loaded onto the stage. The system 500 may be controlled by a controller software. The on-instrument display 520 may show real-time run status of cell imaging, characterization, sorting and classification. The system 500 may use a microfluidic chip that allows for the input and flow of cells in suspension. The high-speed system 500 may include an imager (e.g., including a light source, one or more objective lenses, and an image sensor) to collect brightfield images of cells as they flow through a microfluidic chip. High-resolution images may capture subcellular and subnuclear features of the cells in high contrast. The system 500 may allow high-speed image capture in a range of about 1 to about 10, about 1 to about 50, about 1 to about 100, about 1 to about 200, about 1 to about 500, about 1 to about 800, about 1 to about 1,000, about 1 to about 2000, about 1 to about 5,000, or about 1 to about 8,000 image capturing events per second. Any range of image capturing events per second may be contemplated, for example from 1 through any number greater than about 8,000. In one example, system 500 may capture at least about 100 images per second, for example at least about 200 images per second, or at least about 300 images per second, or at least about 400 images per second, or at least about 500 images per second, or at least about 600 images per second, or at least about 700 images per second, or at least about 800 images per second, or at least about 900 images per second, or at least about 1000 images per second, or more. For example, system 500 may capture at least about 100 to about 1000 images per second.

System 500 may include a computer processor and at least one computer readable medium (e.g., non-volatile computer-readable medium) that stores the human foundation model and instructions for causing the computer processor to collect images using the image sensor, and to use the human foundation model to process the images. Additionally, in some examples, system 500 may include data suite 330 or 410 to perform further processing using the output of the human foundation model. In another example, system 500 may include a computer processor and at least one computer-readable medium (e.g., non-volatile computer-readable medium) that stores instructions for causing the computer processor to collect images using the image sensor, and instructions to transmit the images to another, external system that uses the human foundation model to process the images and in one example further may perform further processing using the output of the human foundation model.

The human foundation model, and in one example also the data suite, may process cell images for morphology analysis, allowing the cells to be sorted in a plurality of collection wells. For example, system 500 further may include a cell sorter, and the instructions may be for causing the computer to sort cells into one or more collection wells using the output of the human foundation model. For example, the processor may determine, using the human foundation model, the values of each of a plurality of machine learning features using a machine learning encoder and the values of each of a plurality of morphometric features using a computer vision encoder. The data suite may be used determine that certain cells have one or more machine learning features and/or one or more morphometric features in common, and may sort those cells into the same collection well as one another. The system may comprise at least about two, e.g., at least about three, at least about four, at least about five, at least about six, at least about seven, at least about eight, at least about nine, at least about ten, at least about fifteen, or at least about twenty collection wells, or more, such that cells may be classified and sorted based on their distinct morphological features. The system 500 may further comprise a laser-based system that tracks cells in real-time to assist with imaging and sorting, and to report on the purity and yield of the run. Further details regarding options for systems 300, 400, 500, including options for analyzing, classifying, and/or sorting cells, are provided below with reference to FIGS. 15-23.

FIG. 6A illustrates an example workflow from high-throughput imaging to cell characterization, classification and sorting based on cell morphology analysis, in accordance with some examples of the present disclosure. The workflow 600 may be streamlined, starting from preparing and loading cells onto the microfluidic platform (operation 610). In some examples, the preparation of samples may comprise dissociation of cells into a single-cell suspension and loading the suspension onto the microfluidic platform. Subsequently, the system may capture images of the cells, and the human foundation model may characterize the cells in real time as they flow through the microfluidic chip (operation 620). The human foundation model may process the images of the cells and generate high-dimensional features reflecting the cell morphology. The images and extracted features may be stored in the data suite (operation 630). The data suite may also provide in-depth data analysis, including selecting cell populations of interest to sort on the microfluidic platform. The system may recover sorted cells in a plurality of collection wells (operation 640), which may be used for downstream analyses.

FIG. 6B illustrates another example workflow from sample preparation to cell characterization and sorting based on cell morphology profiling, in accordance with some examples of the present disclosure. The system for cell morphology profiling as described herein may comprise a benchtop microfluidic platform that captures high-resolution brightfield images of single cells and sort cells in a label-free manner. The microfluidic platform may comprise or be compatible with the human foundation model and a data suite that may allow users to store, visualize, and analyze images and high-dimensional data. To begin an experimental run following the workflow 600′, which in certain regards is similar to workflow 600, samples from established human cell lines or dissociated tissue biopsies in single cell suspension are loaded onto a microfluidic chip (operation 610′, corresponding to operation 610 of workflow 600). Images of single cells are captured (operation 620′, corresponding to operation 620 of workflow 600) and analyzed in real-time by the human foundation model to generate multi-dimensional quantitative morphological profiles (operation 650, corresponding to operation 620 of workflow 600). The human foundation model also visualizes the cell morphology data by, for example, generating user-defined cell clusters based on cell types (operation 630′, corresponding to operation 630 of workflow 600). User-defined cell clusters are then sorted for downstream functional or molecular analysis (operation 640′, corresponding to operation 640 of workflow 600). In addition, the collected morphology data (referred to as embeddings) may be further analyzed as a unique modality, and users may continuously train customized models for specific applications.

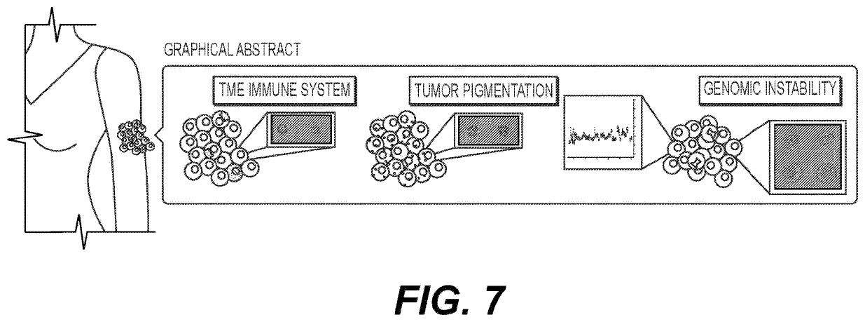

FIG. 7 illustrates example characterization of tumor cells based on cell morphology profiling, in accordance with some examples of the present disclosure. The tumor microenvironment (TME) is a highly complex ecosystem. Tumor cells may co-exist with immune cells (e.g., macrophages, polymorphonuclear cells, mast cells, natural killer cells, dendritic cells (DCs), T lymphocytes, and B lymphocytes) and non-immune cells. The immune cell components of a tumor may determine the metastatic ability of the tumor. In some examples, some tumor cells (e.g., melanoma cells) may be also pigmented. In other examples, some tumor cells may have genomic instability. The morphology of tumor cells may represent different status and characterization of tumor cells. For example, different types of tumor cells and non-tumor cells may have distinct morphological features within the same microenvironment. The system and method as described herein may characterize and sort cells by analyzing the images of the cells, generate multi-dimensional morphometric features and based on which, differentiate cells by types and functions.

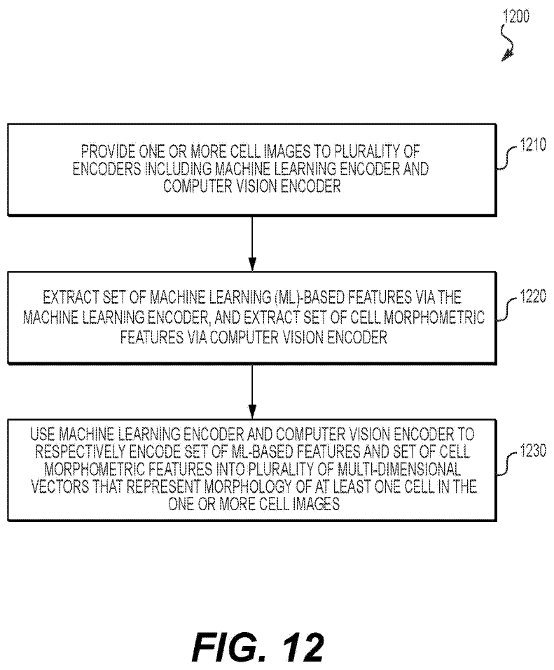

It will be appreciated that the features and operations described herein may be used in any suitable combination with one another. For example, FIG. 12 illustrates an example flow of operations in a method of processing images. Method 1200 illustrated in FIG. 12 includes providing the one or more cell images to a plurality of encoders including a machine learning encoder and a computer vision encoder (operation 1210). In one example, any suitable component(s) of system 300, system 400, or system 500 may include a processor and a non-computer readable medium storing the machine learning encoder and the computer vision encoder, and instructions for causing the processor to use the machine learning encoder and the computer vision encoder to process the cell image(s). For example, the processor may be included within microfluidic platform 310 described with reference to FIG. 3, microfluidic platform 410 described with reference to FIG. 4 (e.g., within HFM 420), or system 500 described with reference to FIG. 5. Nonlimiting examples of machine learning encoders (such as deep learning encoders, for example convolutional neural networks) and computer vision encoders are provided elsewhere herein. In some examples, cells in the one or more cell images are unstained. The one or more cell images are brightfield cell images in some examples, though it will be appreciated that other types of cell images readily may be provided to the machine learning encoder and computer vision encoder.

Method 1200 illustrated in FIG. 12 also may include extracting a set of ML-based features via the machine learning encoder, and extracting a set of cell morphometric features via the computer vision encoder (operation 1220). Nonlimiting examples of ML-based features that may be extracted using a machine learning encoder, and nonlimiting examples of cell morphometric features that may be extracted using a computer vision encoder, are provided elsewhere herein. In one purely illustrative example, the machine learning encoder uses a convolutional neural network. The convolutional neural network may have been trained using self-supervised learning, e.g., may have been trained to find features on its own using unlabeled images of unstained cells of a plurality of different types. In some examples, the computer-vision encoder uses a human-constructed algorithm. In a manner such as described above, the human-constructed algorithm may measure and output different selected characteristics of a cell that describe its morphology using user-defined rules, some nonlimiting examples of which are provided in Table 2.

Method 1200 illustrated in FIG. 12 also may include using the machine learning encoder and the computer vision encoder to respectively encode the set of ML-based features and the set of cell morphometric features into a plurality of multi-dimensional vectors that represent morphology of at least one cell in the one or more cell images. For example, the machine learning encoder may output vector(s) of the extracted ML-based features, the computer-vision encoder may vector(s) of the extracted cell morphometric features, and the vectors of the extracted ML-based features and the extracted cell morphometric features may be combined (e.g., concatenated) to form a single data structure that includes a plurality of multi-dimensional vectors. In some examples, the plurality of multi-dimensional vectors are combined into a single column vector or into a single row vector. In one example, the vector may have length (n+m), where n is the number of ML-based features in the set of ML-based features (and is a positive integer), and m is the number of cell morphometric features in the set of cell morphometric features (and is a positive integer). Within each of the multi-dimensional vectors, each dimension of the n+m dimensions may be an element of that multi-dimensional vector. The element may be a numeric value.

For example, the multi-dimensional vectors may be expressed using the vector:
[V₁ V₂ V₃ . . . Vₙ W₁ W₂ W₃ . . . Wₘ],
   where, similarly as above, the subscripts 1 . . . n correspond to the different respective deep learning dimension numbers, the letter V represents the value of the feature in that image that the deep learning encoder calculated, the subscripts 1 . . . m correspond to the respective computer vision dimension numbers, and the letter W represents the value of the feature in that image that the computer vision encoder calculated. In some examples, the plurality of multi-dimensional vectors may include different numbers of the ML-based features and the cell morphological features; in these examples, m is not equal to n. In other examples, the plurality of multi-dimensional vectors may include a same number each of the ML-based features and the cell morphological features; in these examples m is equal to n. The ML-based features may be orthogonal to one another. The ML-based features may be orthogonal to the cell morphological features.

In a manner such as described further above, in some examples, the ML-based features are not human-interpretable. In some examples, the cell morphological features are human-interpretable. Some nonlimiting examples of cell morphological features include cell position, cell shape, pixel intensity, texture, focus, or any combination thereof. These and other nonlimiting examples of cell morphological features are described in Table 2.

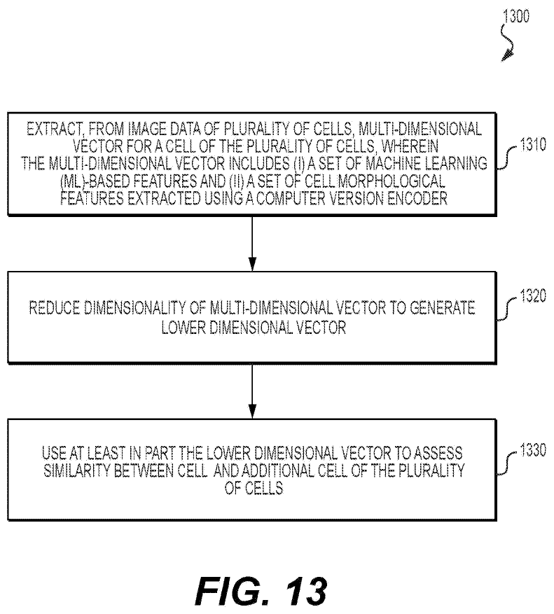

FIG. 13 illustrates an example flow of operations in a method for assessing. Method 1300 illustrated in FIG. 13 may include extracting, from image data of a plurality of cells, a multi-dimensional vector for a cell of the plurality of cells, wherein the multi-dimensional vector comprises (i) a set of machine-learning (ML)-based features extracted using a machine learning encoder and (ii) a set of cell morphometric features extracted using a computer vision encoder (operation 1310). Nonlimiting examples of formats for the multi-dimensional vector, ML-based features, machine learning encoders, cell morphometric features, and computer vision encoders are provided elsewhere herein. In a manner such as described elsewhere herein, the image of the plurality of cells may be label-free.

Method 1300 illustrated in FIG. 13 also may include reducing a dimensionality of the multi-dimensional vector to generate a lower dimensional vector (1320). The dimensionality of the multi-dimensional vector may be reduced, for example, to simplify the information that is displayed (or otherwise recorded) about a group of cells, and thus facilitate analysis of different ML-based features and/or cell morphometric features of that group of cells. In one example, the display of system 300, 400, or 500 may include a user interface via which a user may select from among the different ML-based features and/or cell morphometric features in the multi-dimensional vector for display (or other suitable output). The user interface may, for example, prompt the user to select two of the ML-based features and/or cell morphometric features, or to select three of the ML-based features and/or cell morphometric features, or to select four of the ML-based features and/or cell morphometric features, or to select five or more of the ML-based features and/or cell morphometric features. System 300, 400, or 500 then may generate a rendering of the selected features (e.g., a morphology map such as described with reference to FIG. 1). Such rendering may, for example, include a multi-dimensional plot of which the axes correspond to the selected features. Where two features are selected, the plot may be two-dimensional, where three features are selected, the plot may be three-dimensional, and so on. The values of those features for each cell of the group of cells may be plotted along their respective axes in this rendering.

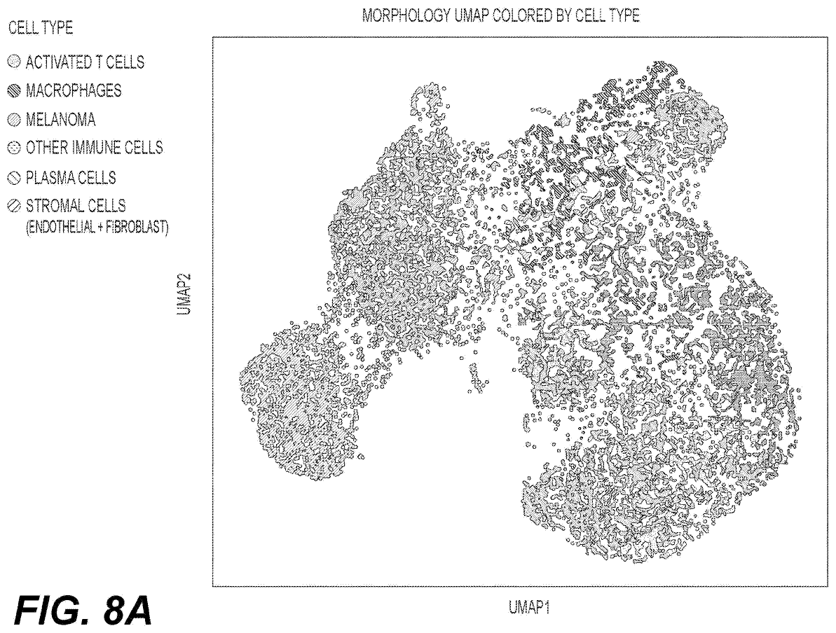

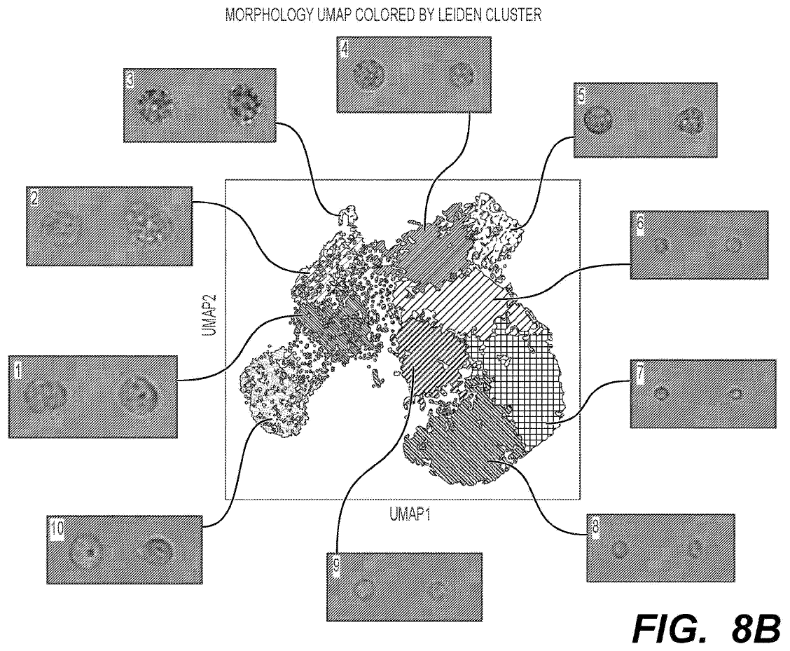

In one example, say that features V₁ and W₃ are selected. The lower-dimensional vector may be expressed, for each cell of the group of cells, as [V₁ W₃] where V₁ is the value of that ML-based feature extracted from the image of a respective cell, and W₃ is the value of that cell morphometric feature extracted from the image of a respective cell. This reduced dimensionality vector may be rendered as a two-dimensional plot in which V₁ is one axis (e.g., the X-axis) and W₃ is another axis (e.g., the Y-axis). For each cell, a point may be rendered in this plot in which the coordinates of that point along the V₁ axis are that cell's value of V₁, and the coordinates of that point along the W₃ axis are that cell's extracted value of W₃. The dimensionality reduction may be performed using the data suite or other suitable component, e.g., of system 300, 400, or 500. In one example, the reduced dimensionality vector may be displayed in graphical form on a display unit, or recorded in a computer-readable medium (e.g., non-volatile computer-readable medium). In some examples, the dimensionality of the multi-dimensional vector is reduced using a dimension reduction technique. In one example, the dimension reduction technique may be selected from the group consisting of missing value ratio, low variance filter, high correlation filter, random forest, backward feature elimination, forward feature selection, factor analysis, principal component analysis (PCA), independent component analysis, methods based on projections, t-distributed stochastic neighbor embedding (t-SNE), and uniform manifold approximation and projection (UMAP). In one specific, nonlimiting example, the dimension reduction technique is PCA. In another specific, nonlimiting example, the dimension reduction technique is UMAP. Nonlimiting examples of UMAPs are illustrated in, and described with reference to, FIGS. 8A-8B, 9A-9C, and 10A.

In one example, the dimensionality of the multi-dimensional vector may be reduced using an algorithm that takes as input the full HFM feature vector and outputs a 2-dimensional or 3-dimensional vector that “compresses” the full HFM feature vector according to some criteria. An example is UMAP where the full feature vector (e.g., 115 dimensional feature vector) is reduced to a 2-dimensional vector such that neighboring cells (cells that are closest together in distance) are the same in both 115 dimensions and 2 dimensions (“a nearest-neighbor preserving projection to 2D”). The UMAP coordinates correspond to the values of the 2-dimensional vector. In some examples, the color of each coordinate may be (1) categorical, such as a label derived from the sample (patient identifier), or the cluster assigned to the cell by a clustering algorithm, or any other categorical label, and/or may be (2) continuous: e.g., the value of a HFM feature.

Method 1300 illustrated in FIG. 13 also may include using at least in part the lower-dimensional vector to assess a similarity between the cell and an additional cell of the plurality of cells. The similarity is assessed in a feature space corresponding to the lower-dimensional vector. Some examples further include, based at least in part on the assessing, generating a cell cluster map that includes a plurality of shapes representing the plurality of cells, wherein the plurality of shapes is arranged in a plurality of clusters using at least the similarity. In some examples, the lower-dimensional vector and the cell cluster map are generated by using different dimension reduction techniques. In one example, the cell cluster map may be generated by using UMAP.

For example, among cells that are similar to one another (e.g., the same type of cell from the same source and processed similarly as one another), different cells may be expected to have similar, but slightly different extracted values than one another for any given dimensions. Among cells that are different than one another in some regard (e.g., the same type of cell but from different sources or processed differently than one another, or different types of cells), the different cells may be expected to differ in their extracted values along given dimensions more than would cells that are similar to one another. The plot may render such similarities, or differences, in the extracted ML-based features and/or cell morphometric features using the locations of points along the respective axes of the plot. A first subset of cells that are similar to one another may have points that form a first cluster in the plot, because their values of V₁ and W₃ are similar to one another, while a second subset of cells that are similar to one another and different than the first subset of cells may form a second cluster in the plot which is spaced apart from the first cluster along at least one of the axes, because their values of V₁ and W₃ are similar to one another and are different than those of the first subset of cells. Thus, the reduced dimensionality plot provides a readily understandable, visual rendering of the manner in which different features of different subsets of cells are similar to, or different than, one another. Although the lower dimensional vector in the simplified example described here has two dimensions, in some examples, the lower-dimensional vector may include three or more dimensions. In some examples, the user interface allows a user to select a point in the plot, and upon such selection provides further information about the cell to which that point corresponds. For example, upon such selection the user interface may display an image of the corresponding cell. The user interface also may display the HFM feature values for each cell and/or categorial labels assigned to the sample that the cell came from (such as known cell type, patient number, and the like).

In some examples, the multi-dimensional vector may be standardized via a feature scaling technique. In some examples, the feature scaling technique is selected from the group consisting of min-max normalization, mean normalization, and z-score normalization. For example, certain algorithms benefit from features being on consistent scales (e.g., PCA, clustering). Which feature scaling is applied depends on the use of the feature vector (that is, which algorithm the feature vector will be subjected to for additional analysis/processing). In one example, it may be selected not to scale features, for example when the features are displayed to users. In one example, radius is in micrometers and it is useful to retain this scale so users understand the cell's size.

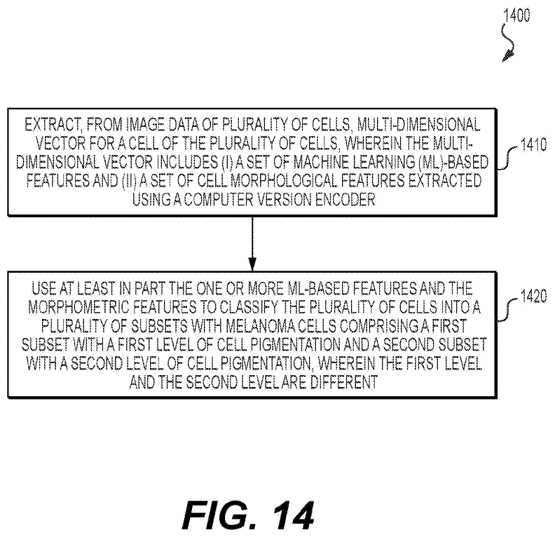

As will be readily understood from the present disclosure and the working examples provided below, operations such as described with reference to FIG. 13 may be used for classifying. For example, FIG. 14 illustrates an example flow of operations in a method for classifying. Method 1400 may include extracting, from image data of a plurality of cells, a multi-dimensional vector for each cell of the plurality of cells, wherein the multi-dimensional vector comprises (i) a set of ML-based features extracted via a machine learning encoder and (ii) a set of cell morphometric features extracted via a computer vision encoder (operation 1410). In some examples, operation 1410 may be performed in a manner similar to that of operation 1310 described with reference to FIG. 13. In some examples, the image data comprises a label-free image of each of the plurality of cells.

Method 1400 also may include using at least in part the one or more ML-based features and the morphometric features to classify the plurality of cells into a plurality of subsets of melanoma cells comprising a first subset with a first level of cell pigmentation and a second subset with a second level of cell pigmentation, wherein the first level and the second level are different (operation 1420). In one example, the level of cell pigmentation may be characterized using at least one ML-based feature, at least one cell morphometric feature, or at least one ML-based feature and at least one cell morphometric feature. The dimensionality of the multi-dimensional vectors of respective melanoma cells being classified may be reduced in a manner such as described with reference to operation 1320 of FIG. 13. For example, a lower dimensional vector may be generated that includes one or more ML-based feature(s) and/or one or more cell morphometric features that characterize the level of cell pigmentation in those cells. Additionally, the lower dimensional vector may be used at least in part to assess similarity between melanoma cells in a manner such as described with reference to operation 1330 of FIG. 13. For example, operation 1420 may include automatically generating a cell cluster map including a plurality of shapes representing the plurality of cells, wherein the plurality of shapes is arranged in a plurality of clusters that corresponds to the plurality of subsets of melanoma cells. Method 1400 further may include sorting the first subset and the second subset into different sub-channels of a flow channel in fluid communication with the plurality of cells.

Many methods for imaging and sorting cells rely on biomarkers that may perturb cells and create selection bias. To reduce, and in some examples even eliminate, dependence on biomarkers and enable broader assessment of cells, the present platform has been developed, which in nonlimiting examples characterizes cells based on high-dimensional morphology. As explained in the present disclosure, live cells may be captured with brightfield high resolution imaging and processed in real-time by self-supervised deep learning models to generate quantitative AI embeddings representative of cell morphology. In some examples, this platform uses an AI model to extract features from cell images of diverse human cells without prior knowledge of cell types, cell preparation, or other application-specific knowledge for an exploratory approach. The Human Foundation Model (HFM), in some examples, includes a hybrid architecture that combines self-supervised learning (SSL) and morphometrics (computer vision) to extract 115 dimensional embeddings representing cell morphology from high-resolution cell images. SSL produces a foundation model with high generalization capacity that enables hypothesis-free sample exploration and efficient generation of application-specific models. Meanwhile, computer vision extracts features that represent measurable and interpretable concepts (e.g., cell size, shape, texture, intensity).

Morphology as a high-dimensional cell characterization descriptor that may be integrated with other “-omics” modalities is a powerful tool in providing a more comprehensive understanding of cell biology. Through the example technology provided herein, Deep Learning and Computer Vision may be used to characterize cells in a label-free manner based on real-time interpretation of high-content morphology data.

For example, as provided herein, the present platform combines microfluidics and high-speed imaging in the imaging instrument, Deep learning and Computer Vision in the Human Foundation Model (HFM), and data analysis and visualization in the data suite. In one example, the hybrid self-supervised Deep Learning model, together with the Computer Vision model, produces 115 embeddings which are reproducible, quantitative, and high-dimensional descriptions that distinguish individual cells from one another. Once cell images are processed by the HFM, deep learning embeddings may be analyzed through interactive UMAPs, population analytics, and image visualizations. Using these features, cell populations of interest may be defined, and select features may be reproducibly used for subsequent experiments or sort populations into six wells for further multi-omic and functional analysis. In one illustrative example, to assess the immune cell subtypes typically present in PBMC samples, the platform may be used to image patient-derived PBMC samples and purified immune cell subsets including CD4+ T cells (total, activated, and naive), CD8+ T cells (total, activated, and naive), CD14+ monocytes, CD19+B cells, CD38+ plasma cells, CD56+NK cells, and macrophages. High-dimensional morphology analysis shows profiled immune cell subsets in distinct locations on the associated UMAP, indicating cell types are separable by morphological features extracted by the HFM. Leiden clustering further distinguished cell groups by morphological traits, with several cell subsets overlapping with individual Leiden clusters. The results suggest the observed morphology profiles may reflect specific functional states.

An example training process for the HFM self-supervised backbone model, the discriminatory power added by supervised tasks, and validation of the reproducibility and generalization capabilities of the resulting model are described herein. The Axon data suite, a user-friendly tool designed for researchers to analyze data and create custom reusable workflows, also is described. This includes the ability to store and manage data, visualize high dimensional data as low-dimensional projections, and train classifiers to identify and sort cell populations on the REM-I instrument. To facilitate compatibility with user-preferred downstream analysis pipelines, the tool provides data export options for images, plots, and embeddings. In some examples, the approach allows users of all computational skill levels to access and interpret AI-enabled morphological profiling. Potential applications of the REM-I platform may include heterogeneous sample evaluation, tumor cell enrichment, cell state characterization, and multi-omic integration.

Further details regarding nonlimiting examples of selected system components, and operations that may be performed using such system components, now will be provided. In some examples, any suitable combination of such system components may be included in system 300, system 400, or system 500, and any suitable operations may be performed by components included in system 300, system 400, or system 500.

FIG. 15 schematically illustrates an example method for classifying a cell. The method may comprise processing image data 1510 comprising tag-free images/videos of single cells (e.g., image data 1510 including, consisting essentially of, or consisting of tag-free images/videos of single cells). Various clustering analysis models 1520 as disclosed herein may be used to process the image data 1510 to extract one or more morphological properties of the cells from the image data 1510, and generate a cell morphology map 1530A based on the extracted one or more morphological properties. For example, the cell morphology map 1530A may be generated based on two morphological properties as dimension 1 and dimension 2. The cell morphology map 1530A may comprise one or more clusters (e.g., clusters A, B, and C) of datapoints, each datapoint representing an individual cell from the image data 1510. The cell morphology map 1530A and the clusters A-C therein may be used to train classifier(s) 1550. Subsequently, a new image 1540 of a new cell may be obtained and processed by the trained classifier(s) 1550 to automatically extract and analyze one or more morphological features from the cellular image 1540 and plot it as a datapoint on the cell morphology map 1530A. Based on its proximity, correlation, or commonality with one or more of the morphologically-distinct clusters A-C on the cell morphology map 1530A, the classifier(s) 1550 may automatically classify the new cell. The classifier(s) 1550 may determine a probability that the cell in the new image data 1540 belongs to cluster C (e.g., the likelihood for the cell in the new image data 1540 to share one or more commonalities and/or characteristics with cluster C more than with other clusters A/B). For example, the classifier(s) 1550 may determine and report that the cell in the new image data 1540 has a 95% probability of belonging to cluster C, 1% probability of belonging to cluster B, and 4% probability of belong to cluster A, solely based on analysis of the tag-free image 1540 and one or more morphological features of the cell extracted therefrom.

An image and/or video (e.g., a plurality of images and/or videos) of one or more cells as disclosed herein (e.g., that of image data 1510 in FIG. 15) may be captured while the cell(s) is suspended in a fluid (e.g., an aqueous liquid, such as a buffer) and/or while the cell(s) is moving (e.g., transported across a microfluidic channel). For example, the cell need not be suspended is a gel-like or solid-like medium. The fluid may comprise a liquid that is heterologous to the cell(s)'s natural environment. For example, cells from a subject's blood may be suspended in a fluid that comprises (i) at least a portion of the blood and (ii) a buffer that is heterologous to the blood. The cell(s) may not be immobilized (e.g., embedded in a solid tissue or affixed to a microscope slide, such as a glass slide, for histology) or adhered to a substrate. The cell(s) may be isolated from the natural environment or niche (e.g., a part of the tissue from which the cell(s) are retrieved from a subject) when the image and/or video of the cell(s) is captured. For example, the image and/or video need not be from a histological imaging. The cell(s) need not be sliced or sectioned prior to obtaining the image and/or video of the cell, and, as such, the cell(s) may remain substantially intact as a whole during capturing of the image and/or video.

When the image data is processed, e.g., to extract one or more morphological features of a cell, each cell image may be annotated with the extracted one or more morphological features and/or with information that the cell image belongs to a particular cluster (e.g., a probability).

The cell morphology map may be a visual (e.g., graphical) representation of one or more clusters of datapoints. The cell morphology map may be a 1-dimensional (1D) representation (e.g., based on one morphological property as one parameter or dimension) or a multi-dimensional representation, such as a 2-dimensional (2D) representation (e.g., based on two morphological properties as two parameters or dimensions), a 3-dimensional (3D) representation (e.g., based on three morphological properties as three parameters or dimensions), a 4-dimensional (4D) representation, etc. In some examples, one morphological property of a plurality of morphological properties used for blotting the cell morphology map may be represented as a non-axial parameter (e.g., non-x, y, or z axis), such as, distinguishable colors (e.g., heatmap), numbers, letters (e.g., texts of one or more languages), and/or symbols (e.g., a square, oval, triangle, square, etc.). For example, a heatmap may be used as colorimetric scale to represent the classifier prediction percentages for each cell against a cell class, cell type, or cell state.

The cell morphology map may be generated based on one or more morphological features (e.g., characteristics, profiles, fingerprints, etc.) from the processed image data. Non-limiting examples of one or more morphological properties of a cell, as disclosed herein, that may be extracted from one or more images of the cell may include, but are not limited to (i) shape, curvature, size (e.g., diameter, length, width, circumference), area, volume, texture, thickness, roundness, etc. of the cell or one or more components of the cell (e.g., cell membrane, nucleus, mitochondria, etc.), (ii) number or positioning of one or more contents (e.g., nucleus, mitochondria, etc.) of the cell within the cell (e.g., center, off-centered, etc.), and (iii) optical characteristics of a region of the image(s) (e.g., unique groups of pixels within the image(s)) that correspond to the cell or a portion thereof (e.g., light emission, transmission, reflectance, absorbance, fluorescence, luminescence, etc.).

Non-limiting examples of clustering as disclosed herein may be hard clustering (e.g., determining whether a cell belongs to a cluster or not), soft clustering (e.g., determining a likelihood that a cell belongs to each cluster to a certain degree), strict partitioning clustering (e.g., determining whether each cell belongs to exactly one cluster), strict partitioning clustering with outliers (e.g., determining whether a cell may also belong to no cluster), overlapping clustering (e.g., determining whether a cell may belong to more than one cluster), hierarchical clustering (e.g., determining whether cells that belong to a child cluster may also belong to a parent cluster), and subspace clustering (e.g., determining whether clusters are not expected to overlap).

Cell clustering and/or generation of the cell morphology map, as disclosed herein, may be based on a single morphological property of the cells. In another example, cell clustering and/or generation the cell morphology map may be based on a plurality of different morphological properties of the cells. In some examples, the plurality of different morphological properties of the cells may have the same weight or different weights. A weight may be a value indicative of the importance or influence of each morphological property relative to one another in training the classifier or using the classifier to (i) generate one or more cell clusters, (ii) generate the cell morphology map, or (iii) analyze a new cellular image to classify the cellular image as disclosed herein. For example, cell clustering may be performed by having 50% weight on cell shape, 40% weight on cell area, and 10% weight on texture (e.g., roughness) of the cell membrane. In some examples, the classifier as disclosed herein may be configured to adjust the weights of the plurality of different morphological properties of the cells during analysis of new cellular image data, thereby to yield a most optimal cell clustering and cell morphology map. The plurality of different morphological properties with different weights may be utilized during the same analysis operation for cell clustering and/or generation of the cell morphology map.

The plurality of different morphological properties may be analyzed hierarchically. In some examples, a first morphological property may be used as a parameter to analyze image data of a plurality of cells to generate an initial set of clusters. Subsequently, a second and different morphological property may be used as a second parameter to (i) modify the initial set of clusters (e.g., optimize arrangement among the initial set of clusters, re-group some clusters of the initial set of clusters, etc.) and/or (ii) generate a plurality of sub-clusters within a cluster of the initial set of clusters. In some examples, a first morphological property may be used as a parameter to analyze image data of a plurality of cells to generate an initial set of clusters, to generate a 1D cell morphology map. Subsequently, a second morphological property may be used as a parameter to further analyze the clusters of the 1D cell morphology map, to modify the clusters and generate a 2D cell morphology map (e.g., a first axis parameter based on the first morphological property and a second axis parameter based on the second morphological property).

In some examples of the hierarchical clustering as disclosed herein, an initial set of clusters may be generated based on an initial morphological feature that is extracted from the image data, and one or more clusters of the initial set of clusters may comprise a plurality of sub-clusters based on second morphological features or sub-features of the initial morphological feature. For example, the initial morphological feature may be cell type, such as stem cells (or not), and the sub-features may be different types of stem cells (e.g., embryonic stem cells, induced pluripotent stem cells, mesenchymal stem cells, muscle stem cells, etc.). In another example, the initial may be cancer cells (or not), and the sub-feature may be different types of cancer cells (e.g., sarcoma cells, sarcoma cells, leukemia cells, lymphoma cells, multiple myeloma cells, melanoma cells, etc.). In a different example, the initial may be cancer cells (or not), and the sub-feature may be different stages of the cancer cell (e.g., quiescent, proliferative, apoptotic, etc.).

Each datapoint may represent an individual cell or a collection of a plurality of cells (e.g., at least about 2—e.g., at least about 3, at least about 4, at least about 5, at least about 6, at least about 7, at least about 8, at least about 9, or at least about 10 cells or more). Each datapoint may represent an individual image (e.g., of a single cell or a plurality of cells) or a collection of a plurality of images (e.g., at least about 2,—e.g., at least about 3, at least about 4, at least about 5, at least about 6, at least about 7, at least about 8, at least about 9, or at least about 10 images of the same single cell or different cells or more)

The cell morphology map may comprise at least about 1, for example at least about 2, or at least about 3, or at least about 4, or at least about 5, or at least about 6, or at least about 7, or at least about 8, or at least about 9, or at least about 10, or at least about 15, or at least about 20, or at least about 30, or at least about 40, or at least about 50, or at least about 60, or at least about 70, or at least about 80, or at least about 90, or at least about 100, or at least about 150, or at least about 200, or at least about 300, or at least about 400, or at least about 500 clusters, or more.

Each cluster as disclosed herein may comprise a plurality of sub-clusters, e.g., at least about 2, or at least about 3, or at least about 4, or at least about 5, or at least about 6, or at least about 7, or at least about 8, or at least about 9, or at least about 10, or at least about 15, or at least about 20, or at least about 30, or at least about 40, or at least about 50, or at least about 60, or at least about 70, or at least about 80, or at least about 90, or at least about 100, or at least about 150, or at least about 200, or at least about 300, or at least about 400, or at least about 500 sub-clusters, or more.

A cluster (or sub-cluster) may comprise datapoints representing cells of the same type/state. In another example, In another example, a cluster (or sub-cluster) may comprise datapoints representing cells of different types/states.

A cluster (or sub-cluster) may comprise at least about 1, for example at least about 2, or at least about 3, or at least about 4, or at least about 5, or at least about 6, or at least about 7, or at least about 8, or at least about 9, or at least about 10, or at least about 15, or at least about 20, or at least about 30, or at least about 40, or at least about 50, or at least about 60, or at least about 70, or at least about 80, or at least about 90, or at least about 100, or at least about 150, or at least about 200, or at least about 300, or at least about 400, or at least about 500, or at least about 1,000, or at least about 2,000, or at least about 3,000, or at least about 4,000, or at least about 5,000, or at least about 10000, or at least about 50,000, or at least about 100,000 datapoints, or more.

Two or more clusters may overlap in a cell morphology map. In another example, no clusters may not overlap in a cell morphology map. In some examples, an allowable degree of overlapping between two or more clusters may be adjustable (e.g., manually or automatically by a machine learning algorithm) depending on the quality, condition, or size of data in the image data being processed.

A cluster (or sub-cluster) as disclosed herein may be represented with a boundary (e.g., a solid line or a dashed line). In another example, a cluster or sub-cluster need not be represented with a boundary, and may be distinguishable from other cluster(s) sub-cluster(s) based on their proximity to one another.

A cluster (or sub-cluster) or a data comprising information about the cluster may be annotated based on one or more annotation schema (e.g., predefined annotation schema). Such annotation may be manual (e.g., by a user of the method or system disclosed herein) or automatically (e.g., by any of the machine learning algorithms disclosed herein). The annotation of the clustering may be related the one or more morphological properties of the cells that have been analyzed (e.g., cell shape, cell area, optical characteristic(s), etc.) to generate the cluster or assign one or more datapoints to the cluster. In another example, the annotation of the clustering may be related to information that has not been used or analyzed to generate the cluster or assign one or more datapoints to the cluster (e.g., genomics, transcriptomics, or proteomics, etc.). In such example, the annotation may be utilized to add additional “layers” of information to each cluster.

In some examples, an interactive annotation tool may be provided that permits one or more users to modify any process of the method described herein. For example, the interactive annotation tool may allow a user to curate, verify, edit, and/or annotate the morphologically-distinct clusters. In another example, the interactive annotation tool may process the image data, extract one or more morphological features from the image data, and allow the user to select one or more of the extracted morphological features to be used as a basis to generate the clusters and/or the cell morphology map. After the generation of the clusters and/or the cell morphology map, the interactive annotation tool may allow the user to annotate each cluster and/or the cell morphology map using (i) a predefined annotation schema or (ii) a new, user-defined annotation schema. In another example, the interactive annotation tool may allow user to assign different weights to different morphological features for the clustering and/or map plotting. In another example, the interactive annotation tool may allow user to select with imaging data (or which cells) to be used and/or which imaging data (or which cells, cell clumps, artifacts, or debris) to be discarded, for the clustering and/or map plotting. A user may manually identify incorrectly clustered cells, or the machine learning algorithm may provide probability or correlation value of cells within each cluster and identify any outlier (e.g., a datapoint that would change the outcome of the probability/correlation value of the cluster(s) by a certain percentage value). Thus, the user may choose to move the outliers using the interactive annotation tool to further tune the cell morphology map, e.g., to yield a “higher resolution” map.

One or more cell morphology maps as disclosed herein may be used to train one or more classifiers (e.g., at least about 1, for example, at least about 2, at least about 3, at least about 4, at least about 5, at least about 6, at least about 7, at least about 8, at least about 9, at least about 10, or more classifiers) as disclosed herein. Each classifier may be trained to analyze one or more images of a cell (e.g., to extract one or more morphological features of the cell) and categorize (or classify) the cell into one or more determined class or categories of a cell (e.g., based on a type of state of the cell). In another example, the classifier may be trained to create a new category to categorize (or classify) the cell into the new category, e.g., when determining that the cell is morphologically distinct than any pre-existing categories of other cells.

The human foundation model (e.g., machine learning algorithm and computer vision model) as disclosed herein may be configured to extract one or more morphological feature of a cell from the image data of the cell. The human foundation model may form a new data set based on the extracted morphological features, and the new data set need not contain the original image data of the cell. In some examples, replicas of the original images in the image data may be stored in a database disclosed herein, e.g., prior to using any of the new images for training, e.g., to keep the integrity of the images of the image data. In some examples, processed images of the original images in the image data may be stored in a database disclosed herein during or subsequent to the classifier training. In some examples, any of the newly extracted morphological features as disclosed herein may be utilized as new molecular markers for a cell or population of cells of interest to the user. As cell analysis platform as disclosed herein may be operatively coupled to one or more databases comprising non-morphological data of cells processed (e.g., genomics data, transcriptomics data, proteomics data, metabolomics data), a selected population of cells exhibiting the newly extracted morphological feature(s) may be further analyzed by their non-morphological properties to identify proteins or genes of interest that are common in the selected population of cells but not in other cells, thereby determining such proteins or genes of interest to be new molecular markers that may be used to identify such selected population of cells.

In some examples, a classifier may be trained by applying machine learning algorithm(s) on at least a portion of one or more cell morphology maps as disclosed herein, which maps may be used as a training dataset. Non-limiting examples of machine learning algorithms for training a classifier may include supervised learning, unsupervised learning, semi-supervised learning, reinforcement learning, self-learning, feature learning, anomaly detection, association rules, etc. In some examples, a classifier may be trained by using one or more learning models on such training dataset. Non-limiting examples of learning models may include artificial neural networks (e.g., convolutional neural networks, U-net architecture neural network, etc.), backpropagation, boosting, decision trees, support vector machines, regression analysis, Bayesian networks, genetic algorithms, kernel estimators, conditional random field, random forest, ensembles of classifiers, minimum complexity machines (MCM), probably approximately correct learning (PACT), etc.

In some examples, the neural networks are designed by the modification of neural networks such as AlexNet, VGGNet, GoogLeNet, ResNet (residual networks), DenseNet, and Inception networks. In some examples, the enhanced neural networks are designed by modification of ResNet (e.g. ResNet 18, ResNet 34, ResNet 50, ResNet 101, and ResNet 152) or inception networks. In some examples, the modification comprises a series of network surgery operations that are mainly carried out to improve including inference time and/or inference accuracy.

The machine learning algorithm as disclosed herein may utilize one or more clustering algorithms to determine that objects in the same cluster may be more similar (in one or more morphological features) to each other than those in other clusters. Non-limiting examples of the clustering algorithms may include, but are not limited to, connectivity models (e.g., hierarchical clustering), centroid models (e.g. K-means algorithm), distribution models (e.g., expectation-maximization algorithm), density models (e.g., density-based spatial clustering of applications with noise (DBSCAN), ordering points to identify the clustering structure (OPTICS)), subspace models (e.g., biclustering), group models, graph-based models (e.g., highly connected subgraphs (HCS) clustering algorithms), single graph models, and neural models (e.g., using unsupervised neural network). The machine learning algorithm may utilize a plurality of models, e.g., in equal weights or in different weights.

In some examples, unsupervised and self-supervised approaches may be used to expedite labeling of image data of cells. For the example of unsupervised, an embedding for a cell image may be generated. For example, the embedding may be a representation of the image in a space with reduced dimensions than the original image data. Such embeddings may be used to cluster images that are similar to one another. Thus, the labeler may be configured to batch-label the cells and increase the throughput as compared to manually labeling one or more cells.

In some examples, for the example of self-supervised learning, additional meta information (e.g., additional non-morphological information) about the sample (e.g., what disease is known or associated with the patient who provided the sample) may be used for labeling of image data of cells.

In some examples, embedding generation may use a neural net trained on predefined cell types. To generate the embeddings described herein, an intermediate layer of the neural net that is trained on predetermined image data (e.g., image data of known cell types and/or states) may be used. By providing enough diversity in image data/sample data to the trained model/classifier, this method may provide an accurate way to cluster future cells.

In some examples, embedding generation may use neural nets trained for different tasks. To generate the embeddings described herein, an intermediate layer of the neural net that is trained for a different task (e.g., a neural net that is trained on a canonical dataset such as ImageNet). Without wishing to be bound by any particular theory, this may allow to focus on features that matter for image classification (e.g., edges and curves) while removing a bias that may otherwise be introduced in labeling the image data.

In some examples, autoencoders may be used for embedding generation. To generate the embeddings described herein, autoencoders may be used, in which the input and the output may be substantially the same image and the squeeze layer may be used to extract the embeddings. The squeeze layer may force the model to learn a smaller representation of the image, which smaller representation may have sufficient information to recreate the image (e.g., as the output).

In some examples, for clustering-based labeling of image data or cells, as disclosed herein, an expanding training data set may be used. With the expanding training data set, one or more revisions of labeling (e.g., manual relabeling) may be needed to, e.g., avoid the degradation of model performance due to the accumulated effect of mislabeled images. Such manual relabeling may be intractable on a large scale and ineffective when done on a random subset of the data. Thus, to systematically surface images for potential relabeling, for example, similar embedding-based clustering may be used to identify labeled images that may cluster with members of other classes. Such examples are likely to be enriched for incorrect or ambiguous labels, which may be removed (e.g., automatically or manually).

In some examples, adaptive image augmentation may be used. In order to make the models and classifiers disclosed herein more robust to artifacts in the image data, (1) one or more images with artifacts may be identified, and (2) such images identified with artifacts may be added to training pipeline (e.g., for training the model/classifier). Identifying the image(s) with artifacts may comprise: (1a) while imaging cells, one or more additional sections of the image frame may be cropped, which frame(s) being expected to contain just the background without any cell; (2a) the background image may be checked for any change in one or more characteristics (e.g., optical characteristics, such as brightness); and (3a) flagging/labeling one or more images that have such change in the characteristic(s). Adding the identified images to training pipeline may comprise: (2a) adding the one or more images that have been flagged/labeled as augmentation by first calculating an average feature of the changed characteristic(s) (e.g., the background median color); (2b) creating a delta image by subtracting the average feature from the image data (e.g., subtracting the median for each pixel of the image); and (3c) adding the delta image to the training pipeline.

One or more dimension of the cell morphology map may be represented by various approaches (e.g., dimensionality reduction approaches), such as, for example, principal component analysis (PCA), multidimensional scaling (MDS), t-distributed stochastic neighbor embedding (t-SNE), and uniform manifold approximation and projection (UMAP). For example, UMAP may be a machine learning technique for dimension reduction. UMAP may be constructed from a theoretical framework based in Riemannian geometry and algebraic topology. UMAP may be utilized for a practical scalable algorithm that applies to real world data, such as morphological properties of one or more cells.

The cell morphology map as disclosed herein may comprise an ontology of the one or more morphological features. The ontology may be an alternative medium to represent a relationship among various datapoints (e.g., each representing a cell) analyzed from an image data. For example, an ontology may be a data structure of information, in which nodes may be linked by edges. An edge may be used to define a relationship between two nodes. For example, a cell morphology map may comprise a cluster comprising sub-clusters, and the relationship between the cluster and the sub-clusters may be represented in an nodes/edges ontology (e.g., an edge may be used to describe the relationship as a subclass of, genus of, part of, stem cell of, differentiated from, progeny of, diseased state of, targets, recruits, interacts with, same tissue, different tissue, etc.).

In some examples, one-to-one morphology to genomics mapping may be utilized. An image of a single cell or images of multiple “similar looking” cells may be mapped to its/their molecular profile(s) (e.g., genomics, proteomics, transcriptomics, etc.). In some examples, classifier-based barcoding may be performed. Each sorting event (e.g., positive classifier) may push the sorted cell(s) into an individual well or droplet with a unique barcode (e.g., nucleic acid or small molecule barcode). The exact barcode(s) used for that individual classifier positive event may be recorded and tracked. Following, the cells may be lysed and molecularly analyzed together with the barcode(s). The result of the molecular analysis may then be mapped (e.g., one-to-one) to the image(s) of the individual (or ensemble of) sorted cell(s) captured while the cell(s) are flowing in the flow channel. In some examples, class-based sorting may be utilized. Cells that are classified in the same class based at least on their morphological features may be sorted into a single well or droplet with a pre-determined barcoded material, and the cells may be lysed, molecularly analyzed, then any molecular information may be used for the one-to-one mapping as disclosed herein.

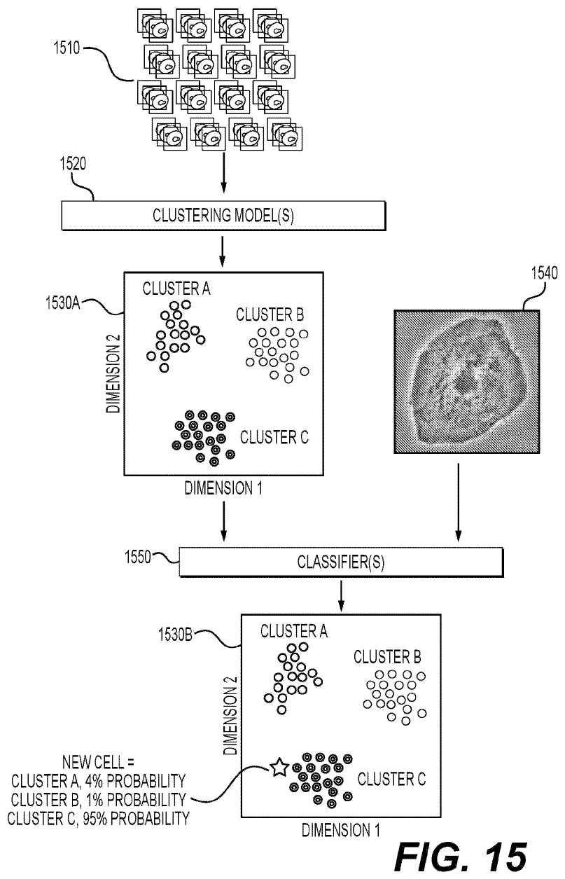

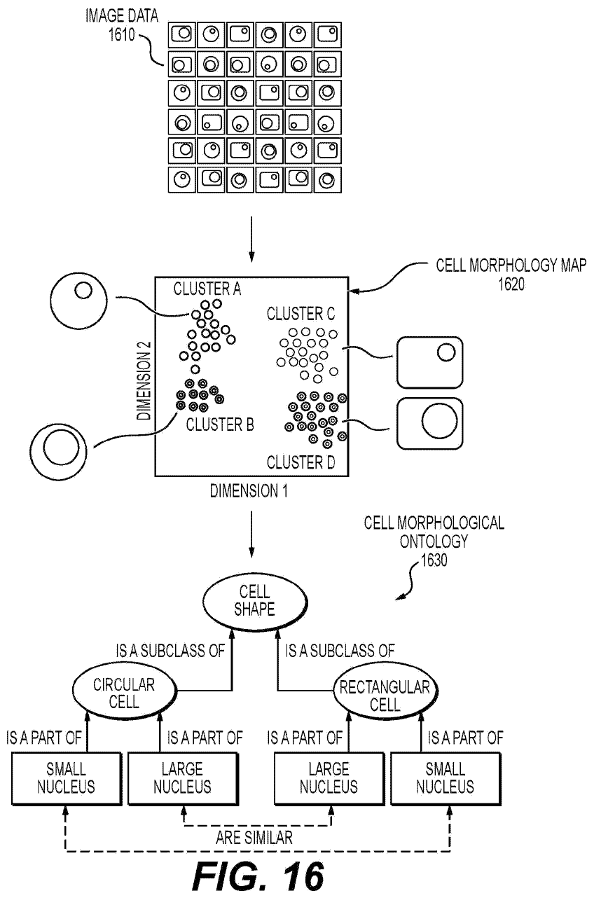

FIG. 16 schematically illustrates different ways of representing analysis data of image data of cells. Tag-free image data 1610 of cells (e.g., circular cells and square cells) having different nuclei (e.g., small nucleus and large nucleus) may be analyzed by any of the methods disclosed herein (e.g., based on extraction of one or more morphological features). For example, any of the classifier(s) disclosed herein may be used to analyze and plot the image data 1610 into a cell morphology map 1620, comprising four distinguishable clusters: cluster A (circular cell, small nucleus), cluster B (circular cell, large nucleus), cluster C (square cell, small nucleus), and cluster D (square cell, large nucleus). The classifier(s) may also represent the analysis in a cell morphological ontology 1630, in which a top node (“cell shape”) may be connected to two sub-nodes (“circular cell” and “rectangular cell”) via an edge (“is a subclass of”) to define the relationship between the nodes. Each sub-node may also be connected to its own sub-nodes (“small nucleus” and “large nucleus”) via an edge (“is a part of”) to define their relationships. The sub-nodes (e.g., “small nucleus” and “large nucleus”) may also be connected using one or more edges (“are similar”) to further define their relationship.

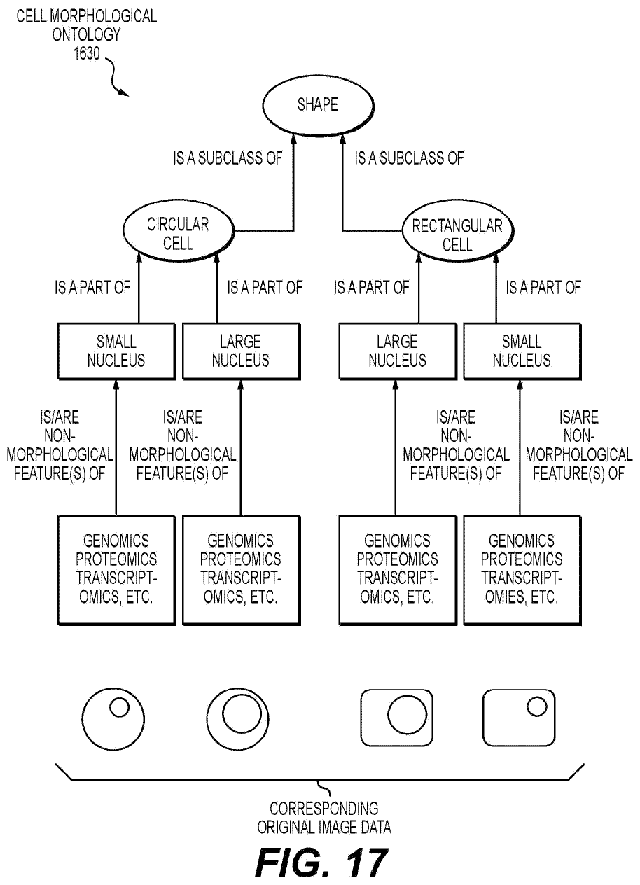

The cell morphology map or cell morphological ontology as disclosed herein may be further annotated with one or more non-morphological data of each cell. As shown in FIG. 17, the ontology 1630 from FIG. 16 may be further annotated with information about the cells that may not be extractable from the image data used to classify the cells (e.g., molecular profiles obtained using molecular barcodes, as disclosed herein). Non-limiting examples of such non-morphological data may be from additional treatment and/or analysis, including, but not limited to, cell culture (e.g., proliferation, differentiation, etc.), cell permeabilization and fixation, cell staining by a probe, mass cytometry, multiplexed ion beam imaging (MIBI), confocal imaging, nucleic acid (e.g., DNA, RNA) or protein extraction, polymerase chain reaction (PCR), target nucleic acid enrichment, sequencing, sequence mapping, etc.

Examples of the probe used for cell staining (or tagging) may include, but are not limited to, a fluorescent probe (e.g., for staining chromosomes such as X, Y, 13, 18 and 21 in fetal cells), a chromogenic probe, a direct immunoagent (e.g. labeled primary antibody), an indirect immunoagent (e.g., unlabeled primary antibody coupled to a secondary enzyme), a quantum dot, a fluorescent nucleic acid stain (such as DAPI, Ethidium bromide, Sybr green, Sybr gold, Sybr blue, Ribogreen, Picogreen, YoPro-1, YoPro-2 YoPro-3, YOYo, Oligreen acridine orange, thiazole orange, propidium iodine, or Hoeste), another probe that emits a photon, or a radioactive probe.

In some examples, the instrument(s) for the additional analysis may comprise a computer executable logic that performs karyotyping, in situ hybridization (ISH) (e.g., fluorescence in situ hybridization (FISH), chromogenic in situ hybridization (CISH), nanogold in situ hybridization (NISH)), restriction fragment length polymorphism (RFLP) analysis, polymerase chain reaction (PCR) techniques, flow cytometry, electron microscopy, quantum dot analysis, or detects single nucleotide polymorphisms (SNPs) or levels of RNA.

Analysis of the image data (e.g., extracting one or more morphological features form the image data, determining clustering and/or cell morphology map based on the image data, etc.) may be performed (e.g., automatically) within less than about 1 hour—e.g., less than about 50 minutes, or less than about 40 minutes, or less than about 30 minutes, or less than about 25 minutes, or less than about 20 minutes, or less than about 15 minutes, or less than about 10 minutes, or less than about 9 minutes, or less than about 8 minutes, or less than about 7 minutes, or less than about 6 minutes, or less than about 5 minutes, or less than about 4 minutes, or less than about 3 minutes, or less than about 2 minutes, or less than about 1 minute, or less than about 50 seconds, or less than about 40 seconds, or less than about 30 seconds, or less than about 20 seconds, or less than about 10 seconds, or less than about 5 seconds, about 1 second, or less. In some examples, such analysis may be performed in real-time.

One or more morphological features utilized for generating the clusters or the cell morphology map, as disclosed herein, may be selected automatically (e.g., by one or more machine learning algorithms) or, in another example, selected manually by a user via a user interface (e.g., graphical user interface (GUI)). The GUI may show visualization of, for example, (i) the one or more morphological parameters extracted from the image data (e.g., represented as images, words, symbols, predefined codes, etc.), (ii) the cell morphology map comprising one or more clusters, or (iii) the cell morphological ontology. The user may select, via the GUI, which morphological parameter(s) to be used to generate the clusters and the cell morphological map prior to actual generation of the clusters and the cell morphological map. The user may, upon seeing or receiving a report about the generated clusters and the cell morphological map, retroactively modify the types of morphological parameter(s) to use, thereby to (i) modify the clustering or the cell morphological mapping and/or (ii) create new cluster(s) or new cell morphological map(s). In some examples, the user may select one or more regions to be excluded or included for further analysis or further processing of the cells (e.g., sorting in the future or in real-time). For example, a microfluidic system as disclosed herein may be utilized to capture image(s) of each cell from a population of cells, and any of the methods disclosed herein may be utilized to analyze such image data to generate a cell morphology map comprising clusters representing the population of cells. The user may select one or more clusters or sub-clusters to be sorted, and the input may be provided to the microfluidic system to sort at least a portion of the cells into one or more sub-channels of the microfluidic system (e.g., in real-time) accordingly. In another example, the user may select one or more clusters or sub-clusters to be excluded during sorting (e.g., to get rid of artifacts, debris, or dead cells), and the input may be provided to the microfluidic system to sort at least a portion of the cells into one or more sub-channels of the microfluidic system (e.g., in real-time) accordingly without such artifacts, debris, or dead cells.

The cell morphology map or cell morphological ontology as disclosed herein may be further annotated with one or more non-morphological data of each cell. As shown in FIG. 17, the ontology 1630 from FIG. 16 may be further annotated with information about the cells that may not be extractable from the image data used to classify the cells (e.g., molecular profiles obtained via molecular barcodes, as disclosed herein). Non-limiting examples of such non-morphological data may be from additional treatment and/or analysis, including, but not limited to, cell culture (e.g., proliferation, differentiation, etc.), cell permeabilization and fixation, cell staining by a probe, mass cytometry, multiplexed ion beam imaging (MIBI), confocal imaging, nucleic acid (e.g., DNA, RNA) or protein extraction, polymerase chain reaction (PCR), target nucleic acid enrichment, sequencing, sequence mapping, etc.

Examples of the probe used for cell staining (or tagging) may include, but are not limited to, a fluorescent probe (e.g., for staining chromosomes such as X, Y, 13, 18 and 21 in fetal cells), a chromogenic probe, a direct immunoagent (e.g. labeled primary antibody), an indirect immunoagent (e.g., unlabeled primary antibody coupled to a secondary enzyme), a quantum dot, a fluorescent nucleic acid stain (such as DAPI, Ethidium bromide, Sybr green, Sybr gold, Sybr blue, Ribogreen, Picogreen, YoPro-1, YoPro-2 YoPro-3, YOYo, Oligreen acridine orange, thiazole orange, propidium iodine, or Hoeste), another probe that emits a photon, or a radioactive probe.

In some examples, the instrument(s) for the additional analysis may comprise a computer executable logic that performs karyotyping, in situ hybridization (ISH) (e.g., florescence in situ hybridization (FISH), chromogenic in situ hybridization (CISH), nanogold in situ hybridization (NISH)), restriction fragment length polymorphism (RFLP) analysis, polymerase chain reaction (PCR) techniques, flow cytometry, electron microscopy, quantum dot analysis, or detects single nucleotide polymorphisms (SNPs) or levels of RNA.

Analysis of the image data (e.g., extracting one or more morphological features form the image data, determining clustering and/or cell morphology map based on the image data, etc.) may be performed (e.g., automatically) within less than about 1 hour, 50 minutes, 40 minutes, 30 minutes, 25 minutes, 20 minutes, 15 minutes, 10 minutes, 9 minutes, 8 minutes, 7 minutes, 6 minutes, 5 minutes, 4 minutes, 3 minutes, 2 minutes, 1 minute, 50 seconds, 40 seconds, 30 seconds, 20 seconds, 10 seconds, 5 seconds, 1 second, or less. In some examples, such analysis may be performed in real-time.

One or more morphological features utilized for generating the clusters or the cell morphology map, as disclosed herein, may be selected automatically (e.g., by one or more machine learning algorithms) or, in another example, selected manually by a user via a user interface (e.g., graphical user interface (GUI)). The GUI may show visualization of, for example, (i) the one or more morphological parameters extracted from the image data (e.g., represented as images, words, symbols, predefined codes, etc.), (ii) the cell morphology map comprising one or more clusters, or (iii) the cell morphological ontology. The user may select, via the GUI, which morphological parameter(s) to be used to generate the clusters and the cell morphological map prior to actual generation of the clusters and the cell morphological map. The user may, upon seeing or receiving a report about the generated clusters and the cell morphological map, retroactively modify the types of morphological parameter(s) to use, thereby to (i) modify the clustering or the cell morphological mapping and/or (ii) create new cluster(s) or new cell morphological map(s). In some examples, the user may select one or more regions to be excluded or included for further analysis or further processing of the cells (e.g., sorting in the future or in real-time). For example, a microfluidic system as disclosed herein may be utilized to capture image(s) of each cell from a population of cells, and any of the methods disclosed herein may be utilized to analyze such image data to generate a cell morphology map comprising clusters representing the population of cells. The user may select one or more clusters or sub-clusters to be sorted, and the input may be provided to the microfluidic system to sort at least a portion of the cells into one or more sub-channels of the microfluidic system (e.g., in real-time) accordingly. In another example, the user may select one or more clusters or sub-clusters to be excluded during sorting (e.g., to get rid of artifacts, debris, or dead cells), and the input may be provided to the microfluidic system to sort at least a portion of the cells into one or more sub channels of the microfluidic system (e.g., in real-time) accordingly without such artifacts, debris, or dead cells.

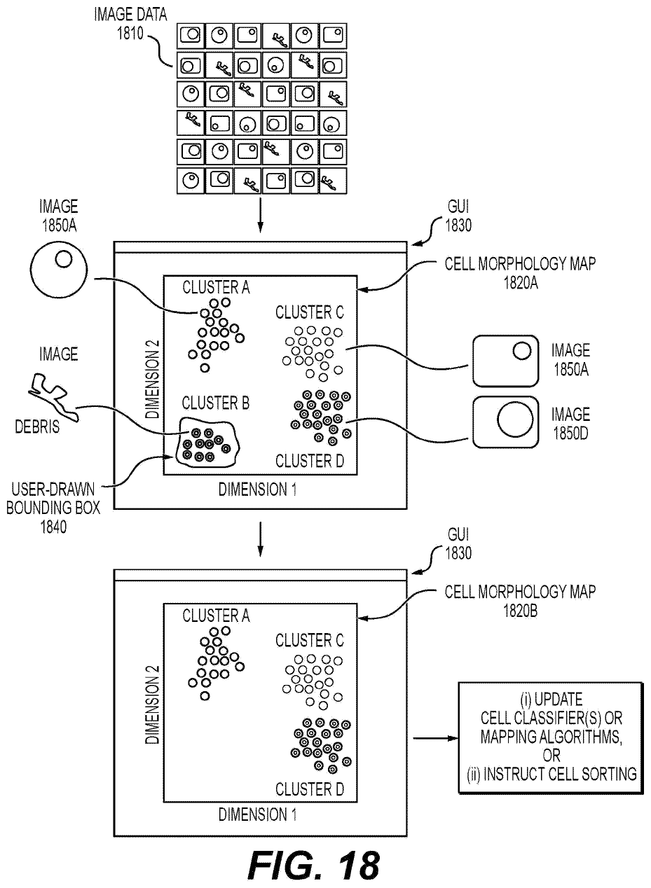

FIG. 18 schematically illustrates a method for a user to interact (e.g., via GUI) with any one of the methods disclosed herein. Image data 1810 of a plurality of cells may be processed, via any one of the methods disclosed herein, to generate a cell morphology map 1820A that represents the plurality of cells as datapoints in different clusters A, B, C, and D. The cell morphology map 1820A may be displayed to the user via the GUI 1830. The user may select each cluster or a datapoint within each cluster to visualize one or more images 1850a, b, c, or d of the cells classified into the cluster. Upon visualization of the images, the user may draw a box 1840 (e.g., via any user-defined shape and/or size) around one or more datapoints or around a cluster. For example, the user may draw a box 1840 around a cluster of “debris” datapoints, to, e.g., remove the selected cluster and generate a new cell morphology map 1820B. The user input may be used to update cell classifying algorithms, mapping algorithms, cell flowing mechanism (e.g., velocity of cells, positioning of the cells within a flow channel, adjusting imaging focal length/plane of one or more sensors/cameras of an imaging module (also referred to as an imaging device herein) that captures one or more images/videos of cells flowing through the cartridge, etc.), cell sorting mechanisms in the flow channel, cell sorting instructions in the flow channel, etc. For example, upon the user's selection, the classifier may be trained to identify one or more common morphological features within the selected datapoints (e.g., features that distinguish the selected datapoints from the unselected data). Features of the selected group may be used to further identify other cells from other samples having similar feature(s) for further analysis or discard cells having similar feature(s), e.g., for cell sorting.

The present disclosure also describes a cell analysis platform, e.g., for analyzing or classifying a cell. The cell analysis platform may be a product of any one of the methods disclosed herein. In another example, or in addition to, the cell analysis platform may be used as a basis to execute any one of the methods disclosed herein. For example, the cell analysis platform may be used to process image data comprising tag-free images of single cells to generate a new cell morphology map of various cell clusters. In another example, the cell analysis platform may be used to process image data comprising tag-free images of single cells to compare the cell to pre-determined (e.g., pre-analyzed) images of known cells or cell morphology map(s), such that the single cells from the image data may be classified, e.g., for cell sorting.

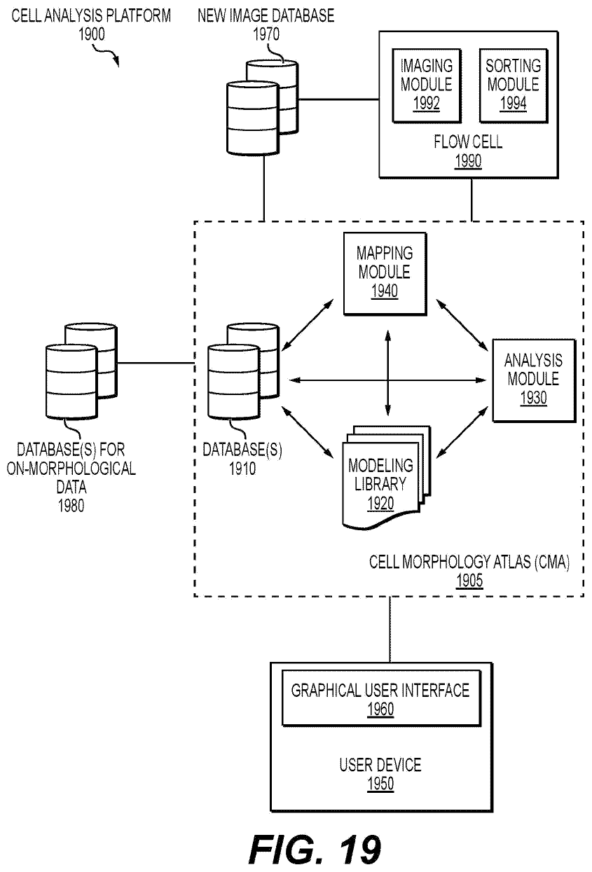

FIG. 19 illustrates an example cell analysis platform (e.g., machine learning/artificial intelligence platform) for analyzing image data of one or more cells. The cell analysis platform 1900 may comprise a cell morphology atlas (CMA) 1905. The CMA 1905 may comprise a database 1910 having a plurality of annotated single cell images that are grouped into morphologically-distinct clusters (e.g., represented a texts, as cell morphology map(s), or cell morphological ontology(ies)) corresponding to a plurality of classifications (e.g., predefined cell classes). The CMA 1905 may comprise a modeling unit comprising one or more models (e.g., modeling library 1920 comprising, such as, one or more machine learning algorithms disclosed herein) that are trained and validated using datasets from the CMA 1905, to process image data comprising images/videos of one or more cells to identify different cell types and/or states based at least on morphological features. The CMA 1905 may comprise an analysis module 1930 comprising one or more classifiers as disclosed herein. The classifier(s) may use one or more of the models from the modeling library 1920 to, e.g., (1) classify one or more images taken from a sample, (2) assess a quality or state of the sample based on the one or more images, (3) map one or more datapoints representing such one or more images onto a cell morphology map (or cell morphological ontology) via using a mapping module 1940. The CMA 1905 may be operatively coupled to one or more additional database 1970 to receive the image data comprising the images/videos of one or more cells. For example, the image data from the database 1970 may be obtained from an imaging module 1992 of a cartridge 1990, which may also be operatively coupled to the CMA 1905. The cartridge may direct flow of a sample comprising or suspected of comprising a target cell, and capture one or more images of contents (e.g., cells) within the sample by the imaging module 1992. Any image data obtained by the imaging module 1992 may be transmitted directly to the CMA 1905 and/or to the new image database 1970. In another example, the CMA 1905 may be operatively coupled to one or more additional databases 1980 comprising non-morphological data of any of the cells (e.g., genomics, transcriptomics, or proteomics, etc.), e.g., to further annotate any of the datapoint, cluster, map, ontology, images, as disclosed herein. The CMA 1905 may be operatively coupled to a user device 1950 (e.g., a computer or a mobile device comprising a display) comprising a GUI 1960 for the user to receive information from and/or to provide input (e.g., instructions to modify or assist any portion of the method disclosed herein). Any classification made by the CMA and/or the user may be provided as an input to the sorting module 1994 of the cartridge 1990. Based on the classification, the sorting module may determine, for example, (i) when to activate one or more sorting mechanisms at the sorting junction of the cartridge 1990 to sort one or more cells of interest, (ii) which sub-channel of a plurality of sub channels to direct each single cell for sorting. In some examples, the sorted cells may be collected for further analysis, e.g., downstream molecular assessment and/or profiling, such as genomics, transcriptomics, proteomics, metabolomics, etc.

Any of the methods or platforms disclosed herein may be used as a tool that permits a user to train one or more models (e.g., from the modeling library) for cell clustering and/or cell classification. For example, a user may provide initial image dataset of a sample to the platform, and the platform may process the initial set of image data. Based on the processing, the platform may determine a number of labels and/or an amount of data that the user needs to train the one or more models, based on the initial image dataset of the sample. In some examples, the platform may determine that the initial set of image data may be insufficient to provide an accurate cell classification or cell morphology map. For example, the platform may plot an initial cell morphology map and recommend to the user the number of labels and/or the amount of data needed to for enhanced processing, classification, and/or sorting, based on proximity (or separability), correlation, or commonality of the datapoints in the map (e.g., whether there is no distinguishable clusters within the map, whether the clusters within the map are too close to each other, etc.). In another example, the platform may allow the user to select different model (e.g., clustering model) or classifier, different combinations of models or classifiers, to re-analyze the initial set of image data.

Any of the methods or platforms disclosed herein may be used to determine quality or state of the image(s) of the cell, that of the cell, or that of a sample comprising the cell. The quality or state of the cell may be determined at a single cell level. In another example, the quality or state of the cell may be determined at an aggregate level (e.g., as a whole sample, or as a portion of the sample). The quality or state may be determined and reported based on, e.g., a number system (e.g., a number scale from about 1 to about 10, a percentage scale from about 1% to about 100%), a symbolic system, or a color system. For example, the quality or state may be indicative of a preparation or priming condition of the sample (e.g., whether the sample has a sufficient number of cells, whether the sample has too many artifacts, debris, etc.) or indicative of a viability of the sample (e.g., whether the sample has an amount of “dead” cells above a predetermined threshold).

Any of the methods or platforms disclosed herein may be used to sort cells in silico (e.g., prior to actual sorting of the cells using a microfluidic channel). The in silico sorting may be, e.g., to discriminate among and/or between, e.g., multiple different cell types (e.g., different types of cancer cells, different types of immune cells, etc.), cell states, cell qualities. The methods and platforms disclosed herein may utilize pre-determined morphological properties (e.g., provided in the platform) for the discrimination. In another example, newly abstracted morphological properties may be abstracted (e.g., generated) based on the input data for the discrimination. In some examples, new model(s) and/or classifier(s) may be trained or generated to process the image data. In some examples, the newly abstracted morphological properties may be used to discriminate among and/or between, e.g., multiple different cell types, cell states, cell qualities that are known. In another example, the newly abstracted morphological properties may be used to create new class (or classifications) to sort the cells (e.g., in silico or via the microfluidic system). The newly abstracted morphological properties as disclosed herein may enhance accuracy or sensitivity of cell sorting (e.g., in silico or via the microfluidic system).

Subsequent to the in silico sorting of the cells, the actual cell sorting of the cells (e.g., via the microfluidic system or cartridge) based on the in silico sorting may be performed within less than about 1 hours, for example less than about 50 minutes, or less than about 40 minutes, or less than about 30 minutes, or less than about 25 minutes, or less than about 20 minutes, or less than about 15 minutes, or less than about 10 minutes, or less than about 9 minutes, or less than about 8 minutes, or less than about 7 minutes, or less than about 6 minutes, or less than about 5 minutes, or less than about 4 minutes, or less than about 3 minutes, or less than about 2 minutes, or less than about 1 minute, or less than about 50 seconds, or less than about 40 seconds, or less than about 30 seconds, or less than about 20 seconds, or less than about 10 seconds, or less than about 5 seconds, or less than about 1 second, or less. In some examples, the in silico sorting and the actual sorting may occur in real-time.

In any of the methods or platforms disclosed herein, the model(s) and/or classifier(s) may be validated (e.g., for the ability to demonstrate accurate cell classification performance). Non-limiting examples of validation metrics that may be utilized may include, but are not limited to, threshold metrics (e.g., accuracy, F-measure, Kappa, Macro-Average Accuracy, Mean-Class-Weighted Accuracy, Optimized Precision, Adjusted Geometric Mean, Balanced Accuracy, etc.), the ranking methods and metrics (e.g., receiver operating characteristics (ROC) analysis or “ROC area under the curve (ROC AUC)”), and the probabilistic metrics (e.g., root-mean-squared error). For example, the model(s) or classifier(s) may be determined to be balanced or accurate when the ROC AUC is greater than about 0.5, greater than about 0.55, greater than about 0.6, greater than about 0.65, greater than about 0.7, greater than about 0.75, greater than about 0.8, greater than about 0.85, greater than about 0.9, greater than about 0.91, greater than about 0.92, greater than about 0.93, greater than about 0.94, greater than about 0.95, greater than about 0.96, greater than about 0.97, greater than about 0.98, greater than about 0.99, or more.

In any of the methods or platforms disclosed herein, the image(s) of the cell(s) may be obtained when the cell(s) are prepared and diluted in a sample (e.g., a buffer sample). The cell(s) may be diluted, e.g., in comparison to real-life concentrations of the cell in the tissue (e.g., solid tissue, blood, serum, spinal fluid, urine, etc.) to a dilution concentration. The methods or platforms disclosed herein may be compatible with a sample (e.g., a biological sample or derivative thereof) that is diluted by a factor of about 500 to about 1,000,000. The methods or platforms disclosed herein may be compatible with a sample that is diluted by a factor of at least about 500. The methods or platforms disclosed herein may be compatible with a sample that is diluted by a factor of at most about 1,000,000. The methods or platforms disclosed herein may be compatible with a sample that is diluted by a factor of about 500 to about 1,000, about 500 to about 2,000, about 500 to about 5,000, about 500 to about 10,000, about 500 to about 20,000, about 500 to about 50,000, about 500 to about 100,000, about 500 to about 200,000, about 500 to about 500,000, about 500 to about 1,000,000, about 1,000 to about 2,000, about 1,000 to about 5,000, about 1,000 to about 10,000, about 1,000 to about 20,000, about 1,000 to about 50,000, about 1,000 to about 100,000, about 1,000 to about 200,000, about 1,000 to about 500,000, about 1,000 to about 1,000,000, about 2,000 to about 5,000, about 2,000 to about 10,000, about 2,000 to about 20,000, about 2,000 to about 50,000, about 2,000 to about 100,000, about 2,000 to about 200,000, about 2,000 to about 500,000, about 2,000 to about 1,000,000, about 5,000 to about 10,000, about 5,000 to about 20,000, about 5,000 to about 50,000, about 5,000 to about 100,000, about 5,000 to about 200,000, about 5,000 to about 500,000, about 5,000 to about 1,000,000, about 10,000 to about 20,000, about 10,000 to about 50,000, about 10,000 to about 100,000, about 10,000 to about 200,000, about 10,000 to about 500,000, about 10,000 to about 1,000,000, about 20,000 to about 50,000, about 20,000 to about 100,000, about 20,000 to about 200,000, about 20,000 to about 500,000, about 20,000 to about 1,000,000, about 50,000 to about 100,000, about 50,000 to about 200,000, about 50,000 to about 500,000, about 50,000 to about 1,000,000, about 100,000 to about 200,000, about 100,000 to about 500,000, about 100,000 to about 1,000,000, about 200,000 to about 500,000, about 200,000 to about 1,000,000, or about 500,000 to about 1,000,000. The methods or platforms disclosed herein may be compatible with a sample that is diluted by a factor of at least about 500, for example, at least about 1,000, at least about 2,000, at least about 5,000, at least about 10,000, at least about 20,000, at least about 50,000, at least about 100,000, at least about 200,000, at least about 500,000, or at least about 1,000,000, or more.

In any of the methods or platforms disclosed herein, the classifier may generate a prediction probability (e.g., based on the morphological clustering and analysis) that an individual cell or a cluster of cells belongs to a cell class (e.g., within a predetermined cell class provided in the CMA as disclosed herein), e.g., via a reporting module. The reporting module may communicate with the user via a GUI as disclosed herein. In another example, the classifier may generate a prediction vector that an individual cell or a cluster of cells belongs to a plurality of cell classes (e.g., a plurality of all of predetermined cell classes from the CMA as disclosed herein). The vector may be ID (e.g., a single row of different cell classes), 2D (e.g., two dimensions, such as tissue origin vs. cell type), 3D, etc. In some examples, based on processing and analysis of image data obtained from a sample, the classifier may generate a report showing a composition of the sample, e.g., a distribution of one or more cell types, each cell type indicated with a relative proportion within the sample. Each cell of the sample may also be annotated with a most probable cell type and one or more less probably cell types.

Any one of the methods and platforms disclosed herein may be capable of processing image data of one or more cells to generate one or more morphometric maps of the one or more cells. Non-limiting examples of morphometric models may be utilized to analyze one or more images of single cells (or cell clusters) may include, e.g., simple morphometries (e.g., based on lengths, widths, masses, angles, ratios, areas, etc.), landmark-based geometric morphometries (e.g., spatial information, intersections, etc. of one or more components of a cell), procrustes-based geometric morphometries (e.g., by removing non-shape information that is altered by translation, scaling, and/or rotation from the image data), Euclidean distance matrix analysis, diffeomorphometry, and outline analysis. The morphometric map(s) may be multi-dimensional (e.g., 2D, 3D, etc.). The morphometric map(s) may be reported to the user via the GUI.

Any of the methods or platforms disclosed herein (e.g., the analysis module) may be used to process, analyze, classify, and/or compare two or more samples (e.g., at least about 2, for example at least about 3, or at least about 4, or at least about 5, or at least about 6, or at least about 7, or at least about 8, or at least about 9, or at least about 10, or more test samples). The two or more samples may each be analyzed to determine a morphological profile (e.g., a cell morphology map) of each sample. For example, the morphological profiles of the two or more samples may be compared for identifying a disease state of a patient's sample in comparison to a health cohort's sample or a sample of image data representative of a disease of interest. In another example, the morphological profiles of the two or more samples may be compared to monitor a progress of a condition of a subject, e.g., comparing first image data of a first set of cells from a subject before a treatment (e.g., a test drug maydidate, chemotherapy, surgical resection of solid tumors, etc.) and second image data of a second set of cells from the subject after the treatment. The second set of cells may be obtained from the subject at least about 1 week, for example at least about 2 weeks, at least about 3 weeks, at least about 4 weeks, at least about 2 months, or at least about 3 months, or more, subsequent to obtaining the first set of cells from the subject. In a different example, the morphological profiles of the two or more samples may be compared to monitor effects of two or more different treatment options (e.g., different test drugs) in two or more different cohorts (e.g., human subjects, animal subjects, or cells being tested in vitro/ex vivo). Accordingly, the systems and methods disclosed herein may be utilized (e.g., using sorting or enrichment of a cell type of interest or a cell exhibiting a characteristic of interest) to select a drug and/or a therapy that yields a desired effect (e.g., a therapeutic effect greater than equal to a threshold value).

Any of the platforms disclosed herein (e.g., cell analysis platform) may provide an inline end-to-end pipeline solution for continuous labeling and/or sorting of multiple different cell types and/or states based at least in part on (e.g., based solely on) morphological analysis of imaging data provided. A modeling library used by the platform may be scalable for large amount of data, extensible (e.g., one or more models or classifiers modified), and/or generalizable (e.g., more resistant to data perturbations—such as artifacts, debris, random objects in the background, image/video distortions—between samples. Any of the modeling library may be removed or updated with new model automatically by the machine learning algorithms or artificial intelligence, or by the user.

Any of the methods and platforms disclosed herein may adjust one or more parameters of the microfluidic system as disclosed herein. As cells are flowing through a flow channel, an imaging module (e.g., sensors, cameras) may capture image(s)/video(s) of the cells and generate new image data. The image data may be processed and analyzed (e.g., in real-time) by the methods and platforms of the present disclosure to train a model (e.g., machine learning model) to determine whether or not to adjust one or more parameters of the microfluidic system.

In some examples, the model(s) may determine that the cells are flowing too fast or too slow, and send an instruction to the microfluidic system to adjust (i) the velocity of the cells (e.g., via adjusting velocity of the fluid medium carrying the cells) and/or (ii) image recording rate of a camera that is capturing images/videos of cells flowing through the flow channel.

In some examples, the model(s) may determine that the cells are in-focus or out-of-focus in the images/videos, and send an instruction to the microfluidic system to (i) adjust a positioning of the cells within the cartridge (e.g., move the cell towards or away from the center of the flow channel via, for example, hydrodynamic focusing and/or inertial focusing) and/or (ii) adjust a focal length/plane of the camera that is capturing images/videos of cells flowing through the flow channel. Adjusting the focal length/plane may be performed for the same cell that has been analyzed (e.g., adjusting focal length/plane of a camera that is downstream) or a subsequent cell. Adjusting the focal length/plane may enhance clarity or reduce blurriness in the images. The focal length/plane may be adjusted based on a classified type or state of the cell. In some examples, adjusting the focal length/plane may allow enhanced focusing/clarity on all parts of the cell. In some examples, adjusting the focal length/plane may allow enhanced focusing/clarity on different portions (but not all parts) of the cell. Without wishing to be bound by any particular theory, out-of-focus images may be usable for any of the methods disclosed herein to extract morphological feature(s) of the cell that otherwise may not be abstracted from in-focus images, or vice versa. Thus, in some examples, instructing the imaging module to capture both in-focus and out-of-focus images of the cells may enhance accuracy of any of the analysis of cells disclosed herein.

In another example, the model(s) may send an instruction to the microfluidic system to modify the flow and adjust an angle of the cell relative to the camera, to adjust focus on different portions of the cell or a subsequent cell. Different portions as disclosed herein may comprise an upper portion, a mid portion, a lower portion, membrane, nucleus, mitochondria, etc. of the cell.

In order to image cells at the right focus (with respect to height or z dimension), what is conventionally done is to calculate the “focus measure” of an image using information theoretic methods like Fourier Transform or Laplace transform.

In some examples, bi-directional out-of-focus (OOF) images cells (e.g., one or more first images that are OOF in a first direction, and one or more second images that are OOF in as second direction that is different—such as opposite—from the first direction). For example, images that are OOF in two opposite directions may be called “bright OOF” image(s) and “dark OOF” image(s), which may be obtained by changing the z-focus bi-directionally. A classifier as disclosed herein may be trained with a image data comprising both bright OOF image(s) and dark OOF image(s). The trained classifiers may be used to run inferences (e.g., in real-time) on new image data of cells to classify each image as bright OOF image, dark OOF image, and in one example image that is not OOF (e.g., not OOF relative to the bright/dark OOF images). The classifier may also measure a percentage of bright OOF image, a percentage of dark OOF image, or a percentage of both bright and dark OOF images within the image data. For example, if any of the percentage of bright OOF image, the percentage of dark OOF image, or the percentage of both bright and dark OOF images is above a threshold value (e.g., a predetermined threshold value), then the classifier may determine that the imaging device (e.g., by the microfluidic system as disclosed herein) may not be imaging cells at the right focal length/plane. The classifier may instruct the user, via GUI of a user device, to adjust the imaging device's focal length/plane. In some examples, the classifier may determine, based on analysis of the image data comprising OOF images, direction and degree of adjustment of focal length/plane that may be required to adjust the imaging device, to yield a reduced amount of OOF imaging. In some examples, the classifier and the microfluidic device may be operatively coupled to a machine learning/artificial intelligence controller, such that the focal length/plane of the imaging device may be adjusted automatically upon determination of the classifier.

A threshold (e.g., a predetermined threshold) of a percentage of OOF images (e.g., bright OOF, dark OOF, or both) may be about 0.1% to about 20%. A threshold (e.g., a predetermined threshold) of a percentage of OOF images (e.g., bright OOF, dark OOF, or both) may be at least about 0.1%. A threshold (e.g., a predetermined threshold) of a percentage of OOF images (e.g., bright OOF, dark OOF, or both) may be at most about 20%. A threshold (e.g., a predetermined threshold) of a percentage of OOF images (e.g., bright OOF, dark OOF, or both) may be about 0.1% to about 0.5%, about 0.1% to about 1%, about 0.1% to about 2%, about 0.1% to about 4%, about 0.1% to about 6%, about 0.1% to about 8%, about 0.1% to about 10%, about 0.1% to about 15%, about 0.1% to about 20%, about 0.5% to about 1%, about 0.5% to about 2%, about 0.5% to about 4%, about 0.5% to about 6%, about 0.5% to about 8%, about 0.5% to about 10%, about 0.5% to about 15%, about 0.5% to about 20%, about 1% to about 2%, about 1% to about 4%, about 1% to about 6%, about 1% to about 8%, about 1% to about 10%, about 1% to about 15%, about 1% to about 20%, about 2% to about 4%, about 2% to about 6%, about 2% to about 8%, about 2% to about 10%, about 2% to about 15%, about 2% to about 20%, about 4% to about 6%, about 4% to about 8%, about 4% to about 10%, about 4% to about 15%, about 4% to about 20%, about 6% to about 8%, about 6% to about 10%, about 6% to about 15%, about 6% to about 20%, about 8% to about 10%, about 8% to about 15%, about 8% to about 20%, about 10% to about 15%, about 10% to about 20%, or about 15% to about 20%. A threshold (e.g., a predetermined threshold) of a percentage of OOF images (e.g., bright OOF, dark OOF, or both) may be at least about 0.1%, for example at least about 0.5%, or at least about 1%, or at least about 2%, or at least about 4%, or at least about 6%, or at least about 8%, or at least about 10%, or at least about 15%, or at least or about 20%, or more.

In some examples, the model(s) may determine that images of different modalities are needed for any of the analysis disclosed herein. Images of varying modalities may comprise a bright field image, a dark field image, a fluorescent image (e.g., of cells stained with a dye), an in-focus image, an out-of-focus image, a greyscale image, a monochrome image, a multi-chrome image, etc.

Any of the models or classifiers disclosed herein may be trained on a set of image data that is annotated with one imaging modality. In another example, the models/classifiers may be trained on set of image data that is annotated with a plurality of different imaging modalities (e.g., about 2, about 3, about 4, about 5, or more different imaging modalities). Any of the models/classifiers disclosed herein may be trained on a set of image data that is annotated with a spatial coordinate indicative of a position or location within the flow channel. Any of the models/classifiers disclosed herein may be trained on a set of image data that is annotated with a timestamp, such that a set of images may be processed based on the time they are taken.

An image of the image data may be processed in various image processing methods, such as horizontal or vertical image flips, orthogonal rotation, gaussian noise, contrast variation, or noise introduction to mimic microscopic particles or pixel-level aberrations. One or more of the processing methods may be used to generate replicas of the image or analyze the image. In some examples, the image may be processed into a lower-resolution image or a lower-dimension image (e.g., by using one or more deconvolution algorithm).

In any of the methods disclosed herein, processing an image or video from image data may comprise identifying, accounting for, and/or excluding one or more artifacts from the image/video, either automatically or manually by a user. Upon identification, the artifact(s) may be fed into any of the models or classifiers, to train image processing or image analysis. The artifact(s) may be accounted for when classifying the type or state of one or more cells in the image/video. The artifact(s) may be excluded from any determination of the type or state of the cell(s) in the image/video. The artifact(s) may be removed in silico by any of the models/classifiers disclosed herein, and any new replica or modified variant of the image/video excluding the artifact(s) may be stored in a database as disclosed herein. The artifact(s) may be, for example, from debris (e.g., dead cells, dust, etc.), optical conditions during capturing the image/video of the cells (e.g., lighting variability, over-saturation, under-exposure, degradation of the light source, etc.), external factors (e.g., vibrations, misalignment of the microfluidic chip relative to the lighting or optical sensor/camera, power surges/fluctuations, etc.), and changes to the microfluidic system (e.g., deformation/shrinkage/expansion of the microfluidic channel or the microfluidic chip as a whole). The artifacts may be known. The artifacts may be unknown, and the models or classifiers disclosed herein may be configured to define one or more parameters of a new artifact, such that the new artifact may be identified, accounted for, and/or excluded in image processing and analysis.

In some examples, a plurality of artifacts disclosed herein may be identified, accounted for, and/or excluded during image/video processing or analysis. The plurality of artifacts may be weighted the same (e.g., determined to have the same degree of influence on the image/video processing or analysis) or may have different weights (e.g., determined to have different degrees of influence on the image/video processing or analysis). Weight assignments to the plurality of artifacts may be instructed manually by the user or determined automatically by the models/classifiers disclosed herein.

In some examples, one or more reference images or videos of the flow channel (e.g., with or without any cell) may be stored in a database and used as a frame of reference to help identify, account for, and/or exclude any artifact. The reference image(s)/video(s) may be obtained before use of the microfluidic system. The reference image(s)/video(s) may be obtained during the use of the microfluidic system. The reference image(s)/video(s) may be obtained periodically during the use of the microfluidic system, such as, each time the optical sensor/camera captures at least about 5, for example at least about 10, at least about 20, at least about 50, at least about 100, at least about 200, at least about 500, at least about 1,000, at least about 2,000, at least about 5,000, at least about 10,000, at least about 20,000, at least about 50,000, or at least about 100,000 images, or more. The reference image(s)/video(s) may be obtained periodically during the use of the microfluidic system, such as, each time the microfluidic system passes at least about 5, for example at least about 10, at least about 20, at least about 50, at least about 100, at least about 200, at least about 500, at least about 1,000, at least about 2,000, at least about 5,000, at least about 10,000, at least about 20,000, at least about 50,000, at least about 100,000 cells, or more. The reference image(s)/video(s) may be obtained at landmark periods during the use of the system, such as, when the optical sensor/camera captures at least about 5, for example at least about 10, at least about 20, at least about 50, at least about 100, at least about 200, at least about 500, at least about 1,000, at least 2,000, at least about 5,000, at least about 10,000, at least about 20,000, at least about 50,000, at least about 100,000 images, or more. The reference image(s)/video(s) may be obtained at landmark periods during the use of the microfluidic system, such as, when the microfluidic system passes at least about 5, for example at least about 10, at least about 20, at least about 50, at least about 100, at least about 200, at least about 500, at least about 1,000, at least about 2,000, at least about 5,000, at least about 10,000, at least about 20,000, at least about 50,000, at least about 100,000, or more, images.

The method and the platform as disclosed herein may be utilized to process (e.g., modify, analyze, classify) the image data at a rate of about 1,000 images/second to about 100,000,000 images/second. The rate of image data processing may be at least about 1,000 images/second. The rate of image data processing may be at most about 100,000,000 images/second. The rate of image data processing may be about 1,000 images/second to about 5,000 images/second, about 1,000 images/second to about 10,000 images/second, about 1,000 images/second to about 50,000 images/second, about 1,000 images/second to about 100,000 images/second, about 1,000 images/second to about 500,000 images/second, about 1,000 images/second to about 1,000,000 images/second, about 1,000 images/second to about 5,000,000 images/second, about 1,000 images/second to about 10,000,000 images/second, about 1,000 images/second to about 50,000,000 images/second, about 1,000 images/second to about 100,000,000 images/second, about 5,000 images/second to about 10,000 images/second, about 5,000 images/second to about 50,000 images/second, about 5,000 images/second to about 100,000 images/second, about 5,000 images/second to about 500,000 images/second, about 5,000 images/second to about 1,000,000 images/second, about 5,000 images/second to about 5,000,000 images/second, about 5,000 images/second to about 10,000,000 images/second, about 5,000 images/second to about 50,000,000 images/second, about 5,000 images/second to about 100,000,000 images/second, about 10,000 images/second to about 50,000 images/second, about 10,000 images/second to about 100,000 images/second, about 10,000 images/second to about 500,000 images/second, about 10,000 images/second to about 1,000,000 images/second, about 10,000 images/second to about 5,000,000 images/second, about 10,000 images/second to about 10,000,000 images/second, about 10,000 images/second to about 50,000,000 images/second, about 10,000 images/second to about 100,000,000 images/second, about 50,000 images/second to about 100,000 images/second, about 50,000 images/second to about 500,000 images/second, about 50,000 images/second to about 1,000,000 images/second, about 50,000 images/second to about 5,000,000 images/second, about 50,000 images/second to about 10,000,000 images/second, about 50,000 images/second to about 50,000,000 images/second, about 50,000 images/second to about 100,000,000 images/second, about 100,000 images/second to about 500,000 images/second, about 100,000 images/second to about 1,000,000 images/second, about 100,000 images/second to about 5,000,000 images/second, about 100,000 images/second to about 10,000,000 images/second, about 100,000 images/second to about 50,000,000 images/second, about 100,000 images/second to about 100,000,000 images/second, about 500,000 images/second to about 1,000,000 images/second, about 500,000 images/second to about 5,000,000 images/second, about 500,000 images/second to about 10,000,000 images/second, about 500,000 images/second to about 50,000,000 images/second, about 500,000 images/second to about 100,000,000 images/second, about 1,000,000 images/second to about 5,000,000 images/second, about 1,000,000 images/second to about 10,000,000 images/second, about 1,000,000 images/second to about 50,000,000 images/second, about 1,000,000 images/second to about 100,000,000 images/second, about 5,000,000 images/second to about 10,000,000 images/second, about 5,000,000 images/second to about 50,000,000 images/second, about 5,000,000 images/second to about 100,000,000 images/second, about 10,000,000 images/second to about 50,000,000 images/second, about 10,000,000 images/second to about 100,000,000 images/second, or about 50,000,000 images/second to about 100,000,000 images/second. The rate of image data processing may be at least about 1,000 images/second, for example at least about 5,000 images/second, at least about 10,000 images/second, at least about 50,000 images/second, at least about 100,000 images/second, at least about 500,000 images/second, at least about 1,000,000 images/second, at least about 5,000,000 images/second, at least about 10,000,000 images/second, at least about 50,000,000 images/second, or at least about 100,000,000 images/second, or more.

The method and the platform as disclosed herein may be utilized to process (e.g., modify, analyze, classify) the image data at a rate of about 1,000 cells/second to about 100,000,000 cells/second. The rate of image data processing may be at least about 1,000 cells/second. The rate of image data processing may be at most about 100,000,000 cells/second. The rate of image data processing may be about 1,000 cells/second to about 5,000 cells/second, about 1,000 cells/second to about 10,000 cells/second, about 1,000 cells/second to about 50,000 cells/second, about 1,000 cells/second to about 100,000 cells/second, about 1,000 cells/second to about 500,000 cells/second, about 1,000 cells/second to about 1,000,000 cells/second, about 1,000 cells/second to about 5,000,000 cells/second, about 1,000 cells/second to about 10,000,000 cells/second, about 1,000 cells/second to about 50,000,000 cells/second, about 1,000 cells/second to about 100,000,000 cells/second, about 5,000 cells/second to about 10,000 cells/second, about 5,000 cells/second to about 50,000 cells/second, about 5,000 cells/second to about 100,000 cells/second, about 5,000 cells/second to about 500,000 cells/second, about 5,000 cells/second to about 1,000,000 cells/second, about 5,000 cells/second to about 5,000,000 cells/second, about 5,000 cells/second to about 10,000,000 cells/second, about 5,000 cells/second to about 50,000,000 cells/second, about 5,000 cells/second to about 100,000,000 cells/second, about 10,000 cells/second to about 50,000 cells/second, about 10,000 cells/second to about 100,000 cells/second, about 10,000 cells/second to about 500,000 cells/second, about 10,000 cells/second to about 1,000,000 cells/second, about 10,000 cells/second to about 5,000,000 cells/second, about 10,000 cells/second to about 10,000,000 cells/second, about 10,000 cells/second to about 50,000,000 cells/second, about 10,000 cells/second to about 100,000,000 cells/second, about 50,000 cells/second to about 100,000 cells/second, about 50,000 cells/second to about 500,000 cells/second, about 50,000 cells/second to about 1,000,000 cells/second, about 50,000 cells/second to about 5,000,000 cells/second, about 50,000 cells/second to about 10,000,000 cells/second, about 50,000 cells/second to about 50,000,000 cells/second, about 50,000 cells/second to about 100,000,000 cells/second, about 100,000 cells/second to about 500,000 cells/second, about 100,000 cells/second to about 1,000,000 cells/second, about 100,000 cells/second to about 5,000,000 cells/second, about 100,000 cells/second to about 10,000,000 cells/second, about 100,000 cells/second to about 50,000,000 cells/second, about 100,000 cells/second to about 100,000,000 cells/second, about 500,000 cells/second to about 1,000,000 cells/second, about 500,000 cells/second to about 5,000,000 cells/second, about 500,000 cells/second to about 10,000,000 cells/second, about 500,000 cells/second to about 50,000,000 cells/second, about 500,000 cells/second to about 100,000,000 cells/second, about 1,000,000 cells/second to about 5,000,000 cells/second, about 1,000,000 cells/second to about 10,000,000 cells/second, about 1,000,000 cells/second to about 50,000,000 cells/second, about 1,000,000 cells/second to about 100,000,000 cells/second, about 5,000,000 cells/second to about 10,000,000 cells/second, about 5,000,000 cells/second to about 50,000,000 cells/second, about 5,000,000 cells/second to about 100,000,000 cells/second, about 10,000,000 cells/second to about 50,000,000 cells/second, about 10,000,000 cells/second to about 100,000,000 cells/second, or about 50,000,000 cells/second to about 100,000,000 cells/second. The rate of image data processing may be at least about 1,000 cells/second, for example at least about 5,000 cells/second, at least about 10,000 cells/second, at least about 50,000 cells/second, at least about 100,000 cells/second, at least about 500,000 cells/second, at least about 1,000,000 cells/second, at least about 5,000,000 cells/second, at least about 10,000,000 cells/second, at least about 50,000,000 cells/second, or at least about 100,000,000 cells/second, or more.

The method and the platform as disclosed herein may be utilized to process (e.g., modify, analyze, classify) the image data at a rate of about 1,000 datapoints/second to about 100,000,000 datapoints/second. The rate of image data processing may be at least about 1,000 datapoints/second. The rate of image data processing may be at most about 100,000,000 datapoints/second. The rate of image data processing may be about 1,000 datapoints/second to about 5,000 datapoints/second, about 1,000 datapoints/second to about 10,000 datapoints/second, about 1,000 datapoints/second to about 50,000 datapoints/second, about 1,000 datapoints/second to about 100,000 datapoints/second, about 1,000 datapoints/second to about 500,000 datapoints/second, about 1,000 datapoints/second to about 1,000,000 datapoints/second, about 1,000 datapoints/second to about 5,000,000 datapoints/second, about 1,000 datapoints/second to about 10,000,000 datapoints/second, about 1,000 datapoints/second to about 50,000,000 datapoints/second, about 1,000 datapoints/second to about 100,000,000 datapoints/second, about 5,000 datapoints/second to about 10,000 datapoints/second, about 5,000 datapoints/second to about 50,000 datapoints/second, about 5,000 datapoints/second to about 100,000 datapoints/second, about 5,000 datapoints/second to about 500,000 datapoints/second, about 5,000 datapoints/second to about 1,000,000 datapoints/second, about 5,000 datapoints/second to about 5,000,000 datapoints/second, about 5,000 datapoints/second to about 10,000,000 datapoints/second, about 5,000 datapoints/second to about 50,000,000 datapoints/second, about 5,000 datapoints/second to about 100,000,000 datapoints/second, about 10,000 datapoints/second to about 50,000 datapoints/second, about 10,000 datapoints/second to about 100,000 datapoints/second, about 10,000 datapoints/second to about 500,000 datapoints/second, about 10,000 datapoints/second to about 1,000,000 datapoints/second, about 10,000 datapoints/second to about 5,000,000 datapoints/second, about 10,000 datapoints/second to about 10,000,000 datapoints/second, about 10,000 datapoints/second to about 50,000,000 datapoints/second, about 10,000 datapoints/second to about 100,000,000 datapoints/second, about 50,000 datapoints/second to about 100,000 datapoints/second, about 50,000 datapoints/second to about 500,000 datapoints/second, about 50,000 datapoints/second to about 1,000,000 datapoints/second, about 50,000 datapoints/second to about 5,000,000 datapoints/second, about 50,000 datapoints/second to about 10,000,000 datapoints/second, about 50,000 datapoints/second to about 50,000,000 datapoints/second, about 50,000 datapoints/second to about 100,000,000 datapoints/second, about 100,000 datapoints/second to about 500,000 datapoints/second, about 100,000 datapoints/second to about 1,000,000 datapoints/second, about 100,000 datapoints/second to about 5,000,000 datapoints/second, about 100,000 datapoints/second to about 10,000,000 datapoints/second, about 100,000 datapoints/second to about 50,000,000 datapoints/second, about 100,000 datapoints/second to about 100,000,000 datapoints/second, about 500,000 datapoints/second to about 1,000,000 datapoints/second, about 500,000 datapoints/second to about 5,000,000 datapoints/second, about 500,000 datapoints/second to about 10,000,000 datapoints/second, about 500,000 datapoints/second to about 50,000,000 datapoints/second, about 500,000 datapoints/second to about 100,000,000 datapoints/second, about 1,000,000 datapoints/second to about 5,000,000 datapoints/second, about 1,000,000 datapoints/second to about 10,000,000 datapoints/second, about 1,000,000 datapoints/second to about 50,000,000 datapoints/second, about 1,000,000 datapoints/second to about 100,000,000 datapoints/second, about 5,000,000 datapoints/second to about 10,000,000 datapoints/second, about 5,000,000 datapoints/second to about 50,000,000 datapoints/second, about 5,000,000 datapoints/second to about 100,000,000 datapoints/second, about 10,000,000 datapoints/second to about 50,000,000 datapoints/second, about 10,000,000 datapoints/second to about 100,000,000 datapoints/second, or about 50,000,000 datapoints/second to about 100,000,000 datapoints/second. The rate of image data processing may be at least about 1,000 datapoints/second, for example at least about 5,000 datapoints/second, at least about 10,000 datapoints/second, at least about 50,000 datapoints/second, at least about 100,000 datapoints/second, at least about 500,000 datapoints/second, at least about 1,000,000 datapoints/second, at least about 5,000,000 datapoints/second, at least about 10,000,000 datapoints/second, at least about 50,000,000 datapoints/second, or at least about 100,000,000 datapoints/second, or more.

Any of the methods or platforms disclosed herein may be operatively coupled to an online crowdsourcing platform. The online crowdsourcing platform may comprise any of the database disclosed herein. For example, the database may store a plurality of single cell images that are grouped into morphologically-distinct clusters corresponding to a plurality of cell classes (e.g., predetermined cell types or states). The online crowdsourcing platform may comprise one or more models or classifiers as disclosed herein (e.g., a modeling library comprising one or more machine learning models/classifiers as disclosed herein). The online crowdsourcing platform may comprise a web portal for a community of users to share contents, e.g., (1) upload, download, search, curate, annotate, or edit one or more existing images or new images into the database, (2) train or validate the one or more model(s)/classifier(s) using datasets from the database, and/or (3) upload new models into the modeling library. In some examples, the online crowdsourcing platform may allow users to buy, sell, share, or exchange the model(s)/classifier(s) with one another.

In some examples, the web portal may be configured to generate incentives for the users to update the database with new annotated cell images, model(s), and/or classifier(s). Incentives may be monetary. Incentives may be additional access to the global CMA, model(s), and/or classified s). In some examples, the web portal may be configured to generate incentives for the users to download, use, and review (e.g., rate or leave comments) any of the annotated cell images, model(s), and/or classifier(s) from, e.g., other users.

In some examples, a global cell morphology atlas (global CMA) may be generated by collecting (i) annotated cell images, (ii) cell morphology maps or ontologies, (iii), and/or (iv) classifiers from the users via the web portal. The global CMA may then be shared with the users via the web portal. All users may have access to the global CMA. In another example, specifically defined users may have access to specifically defined portions of the global CMA. For example, cancer centers may have access to “cancer cells” portion of the global CMA, e.g., via a subscription based service. In a similar fashion, global models or classifiers may be generated based on the annotated cell images, model(s), and/or classifiers that are collected from the users via the web portal.

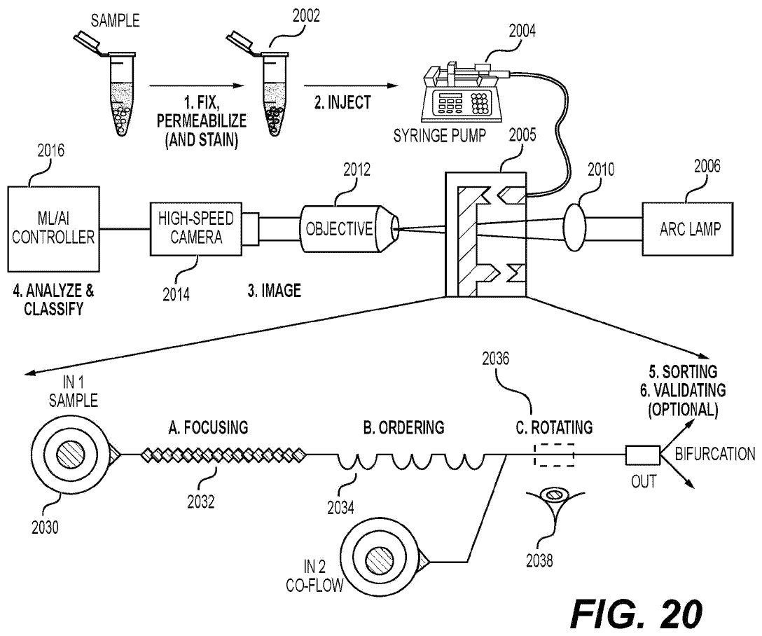

FIG. 20 shows a schematic illustration of the cell sorting system, as disclosed herein, with a cartridge design (e.g., a microfluidic design), with further details illustrated in FIG. 20B. The cell sorting system may be operatively coupled to a machine learning or artificial intelligence controller. Such ML/AI controller may be configured to perform any of the methods disclosed herein. Such ML/AI controller may be operatively coupled to, or included within, any of the platforms disclosed herein.

In operation, a sample 2002 is prepared and injected by a pump 2004 (e.g., a syringe pump) into a cartridge 2005, or flow-through device. In some examples, the cartridge 2005 is a microfluidic device. Although FIG. 20 illustrates a classification and/or sorting system utilizing a syringe pump, any of a number of perfusion systems may be used such as (but not limited to) gravity feeds, peristalsis, or any of a number of pressure systems. In some examples, the sample is prepared by fixation and staining. In some examples, the sample comprises live cells. As may readily be appreciated, the specific manner in which the sample is prepared is largely dependent upon the requirements of a specific application.

Examples of the pump 2004, or other suitable flow unit for flowing a sample through cartridge 2005 may be, but are not limited to, a syringe pump, a vacuum pump, an actuator (e.g., linear, pneumatic, hydraulic, etc.), a compressor, or any other suitable device to exert pressure (positive, negative, alternating thereof, etc.) to a fluid that may or may not comprise one or more particles (e.g., one or more cells to be classified, sorted, and/or analyzed). The pump or other suitable flow unit may be configured to raise, compress, move, and/or transfer fluid into or away from the microfluidic channel. In some examples, the pump or other suitable flow unit may be configured to deliver positive pressure, alternating positive pressure and vacuum pressure, negative pressure, alternating negative pressure and vacuum pressure, and/or only vacuum pressure. The cartridge of the present disclosure may comprise (or otherwise be in operable communication with) at least about 1—e.g., at least about 2, at least about 3, at least about 4, at least about 5, at least about 6, at least about 7, at least about 8, at least about 9, at least about 10, or more, pumps or other flow units. The cartridge may comprise at most about 10, for example at most about 9, at most about 8, at most about 7, at most about 6, at most about 5, at most about 4, at most about 3, at most about 2, or at most about 1 pumps or other suitable flow units.

Each pump or other suitable flow unit may be in fluid communication with at least about 1, e.g., at least about 2, at least about 3, at least about 4, at least about 5, at least about 6, at least about 7, at least about 8, at least about 9, at least about 10, or more sources of fluid. Each flow unit may be in fluid communication with at most about 10, for example at most about 9, at most about 8, at most about 7, at most about 6, at most about 5, at most about 4, at most about 3, at most about 2, or at most about 1 fluid. The fluid may contain the particles (e.g., cells). In another example, the fluid may be particle-free. The pump or other suitable flow unit may be configured to maintain, increase, and/or decrease a flow velocity of the fluid within the microfluidic channel of the flow unit. Thus, the pump or other suitable flow unit may be configured to maintain, increase, and/or decrease a flow velocity (e.g., downstream of the microfluidic channel) of the particles. The pump or other suitable flow unit may be configured to accelerate or decelerate a flow velocity of the fluid within the microfluidic channel of the flow unit, thereby accelerating or decelerating a flow velocity of the particles.

The fluid may be liquid or gas (e.g., air, argon, nitrogen, etc.). The liquid may be an aqueous solution (e.g., water, buffer, saline, etc.). In another example, the liquid may be oil. In some examples, only one or more aqueous solutions may be directed through the microfluidic channels. In another example, only one or more oils may be directed through the microfluidic channels. In another alternative, both aqueous solution(s) and oil(s) may be directed through the microfluidic channels. In some examples, (i) the aqueous solution may form droplets (e.g., emulsions containing the particles) that are suspended in the oil, or (ii) the oil may form droplets (e.g., emulsions containing the particles) that are suspended in the aqueous solution. As may readily be appreciated, any perfusion system, including but not limited to peristalsis systems and gravity feeds, appropriate to a given classification and/or sorting system may be utilized.

As noted above, the cartridge 2005 may be implemented as a fluidic device that focuses cells from the sample into a single streamline that is imaged continuously. In the illustrated example, the cell line is illuminated by a light source 2006 (e.g., a lamp, such as an arc lamp) and an optical system 2010 that directs light onto an imaging region 2038 of the cartridge 2005. An objective lens system 2012 magnifies the cells by directing light toward the sensor of a high-speed camera system 2014.

In some examples, a 10×, 20×, 40×, 60×, 80×, 100×, or 200× objective is used to magnify the cells. In some examples, a 10×, objective is used to magnify the cells. In some examples, a 20× objective is used to magnify the cells. In some examples, a 40× objective is used to magnify the cells. In some examples, a 60× objective is used to magnify the cells. In some examples, a 80× objective is used to magnify the cells. In some examples, a 100× objective is used tog magnify the cells. In some examples, a 200× objective is used to magnify the cells. In some examples, a 10× to a 200× objective is used to magnify the cells, for example a 10×-20×, a 10×-40×, a 10×-60×, a 10×-80×, or 10×-100× objective is used to magnify the cells. As may readily be appreciated by a person having ordinary skill in the art, the specific magnification utilized may vary greatly and is largely dependent upon the requirements of a given imaging system and cell types of interest.

In some examples, one or more imaging devices may be used to capture images of the cell. In some examples, the imaging device is a high-speed camera. In some examples, the imaging device is a high-speed camera with a micro-second exposure time. In some instances, the exposure time is less than about 1 millisecond. In some instances, the exposure time is between about 1 millisecond (ms) and about 0.75 millisecond. In some instances, the exposure time is between about 1 ms and about 0.50 ms. In some instances, the exposure time is between about 1 ms and about 0.25 ms. In some instances, the exposure time is between about 0.75 ms and about 0.50 ms. In some instances, the exposure time is between about 0.75 ms and about 0.25 ms. In some instances, the exposure time is between about 0.50 ms and about 0.25 ms. In some instances, the exposure time is between about 0.25 ms and about 0.1 ms. In some instances, the exposure time is between about 0.1 ms and about 0.01 ms. In some instances, the exposure time is between about 0.1 ms and about 0.001 ms. In some instances, the exposure time is between about 0.1 ms and about 1 microsecond (ps). In some examples, the exposure time is between about 1 ps and about 0.1 ps. In some examples, the exposure time is between about 1 ps and about 0.01 ps. In some examples, the exposure time is between about 0.1 ps and about 0.01 ps. In some examples, the exposure time is between about 1 ps and about 0.001 ps. In some examples, the exposure time is between about 0.1 ps and about 0.001 ps. In some examples, the exposure time is between about 0.01 ps and about 0.001 ps.

In some examples, the cartridge 2005 may comprise at least about 1—e.g., at least about 2, at least about 3, at least about 4, at least about 5, at least about 6, at least about 7, at least about 8, at least about 9, at least about 10, or more, imaging devices (e.g., the high-speed camera system 2014) on or adjacent to the imaging region 2038. In some examples, the cartridge may comprise at most about 10—e.g., at most about 9, at most about 8, at most about 7, at most about 6, at most about 5, at most about 4, at most about 3, at most about 2, or at most about 1 imaging device on or adjacent to the imaging region 2038. In some examples, the cartridge 2005 may comprise a plurality of imaging devices. Each of the plurality of imaging devices may use light from a same light source. In another example, each of the plurality of imaging devices may use light from different light sources. The plurality of imaging devices may be configured in parallel and/or in series with respect to one another. The plurality of imaging devices may be configured on one or more sides (e.g., two adjacent sides or two opposite sides) of the cartridge 2005. The plurality of imaging devices may be configured to view the imaging region 2038 along a same axis or different axes with respect to (i) a length of the cartridge 2005 (e.g., a length of a straight channel of the cartridge 2005) or (ii) a direction of migration of one or more particles (e.g., one or more cells) in the cartridge 2005.

One or more imaging devices of the present disclosure may be stationary while imaging one or more cells, e.g., at the imaging region 2038. In another example, one or more imaging devices may move with respect to the flow channel (e.g., along the length of the flow channel, towards and/or away from the flow channel, tangentially about the circumference of the flow channel, etc.) while imaging the one or more cells. In some examples, the one or more imaging devices may be operatively coupled to one or more actuators, such as, for example, a stepper actuator, linear actuator, hydraulic actuator, pneumatic actuator, electric actuator, magnetic actuator, and mechanical actuator (e.g., rack and pinion, chains, etc.).

In some examples, the cartridge 2005 may comprise at least about 1—e.g., at least about 2, about 3, about 4, about 5, about 6, about 7, about 8, about 9, about 10, or more, imaging regions (e.g., the imaging region 2038). In some examples, the cartridge 2005 may comprise at most about 10—e.g., at most about 9, about 8, about 7, about 6, about 5, about 4, about 3, about 2, or about 1 imaging region. In some examples, the cartridge 2015 may comprise a plurality of imaging regions, and the plurality of imaging regions may be configured in parallel and/or in series with respect to each another. The plurality of imaging regions may or may not be in fluid communication with each other. In an example, a first imaging region and a second imaging region may be configured in parallel, such that a first fluid that passes through the first imaging region does not pass through a second imaging region. In another example, a first imaging region and a second imaging region may be configured in series, such that a first fluid that passes through the first imaging region also passes through the second imaging region.

The imaging device(s) (e.g., the high-speed camera) of the imaging system may comprise an electromagnetic radiation sensor (e.g., IR sensor, color sensor, etc.) that detects at least a portion of the electromagnetic radiation that is reflected by and/or transmitted from the cartridge or any content (e.g., the cell) in the cartridge. The imaging device may be in operative communication with one or more sources (e.g., at least about 1—e.g., at least about 2, at least about 3, at least about 4, at least about 5, or more) of the electromagnetic radiation. The electromagnetic radiation may comprise one or more wavelengths from the electromagnetic spectrum including, but not limited to x-rays (about 0.1 nanometers (nm) to about 10.0 nm; or about 1018 Hertz (Hz) to about 1016 Hz), ultraviolet (UV) rays (about 10.0 nm to about 380 nm; or about 8×1016 Hz to about 1015 Hz), visible light (about 380 nm to about 750 nm; or about 8×1014 Hz to about 4×1014 Hz), infrared (IR) light (about 750 nm to about 0.1 centimeters (cm); or about 4×1014 Hz to about 5×1011 Hz), and microwaves (about 0.1 cm to about 100 cm; or about 108 Hz to about 5×1011 Hz). In some examples, the source(s) of the electromagnetic radiation may be ambient light, and thus the cell sorting system may not have an additional source of the electromagnetic radiation.

The imaging device(s) may be configured to take a two-dimensional image (e.g., one or more pixels) of the cell and/or a three-dimensional image (e.g., one or more voxels) of the cell.

As may readily be appreciated, the exposure times may differ across different systems and may largely be dependent upon the requirements of a given application or the limitations of a given system such as but not limited to flow rates. Images are acquired and may be analyzed using an image analysis algorithm.

In some examples, the images are acquired and analyzed post-capture. In some examples, the images are acquired and analyzed in real-time continuously. Using object tracking software, single cells may be detected and tracked while in the field of view of the camera.

Background subtraction may then be performed. In a number of examples, the cartridge 2006 causes the cells to rotate as they are imaged, and multiple images of each cell are provided to a computing system 2016 for analysis. In some examples, the multiple images comprise images from a plurality of cell angles.

The flow rate and channel dimensions may be determined to obtain multiple images of the same cell from a plurality of different angles (i.e., a plurality of cell angles). A degree of rotation between an angle to the next angle may be uniform or non-uniform. In some examples, a full 360° view of the cell is captured. In some examples, 4 images are provided in which the cell rotates 90° between successive frames. In some examples, 8 images are provided in which the cell rotates 45° between successive frames. In some examples, 24 images are provided in which the cell rotates 15° between successive frames. In some examples, at least three or more images are provided in which the cell rotates at a first angle between a first frame and a second frame, and the cell rotates at a second angle between the second frame and a third frame, wherein the first and second angles are different. In some examples, less than the full 360° view of the cell may be captured, and a resulting plurality of images of the same cell may be sufficient to classify the cell (e.g., determine a specific type of the cell).

The cell may have a plurality of sides. The plurality of sides of the cell may be defined with respect to a direction of the transport (flow) of the cell through the channel. In some examples, the cell may comprise a stop side, a bottom side that is opposite the top side, a front side (e.g., the side towards the direction of the flow of the cell), a rear side opposite the front side, a left side, and/or a right side opposite the left side. In some examples, the image of the cell may comprise a plurality of images captured from the plurality of angles, wherein the plurality of images comprise: (1) an image captured from the top side of the cell, (2) an image captured from the bottom side of the cell, (3) an image captured from the front side of the cell, (4) an image captured from the rear side of the cell, (5) an image captured from the left side of the cell, and/or (6) an image captured from the right side of the cell.

In some examples, a two-dimensional “hologram” of a cell may be generated by superimposing the multiple images of the individual cell. The “hologram” may be analyzed to automatically classify characteristics of the cell based upon features including but not limited to the morphological features of the cell.

In some examples, at least about 1, for example at least about 2, at least about 3, at least about 4, at least about 5, at least about 6, at least about 7, at least about 8, at least about 9, or at least about 10 images, or more, are captured for each cell. In some examples, at least about 5 or more images are captured for each cell. In some examples, from about 5 to about 10 images are captured for each cell. In some examples, at least about 10 or more images are captured for each cell. In some examples, from about 10 to about 20 images are captured for each cell. In some examples, at least about 20 or more images are captured for each cell. In some examples, from about 20 to about 50 images are captured for each cell. In some examples, at least about 50 or more images are captured for each cell. In some examples, from about 50 to about 100 images are captured for each cell. In some examples, 100 or more images are captured for each cell. In some examples, at least about 1, for example at least about 2, at least about 3, at least about 4, at least about 5, at least about 6, at least about 7, at least about 8, at least about 9, at least about 10, at least about 15, at least about 20, at least about 30, at least about 40, at least about 50, or more images may be captured for each cell at a plurality of different angles. In some examples, at most 50, for example at most about 40, at most about 30, at most about 20, at most about 15, at most about 10, at most about 9, at most about 8, at most about 7, at most about 6, at most about 5, at most about 4, at most about 3, or at most about 2 images may be captured for each cell at a plurality of different angles.

In some examples, the imaging device is moved so as to capture multiple images of the cell from a plurality of angles. In some examples, the images are captured at an angle between 0 and 90 degrees to the horizontal axis. In some examples, the images are captured at an angle between 90 and 180 degrees to the horizontal axis. In some examples, the images are captured at an angle between 180 and 270 degrees to the horizontal axis. In some examples, the images are captured at an angle between 270 and 360 degrees to the horizontal axis. In some examples, multiple imaging devices (for e.g. multiple cameras) are used wherein each device captures an image of the cell from a specific cell angle. In some examples, at least about 2, for example at least about 3, at least about 4, at least about 5, at least about 6, at least about 7, at least about 8, at least about 9, or at least about 10 cameras, or more, are used. In some examples, more than about 10 cameras are used, wherein each camera images the cell from a specific cell angle.

As may readily be appreciated, the number of images that are captured is dependent upon the requirements of a given application or the limitations of a given system. In several examples, the cartridge has different regions to focus, order, and/or rotate cells. Although the focusing regions, ordering regions, and cell rotating regions are discussed as affecting the sample in a specific sequence, a person having ordinary skill in the art would appreciate that the various regions may be arranged differently, where the focusing, ordering, and/or rotating of the cells in the sample may be performed in any order. Regions within a microfluidic device implemented in accordance with an example of the disclosure are illustrated in FIG. 20B. Cartridge 2005 may include a filtration region 2030 to prevent channel clogging by aggregates/debris or dust particles. Cells pass through a focusing region 2032 that focuses the cells into a single streamline of cells that are then spaced by an ordering region 2034. In some examples, the focusing region utilizes “inertial focusing” to form the single streamline of cells. In some examples, the focusing region utilizes “hydrodynamic focusing” to focus the cells into the single streamline of cells. In one example, prior to imaging, rotation may be imparted upon the cells by a rotation region 2036. In one example, the spinning cells may then pass through an imaging region 2038 in which the cells are illuminated for imaging prior to exiting the cartridge. These various regions are described and discussed in further detail below. In some examples, the rotation region 2036 may precede the imaging region 2038. In some examples, the rotation region 2036 may be a part (e.g., a beginning portion, a middle portion, and/or an end portion with respect to a migration of a cell within the cartridge) of the imaging region 2038. In some examples, the imaging region 2038 may be a part of the rotation region 2036. In some examples, a single cell is imaged in a field of view of the imaging device, e.g. camera. In some examples, multiple cells are imaged in the same field of view of the imaging device. In some examples, at least about 1, for example at least about 2, at least about 3, at least about 4, at least about 5, at least about 6, at least about 7, at least about 8, at least about 9, or at least about 10 cells, or more, are imaged in the same field of view of the imaging device. In some examples, up to about 100 cells are imaged in the same field of view of the imaging device. In some instances, about 10 to about 100 cells are imaged in the field of view, for example, about 10 to 20 cells, about 10 to about 30 cells, about 10 to about 40 cells, about 10 to about 50 cells, about 10 to about 60 cells, about 10 to about 80 cells, about 10 to about 90 cells, about 20 to about 30 cells, about 20 to about 40 cells, about 20 to about 50 cells, about 20 to about 60 cells, about 20 to about 70 cells, about 20 to about 80 cells, about 20 to about 90 cells, about 30 to about 40 cells, about 40 to about 50 cells, about 40 to about 60 cells, about 40 to about 70 cells, about 40 to about 80 cells, about 40 to about 90 cells, about 50 to about 60 cells, about 50 to about 70 cells, about 50 to about 80 cells, about 50 to about 90 cells, about 60 to about 70 cells, about 60 to about 80 cells, about 60 to about 90 cells, about 70 to about 80 cells, about 70 to about 90 cells, or about 90 to about 100 cells are imaged in the same field of view of the imaging device.

In some examples, only a single cell may be allowed to be transported across a cross-section of the flow channel perpendicular to the axis of the flow channel. In some examples, a plurality of cells (e.g., at least about 2, for example at least about 3, at least about 4, at least about 5, or more cells; or at most about 5, for example at most about 4, at most about 3, at most about 2, or at most about 1 cell) may be allowed to be transported simultaneously across the cross-section of the flow channel perpendicular to the axis of the flow channel. In such a example, the imaging device (or the processor operatively linked to the imaging device) may be configured to track each of the plurality of cells as they are transported along the flow channel.

The imaging system may include, among other things, a camera, an objective lens system and a light source. In a number of examples, cartridges similar to those described above may be fabricated using standard 2D microfluidic fabrication techniques, requiring minimal fabrication time and cost.

Although specific classification and/or sorting systems, cartridges, and microfluidic devices are described above with respect to FIGS. 20, classification and/or sorting systems may be implemented in any of a variety of ways appropriate to the requirements of specific applications in accordance with various examples of the disclosure. Specific elements of microfluidic devices that may be utilized in classification and/or sorting systems in accordance with some examples of the disclosure are discussed further below.

In some examples, examples, the microfluidic system may comprise a microfluidic chip (e.g., comprising one or more microfluidic channels for flowing cells) operatively coupled to an imaging device (e.g., one or more cameras). A microfluidic device may comprise the imaging device, and the chip may be inserted into the device, to align the imaging device to an imaging region of a channel of the chip. To align the chip to the precise location for the imaging, the chip may comprise one or more positioning identifiers (e.g., pattern(s), such as numbers, letters, symbols, or other drawings) that may be imaged to determine the positioning of the chip (and thus the imaging region of the channel of the chip) relative to the device as a whole or relative to the imaging device. For image-based alignment (e.g., auto-alignment) of the chip within the device, one or more images of the chip may be capture upon its coupling to the device, and the image(s) may be analyzed by any of the methods disclosed herein (e.g., using any model or classifier disclosed herein) to determine a degree or score of chip alignment. The positioning identifier(s) may be a “guide” to navigate the stage holding the chip within the device to move within the device towards a correct position relative to the imaging unit.

In some examples, rule-based image processing may be used to navigate the stage to a precise range of location or a precise location relative to the image unit.

In some examples, machine learning/artificial intelligence methods as disclosed herein may be modified or trained to identify the pattern on the chip and navigate the stage to the precise imaging location for the image unit, to increase resilience.

In some examples, machine learning/artificial intelligence methods as disclosed herein may be modified or trained to implement reinforcement learning based alignment and focusing. The alignment process for the chip to the instrument or the image unit may involve moving the stage holding the chip in, e.g., either X or Y axis and/or moving the imaging plane on the Z axis. In the training process, (i) the chip may start at a X, Y, and Z position (e.g., randomly selected), (ii) based on one or more image(s) of the chip and/or the stage holding the chip, a model may determine a movement vector for the stage and a movement for the imaging plane, (iii) depending on whether such movement vector may take the chip closer to the optimum X, Y, and Z position relative to the image unit, an error term may be determined as a loss for the model, and (iv) the magnitude of the error may be either constant or be proportional to how far the current X, Y, and Z position is from an optimal X, Y, and Z position (e.g., may be predetermined). Such trained model may be used to determine, for example, the movement vector and/or movement of the movement for the imaging plane, to enhance relative alignment between the chip and the image unit (e.g., one or more sensors). The alignment may occur subsequent to capturing of the image(s). In another example, the alignment may occur real-time while capturing images/videos of the positioning identifier(s) of the chip.

One or more flow channels of the cartridge of the present disclosure may have various shapes and sizes. For example, referring to FIGS. 20, at least a portion of the flow channel (e.g., the focusing region 2032, the ordering region 2034, the rotation region 2036, the imaging region 2038, connecting region therebetween, etc.) may have a cross-section that is circular, triangular, square, rectangular, pentagonal, hexagonal, or any partial shape or combination of shapes thereof.

In some examples, the system of the present disclosure comprises straight channels with rectangular or square cross-sections. In some examples, the system of the present disclosure comprises straight channels with round cross-sections. In some examples, the system comprises straight channels with half-ellipsoid cross-sections. In some examples, the system comprises spiral channels. In some examples, the system comprises round channels with rectangular cross-sections. In some examples, the system comprises round channels with rectangular channels with round cross-sections. In some examples, the system comprises round channels with half-ellipsoid cross-sections. In some examples, the system comprises channels that are expanding and contracting in width with rectangular cross-sections. In some examples, the system comprises channels that are expanding and contracting in width with round cross-sections. In some examples, the system comprises channels that are expanding and contracting in width with half-ellipsoid cross-sections.

The flow channel may comprise one or more walls that are formed to focus one or more cells into a streamline. The flow channel may comprise a focusing region comprising the wall(s) to focus the cell(s) into the streamline. Focusing regions on a microfluidic device may take a disorderly stream of cells and utilize a variety of forces (for e.g. inertial lift forces (wall effect and shear gradient forces) or hydrodynamic forces) to focus the cells within the flow into a streamline of cells. In some examples, the cells are focused in a single streamline. In some examples, the cells are focused in multiple streamlines, for example at least 2, at least 3, at least 4, at least 5, at least 6, at least 7, at least 8, at least 9, or at least 10 streamlines.

The focusing region receives a flow of randomly arranged cells via an upstream section. The cells flow into a region of contracted and expanded sections in which the randomly arranged cells are focused into a single streamline of cells. The focusing may be driven by the action of inertial lift forces (wall effect and shear gradient forces) acting on cells.

In some examples, the focusing region is formed with curvilinear walls that form periodic patterns. In some examples, the patterns form a series of square expansions and contractions. In other examples, the patterns are sinusoidal. In further examples, the sinusoidal patterns are skewed to form an asymmetric pattern. The focusing region may be effective in focusing cells over a wide range of flow rates. In the illustrated example, an asymmetrical sinusoidal-like structure is used as opposed to square expansions and contractions. This helps prevent the formation of secondary vortices and secondary flows behind the particle flow stream. In this way, the illustrated structure allows for faster and more accurate focusing of cells to a single lateral equilibrium position. Spiral and curved channels may also be used in an inertia regime; however, these may complicate the integration with other modules. Finally, straight channels where channel width is greater than channel height may also be used for focusing cells onto single lateral position. However, in this case, since there will be more than one equilibrium position in the z-plane, imaging may become problematic, as the imaging focal plane is preferably fixed. As may readily be appreciated, any of a variety of structures that provide a cross section that expands and contracts along the length of the microfluidic channel or are capable of focusing the cells may be utilized as appropriate to the requirements of specific applications.

The cell sorting system may be configured to focus the cell at a width and/or a height within the flow channel along an axis of the flow channel. The cell may be focused to a center or off the center of the cross-section of the flow channel. The cell may be focused to a side (e.g., a wall) of the cross-section of the flow channel. A focused position of the cell within the cross-section of the channel may be uniform or non-uniform as the cell is transported through the channel.

While specific implementations of focusing regions within microfluidic channels are described above, any of a variety of channel configurations that focus cells into a single streamline may be utilized as appropriate to the requirements of a specific application in accordance with various examples of the disclosure.

Microfluidic channels may be designed to impose ordering upon a single streamline of cells formed by a focusing region in accordance with several examples of the disclosure. Microfluidic channels in accordance with some examples of the disclosure include an ordering region having pinching regions and curved channels. The ordering region orders the cells and distances single cells from each other to facilitate imaging. In some examples, ordering is achieved by forming the microfluidic channel to apply inertial lift forces and Dean drag forces on the cells.

Different geometries, orders, and/or combinations may be used. In some examples, pinching regions may be placed downstream from the focusing channels without the use of curved channels. Adding the curved channels may help with more rapid and controlled ordering, as well as increasing the likelihood that particles follow a single lateral position as they migrate downstream. As may readily be appreciated, the specific configuration of an ordering region is largely determined based upon the requirements of a given application.

Architecture of the microfluidic channels of the cartridge of the present disclosure may be controlled (e.g., modified, optimized, etc.) to modulate cell flow along the microfluidic channels. Examples of the cell flow may include (i) cell focusing (e.g., into a single streamline) and (ii) rotation of the one or more cells as the cell(s) are migrating (e.g., within the single streamline) down the length of the microfluidic channels. In some examples, microfluidic channels may be configured to impart rotation on ordered cells in accordance with a number of examples of the disclosure. One or more cell rotation regions (e.g., the cell rotation region 2036) of microfluidic channels in accordance with some examples of the disclosure use co-flow of a particle-free buffer to induce cell rotation by using the co-flow to apply differential velocity gradients across the cells. In some examples, a cell rotation region may introduce co-flow of at least about 1, for example at least about 2, at least about 3, at least about 4, at least about 5, or more buffers (e.g., particle-free, or containing one or more particles, such as polymeric or magnetic particles) to impart rotation on one or more cells within the channel. In some examples, a cell rotation region may introduce co-flow of at most about 5, for example at most about 4, at most about 3, at most about 2, or at most about 1 buffer to impart the rotation of one or more cells within the channel. In some examples, the plurality of buffers may be co-flowed at a same position along the length of the cell rotation region, or sequentially at different positions along the length of the cell rotation region. In some examples, the plurality of buffers may be the same or different. In several examples, the cell rotation region of the microfluidic channel is fabricated using a two-layer fabrication process so that the axis of rotation is perpendicular to the axis of cell downstream migration and parallel to cell lateral migration.

Cells may be imaged in at least a portion of the cell rotating region, while the cells are tumbling and/or rotating as they migrate downstream. In another example, the cells may be imaged in an imaging region that is adjacent to or downstream of the cell rotating region. In some examples, the cells may be flowing in a single streamline within a flow channel, and the cells may be imaged as the cells are rotating within the single streamline. A rotational speed of the cells may be constant or varied along the length of the imaging region. This may allow for the imaging of a cell at different angles (e.g., from a plurality of images of the cell taken from a plurality of angles due to rotation of the cell), which may provide more accurate information concerning cellular features than may be captured in a single image or a sequence of images of a cell that is not rotating to any significant extent. This also allow a 3D reconstruction of the cell using available software since the angles of rotation across the images are known. In another example, every single image of the sequence of image many be analyzed individually to analyze (e.g., classify) the cell from each image. In some examples, results of the individual analysis of the sequence of images may be aggregated to determine a final decision (e.g., classification of the cell).

In some examples, a cell rotation region of a microfluidic channel incorporates an injected co-flow prior to an imaging region in accordance with an example of the disclosure. Co-flow may be introduced in the z plane (perpendicular to the imaging plane) to spin the cells. Since the imaging is done in the x-y plane, rotation of cells around an axis parallel to the y-axis provides additional information by rotating portions of the cell that may have been occluded in previous images into view in each subsequent image. Due to a change in channel dimensions, at point xo, a velocity gradient is applied across the cells, which may cause the cells to spin. The angular velocity of the cells depends on channel and cell dimensions and the ratio between Q1 (main channel flow rate) and Q2 (co-flow flow rate) and may be configured as appropriate to the requirements of a given application. In some examples, a cell rotation region incorporates an increase in one dimension of the microfluidic channel to initiate a change in the velocity gradient across a cell to impart rotation onto the cell. In some examples, a cell rotation region of a microfluidic channel incorporates an increase in the z-axis dimension of the cross section of the microfluidic channel prior to an imaging region in accordance with an example of the disclosure. The change in channel height may initiate a change in velocity gradient across the cell in the z axis of the microfluidic channel, which may cause the cells to rotate as with using co flow.

In some examples, the system and methods of the present disclosure focuses the cells in microfluidic channels. The term focusing as used herein broadly means controlling the trajectory of cell/cells movement and comprises controlling the position and/or speed at which the cells travel within the microfluidic channels. In some examples controlling the lateral position and/or the speed at which the particles travel inside the microfluidic channels, allows to accurately predict the time of arrival of the cell at a bifurcation. The cells may then be accurately sorted. The parameters critical to the focusing of cells within the microfluidic channels include, but are not limited to channel geometry, particle size, overall system throughput, sample concentration, imaging throughput, size of field of view, and method of sorting.

In some examples the focusing is achieved using inertial forces. In some examples, the system and methods of the present disclosure focus cells to a certain height from the bottom of the channel using inertial focusing. In these examples, the distance of the cells from the objective is equal and images of all the cells will be clear. As such, cellular details, such as nuclear shape, structure, and size appear clearly in the outputted images with minimal blur. In some examples, the system disclosed herein has an imaging focusing plane that is adjustable. In some examples, the focusing plane is adjusted by moving the objective or the stage. In some examples, the best focusing plane is found by recording videos at different planes and the plane wherein the imaged cells have the highest Fourier magnitude, thus, the highest level of detail and highest resolution, is the best plane.

In some examples, the system and methods of the present disclosure utilize a hydrodynamic-based z focusing system to obtain a consistent z height for the cells of interests that are to be imaged. In some examples, the design comprises hydrodynamic focusing using multiple inlets for main flow and side flow. In some examples, the hydrodynamic-based z focusing system is a triple-punch design. In some examples, the design comprises hydrodynamic focusing with three inlets, wherein the two side flows pinch cells at the center. For certain channel designs, dual z focus points may be created, wherein a double-punch design similar to the triple-punch design may be used to send objects to one of the two focus points to get consistent focused images. In some examples, the design comprises hydrodynamic focusing with 2 inlets, wherein only one side flow channel is used and cells are focused near channel wall. In some examples, the hydrodynamic focusing comprises side flows that do not contain any cells and a middle inlet that contains cells. The ratio of the flow rate on the side channel to the flow rate on the main channel determines the width of cell focusing region. In some examples, the design is a combination of the above. In all examples, the design is integrable with the bifurcation and sorting mechanisms disclosed herein. In some examples, the hydrodynamic-based z focusing system is used in conjunction with inertia-based z focusing.

In some examples, the cell is a live cell. In some examples, the cell is a fixed cell (e.g., in methanol or paraformaldehyde). In some examples, one or more cells may be coupled (e.g., attached covalently or non-covalently) to a substrate (e.g., a polymeric bead or a magnetic bead) while flowing through the cartridge. In some examples, the cell(s) may not be coupled to any substrate while flowing through the cartridge.

A variety of techniques may be utilized to classify images of cells captured by classification and/or sorting systems in accordance with various examples of the disclosure. In some examples, the image captures are saved for future analysis/classification either manually or by image analysis software. Any suitable image analysis software may be used for image analysis. In some examples, image analysis is performed using OpenCV. In some examples, analysis and classification is performed in real time.

In some examples, the system and methods of the present disclosure comprise collecting a plurality of images of objects in the flow. In some examples, the plurality of images comprises at least 20 images of cells. In some examples, the plurality of images comprises at least about 19, at least about 18, at least about 17, at least about 16, at least about 15, at least about 14, at least about 13, at least about 12, at least about 11, at least about 10, at least about 9, at least about 8, at least about 7, at least about 6, at least about 5, at least about 4, at least about 3, or at least about 2 images of cells. In some examples, the plurality of images comprises images from multiple cell angles. In some examples, the plurality of images, comprising images from multiple cell angles, help derive extra features from the particle which would be hidden if the particle is imaged from a single point-of-view. In some examples, without wishing to be bound by any particular theory, the plurality of images, comprising images from multiple cell angles, help derive extra features from the particle which would be hidden if a plurality of images are combined into a multi-dimensional reconstruction (e.g., a two-dimensional hologram or a three-dimensional reconstruction).

In some examples, the systems and methods of present disclosure allow for a tracking ability, wherein the system and methods track a particle (e.g., cell) under the camera and maintain the knowledge of which frames belong to the same particle. In some examples, the particle is tracked until it has been classified and/or sorted. In some examples, the particle may be tracked by one or more morphological (e.g., shape, size, area, volume, texture, thickness, roundness, etc.) and/or optical (e.g., light emission, transmission, reflectance, absorbance, fluorescence, luminescence, etc.) characteristics of the particle. In some examples, each particle may be assigned a score (e.g., a characteristic score) based on the one or more morphological and/or optical characteristics, thereby to track and confirm the particle as the particle travels through the microfluidic channel.

In some examples, the systems and methods of the disclosure comprise imaging a single particle in a particular field of view of the camera. In some examples, the same instrument that performs imaging operations may also perform sorting operations. In some examples, the system and methods of the present disclosure image multiple particles in the same field of view of camera. Imaging multiple particles in the same field of view of the camera may provide additional advantages, for example it will increase the throughput of the system by batching the data collection and transmission of multiple particles. In some instances, at least about 2, for example at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, or more particles are imaged in the same field of view of the camera. In some instances, about 100 to about 200 particles are imaged in the same field of view of the camera. In some instances, at most about 100, for example at most about 90, at most about 80, at most about 70, at most about 60, at most about 50, at most about 40, at most about 30, at most about 20, at most about 10, at most about 9, at most about 8, at most about 7, at most about 6, at most about 5, at most about 4, at most about 3, or at most about 2 particles are imaged in the same field of view of the camera. In some examples, the number of the particles (e.g., cells) that are imaged in the same field of view may not be changed throughout the operation of the cartridge. In another example, the number of the particles (e.g., cells) that are imaged in the same field of view may be changed in real-time throughout the operation of the cartridge, e.g., to increase speed of the classification and/or sorting process without negatively affecting quality or accuracy of the classification and/or soring process.

The imaging region maybe downstream of the focusing region and the ordering region. Thus, the imaging region may not be part of the focusing region and the ordering region. In an example, the focusing region may not comprise or be operatively coupled to any imaging device that is configured to capture one or more images to be used for particle analysis (e.g., cell classification).

In some examples, the systems and the methods of the present disclosure actively sorts a stream of particles. The term sort or sorting as used herein refers to physically separating particles, for e.g. cells, with one or more desired characteristics. The desired characteristic(s) may comprise a morphometric feature of the cell(s) analyzed and/or obtained from the image(s) of the cell, or a combination of such morphometric features.

Examples of the morphometric feature of the cell(s) may comprise a size, shape, volume, electromagnetic radiation absorbance and/or transmittance (e.g., fluorescence intensity, luminescence intensity, etc.), or viability (e.g., when live cells are used), or a feature selected from Table 1 or from Table 2.

The flow channel may branch into a plurality of channels, and the cell sorting system may be configured to sort the cell by directing the cell to a selected channel of the plurality of channels based on the analyzed image of the cell. The analyzed image may be indicative of one or more features of the cell, wherein the feature(s) are used as parameters of cell sorting. In some examples, one or more channels of the plurality of channels may have a plurality of sub channels, and the plurality of sub-channels may be used to further sort the cells that have been sorted once.

Cell sorting may comprise isolating one or more target cells from a population of cells. The target cell(s) may be isolated into a separate reservoir that keeps the target cell(s) separate from the other cells of the population. Cell sorting accuracy may be defined as a proportion (e.g., a percentage) of the target cells in the population of cells that have been identified and sorted into the separate reservoir. In some examples, the cell sorting accuracy of the cartridge provided herein may be at least about 80%, for example at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, a at least bout 97%, at least about 98%, at least about 99%, or more (e.g., about 99.9% or about 100%). In some examples, the cell sorting accuracy of the cartridge provided herein may be at most about 100%, for example at most about 99%, at most about 98%, at most about 97%, at most about 96%, at most about 95%, at most about 94%, at most about 93%, at most about 92%, at most about 91%, at most about 90%, at most about 89%, at most about 88%, at most about 87%, at most about 86%, at most about 85%, at most about 84%, at most about 83%, at most about 82%, at most about 81%, or at most about 80%, or less.

In some examples, cell sorting may be performed at a rate of at least about 1 cell/second, for example at least about 5 cells/second, at least about 10 cells/second, at least about 50 cells/second, at least about 100 cells/second, at least about 500 cells/second, at least about 1,000 cells/second, at least about 5,000 cells/second, at least about 10,000 cells/second, at least about 50,000 cells/second, or more. In some examples, cell sorting may be performed at a rate of at most about 50,000 cells/second, for example at most about 10,000 cells/second, at most about 5,000 cells/second, at most about 1,000 cells/second, at most about 500 cells/second, at most about 100 cells/second, at most about 50 cells/second, at most about 10 cells/second, at most about 5 cells/second, or at most about 1 cell/second, or less.

In some examples, the systems and methods disclosed herein use an active sorting mechanism. In various examples, the active sorting is independent from analysis and decision making platforms and methods. In various examples the sorting is performed by a sorter, which receives a signal from the decision making unit (e.g. a classifier), or any other external unit, and then sorts cells as they arrive at the bifurcation. The term bifurcation as used herein refers to the termination of the flow channel into two or more channels, such that cells with the one or more desired characteristics are sorted or directed towards one of the two or more channels and cell without the one or more desired characteristics are directed towards the remaining channels. In some examples, the flow channel terminates into at least about 2, for example at least about 3, at least about 4, at least about 5, at least about 6, at least about 7, at least about 8, at least about 9, at least about 10, or more channels. In some examples, the flow channel terminates into at most about 10, for example at most about 9, at most about 8, at most about 7, at most about 6, at most about 5, at most about 4, at most about 3, or at most about 2 channels. In some examples, the flow channel terminates in two channels and cells with one or more desired characteristics are directed towards one of the two channels (the positive channel), while cells without the one or more desired characteristics are directed towards the other channel (the negative channel). In some examples, the flow channel terminates in three channels and cells with a first desired characteristic are directed to one of the three channels, cells with a second desired characteristic are directed to another of the three channels, and cells without the first desired characteristic and the second desired characteristic are directed to the remaining of the three channels.

In some examples, the sorting is performed by a sorter. The sorter may function by predicting the exact time at which the particle will arrive at the bifurcation. To predict the time of particle arrival, the sorter may use any applicable method. In some examples, the sorter predicts the time of arrival of the particle by using (i) velocity of particles (e.g., downstream velocity of a particle along the length of the microfluidic channel) that are upstream of the bifurcation and (ii) the distance between velocity measurement/calculation location and the bifurcation. In some examples, the sorter predicts the time of arrival of the particles by using a constant delay time as an input.

In some examples, prior to the cell's arrival at the bifurcation, the sorter may measure the velocity of a particle (e.g., a cell) at least about 1, for example at least about 2, at least about 3, at least about 4, or at least about 5, or more times. In some examples, prior to the cell's arrival at the bifurcation, the sorter may measure the velocity of the particle at most about 5, for example at most about 4, at most about 3, at most about 2, or at most about 1 time. In some examples, the sorter may use at least about 1, for example at least about 2, at least about 3, at least about 4, or at least about 5, or more sensors. In some examples, the sorter may use at most about 5, for example at most about 4, at most about 3, at most about 2, or at most about 1 sensor. Example of the sensor(s) may be an imaging device (e.g., a camera such as a high-speed camera), one- or multi-point light (e.g., laser) detector, etc. Referring to FIGS. 20, the sorter may use any one of the imaging devices (e.g., the high-speed camera system 2014) disposed at or adjacent to the imaging region 2038. In some examples, the same imaging device(s) may be used to capture one or more images of a cell as the cell is rotating and migrating within the channel, and the one or more images may be analyzed to (i) classify the cell and (ii) measure a rotational and/or lateral velocity of the cell within the channel and predict the cell's arrival time at the bifurcation. In some examples, the sorter may use one or more sensors that are different than the imaging devices of the imaging region 2038. The sorter may measure the velocity of the particle (i) upstream of the imaging region 2038, (ii) at the imaging region 2038, and/or (iii) downstream of the imaging region 2038.

The sorter may comprise or be operatively coupled to a processor, such as a computer processor. Such processor may be the processor 2016 that is operatively coupled to the imaging device 2014 or a different processor. The processor may be configured to calculate the velocity of a particle (rotational and/or downstream velocity of the particle) an predict the time of arrival of the particle at the bifurcation. The processor may be operatively coupled to one or more valves of the bifurcation. The processor may be configured to direct the valve(s) to open and close any channel in fluid communication with the bifurcation. The processor may be configured to predict and measure when operation of the valve(s) (e.g., opening or closing) is completed.

In some examples, the sorter may comprise a self-included unit (e.g., comprising the sensors, such as the imaging device(s)) which is capable of (i) predicting the time of arrival of the articles and/or (ii) detecting the particle as it arrives at the bifurcation. In order to sort the particles, the order at which the particles arrive at the bifurcation, as detected by the self-included unit, may be matched to the order of the received signal from the decision making unit (e.g. a classifier). In some examples, controlled particles are used to align and update the order as necessary. In some examples, the decision making unit may classify a first cell, a second cell, and a third cell, respectively, and the sorter may confirm that the first cell, the second cell, and the third cell are sorted, respectively in the same order. If the order is confirmed, the classification and sorting mechanisms (or deep learning algorithms) may remain the same. If the order is different between the classifying and the sorting, then the classification and/or sorting mechanisms (or deep learning algorithms) may be updated or optimized, either manually or automatically. In some examples, the controlled particles may be cells (e.g., live or dead cells).

In some examples, the controlled particles may be special calibration beads (e.g., plastic beads, metallic beads, magnetic beads, etc.). In some examples the calibration beads used are polystyrene beads with size ranging between about 1 mM to about 50 mM. In some examples the calibration beads used are polystyrene beads with size of least about 1 μM. In some examples the calibration beads used are polystyrene beads with size of at most about 50 μM. In some examples the calibration beads used are polystyrene beads with size ranging between about 1 pM to about 3 pM, about 1 pM to about 5 pM, about 1 pM to about 6 pM, about 1 pM to about 10 pM, about 1 pM to about 15 pM, about 1 pM to about 20 pM, about 1 pM to about 25 pM, about 1 pM to about 30 pM, about 1 pM to about 35 pM, about 1 pM to about 40 pM, about 1 pM to about 50 pM, about 3 pM to about 5 pM, about 3 pM to about 6 pM, about 3 pM to about 10 pM, about 3 pM to about 15 pM, about 3 pM to about 20 pM, about 3 pM to about 25 pM, about 3 pM to about 30 pM, about 3 pM to about 35 pM, about 3 pM to about 40 pM, about 3 pM to about 50 pM, about 5 pM to about 6 pM, about 5 pM to about 10 pM, about 5 pM to about 15 pM, about 5 pM to about 20 pM, about 5 pM to about 25 pM, about 5 pM to about 30 pM, about 5 pM to about 35 pM, about 5 pM to about 40 mM, about 5 mM to about 50 mM, about 6 mM to about 10 mM, about 6 mM to about 15 mM, about 6 mM to about 20 mM, about 6 mM to about 25 mM, about 6 mM to about 30 mM, about 6 mM to about 35 mM, about 6 mM to about 40 mM, about 6 mM to about 50 mM, about 10 mM to about 15 mM, about 10 mM to about 20 mM, about 10 mM to about 25 mM, about 10 mM to about 30 mM, about 10 mM to about 35 mM, about 10 mM to about 40 mM, about 10 mM to about 50 mM, about 15 mM to about 20 mM, about 15 mM to about 25 mM, about 15 mM to about 30 mM, about 15 mM to about 35 mM, about 15 mM to about 40 mM, about 15 mM to about 50 mM, about 20 mM to about 25 mM, about 20 mM to about 30 mM, about 20 mM to about 35 mM, about 20 mM to about 40 mM, about 20 mM to about 50 mM, about 25 mM to about 30 mM, about 25 mM to about 35 mM, about 25 mM to about 40 mM, about 25 mM to about 50 mM, about 30 mM to about 35 mM, about 30 mM to about 40 mM, about 30 mM to about 50 mM, about 35 mM to about 40 mM, about 35 mM to about 50 mM, or about 40 mM to about 50 mM. In some examples the calibration beads used are polystyrene beads with size of about 1 mM, about 3 mM, about 5 mM, about 6 mM, about 10 mM, about 15 mM, about 20 mM, about 25 mM, about 30 mM, about 35 mM, about 40 mM, or about 50 mM.

In some examples, the sorter (or an additional sensor disposed at or adjacent to the bifurcation) may be configured to validate arrival of the particles (e.g., the cells) at the bifurcation. In some examples, the sorter may be configured to measure an actual arrival time of the particles (e.g., the cells) at the bifurcation. The sorter may analyze (e.g., compare) the predicted arrival time, the actual arrival time, the velocity of the particles downstream of the channel prior to any adjustment of the velocity, and/or a velocity of the particles downstream of the channel subsequent to such adjustment of the velocity. Based on the analyzing, the sorter may modify any operation (e.g., cell focusing, cell rotation, controlling cell velocity, cell classification algorithms, valve actuation processes, etc.) of the cartridge. The validation by the sorter may be used for closed-loop and real-time update of any operation of the cartridge.

In some examples, to predict the time of arrival of one or more cells for sorting, the systems, methods, and platforms disclosed herein may dynamically adjust a delay time (e.g., a constant delay time) based on imaging of the cell(s) or based on tracking of the cell(s) with light (e.g., laser). By detecting changes (e.g., flow rates, velocity of aggregate of multiple cells, the lateral location of cells in the channel, etc.) the delay time (e.g., time at which the cells arrive at the bifurcation) may be predicted and adjusted in real-time (e.g., every few milliseconds). A feedback loop may be designed that may constantly read such changes and adjust the delay time accordingly. In another example, the delay time may be adjusted for each cell/particle. The delay time may be calculated separately for each individual cell, based on, e.g., its velocity, lateral position in the channel, and/or time of arrival at specific locations along the channel (e.g., using tracking based on lasers or other methods). The calculated delay time may then be applied to the individual cell/particle (e.g., if the cell is a positive cell or a target cell, the sorting may be performed according to its specific delay time or a predetermined delay time). In some examples, the sorters used in the systems and methods disclosed herein are self-learning cell sorting systems or intelligent cell sorting systems, as disclosed herein.

These sorting systems may continuously learn based on the outcome of sorting. For example, a sample of cells is sorted, the sorted cells are analyzed, and the results of this analysis are fed back to the classifier. In some examples, the cells that are sorted as “positive” (i.e., target cells or cells of interest) may be analyzed and validated. In some examples, the cells that are sorted as “negative” (i.e., non-target cells or cells not of interest) may be analyzed and validated. In some examples, both positive and negative cells may be validated. Such validation of sorted cells (e.g., based on secondary imaging and classification) may be used for closed-loop and real-time update of the primary cell classification algorithms.

In some examples, a flush mechanism may be used during sorting. The flush mechanism may ensure that the cell which has been determined to be sorted to a specific bucket or well will end up there (e.g., not be stuck in various parts of the channel or outlet). The flush mechanism may ensure that the channel and outlets stay clean and debris-free for maximum durability. The flush mechanism may inject additional solutions/reagents (e.g., cell lysis buffers, barcoded reagents, etc.) to the well or droplet that the cell is being sorted into. The flush mechanism may be supplied by a separate set of channels and/or valves which are responsible to flow a fluid at a predefined cadence in the direction of sorting.

In some examples, the methods and systems disclosed herein may use any sorting technique to sort particles. At least a portion of the collection reservoir may or may not be pre filled with a fluid, e.g., a buffer. In some examples, the sorting technique comprises closing a channel on one side of the bifurcation to collect the desired cell on the other side. In some examples, the closing of the channels may be carried out by employing any known technique. In some examples, the closing is carried out by application of a pressure. In some instances, the pressure is pneumatic actuation. In some examples, the pressure may be positive pressure or negative pressure. In some examples, positive pressure is used. In some examples, one side of the bifurcation is closed by applying pressure and deflecting the soft membrane between top and bottom layers. Other examples of systems and methods of particle (e.g., cell) imaging, analysis, and sorting are further described in International Application No. PCT/US2017/033676 and International Application No. PCT/US2019/046557, each of which is incorporated herein by reference in its entirety.

In various examples, the systems and methods of the present disclosure comprise one or more reservoirs designed to collect the particles after the particles have been sorted. In some examples, the number of cells to be sorted is about 1 cell to about 1,000,000 cells. In some examples, the number of cells to be sorted is at least about 1 cell. In some examples, the number of cells to be sorted is at most about 1,000,000 cells. In some examples, the number of cells to be sorted is about 1 cell to about 100 cells, about 1 cell to about 500 cells, about 1 cell to about 1,000 cells, about 1 cell to about 5,000 cells, about 1 cell to about 10,000 cells, about 1 cell to about 50,000 cells, about 1 cell to about 100,000 cells, about 1 cell to about 500,000 cells, about 1 cell to about 1,000,000 cells, about 100 cells to about 500 cells, about 100 cells to about 1,000 cells, about 100 cells to about 5,000 cells, about 100 cells to about 10,000 cells, about 100 cells to about 50,000 cells, about 100 cells to about 100,000 cells, about 100 cells to about 500,000 cells, about 100 cells to about 1,000,000 cells, about 500 cells to about 1,000 cells, about 500 cells to about 5,000 cells, about 500 cells to about 10,000 cells, about 500 cells to about 50,000 cells, about 500 cells to about 100,000 cells, about 500 cells to about 500,000 cells, about 500 cells to about 1,000,000 cells, about 1,000 cells to about 5,000 cells, about 1,000 cells to about 10,000 cells, about 1,000 cells to about 50,000 cells, about 1,000 cells to about 100,000 cells, about 1,000 cells to about 500,000 cells, about 1,000 cells to about 1,000,000 cells, about 5,000 cells to about 10,000 cells, about 5,000 cells to about 50,000 cells, about 5,000 cells to about 100,000 cells, about 5,000 cells to about 500,000 cells, about 5,000 cells to about 1,000,000 cells, about 10,000 cells to about 50,000 cells, about 10,000 cells to about 100,000 cells, about 10,000 cells to about 500,000 cells, about 10,000 cells to about 1,000,000 cells, about 50,000 cells to about 100,000 cells, about 50,000 cells to about 500,000 cells, about 50,000 cells to about 1,000,000 cells, about 100,000 cells to about 500,000 cells, about 100,000 cells to about 1,000,000 cells, or about 500,000 cells to about 1,000,000 cells. In some examples, the number of cells to be sorted is more than about 1 cell, more than about 100 cells, more than about 500 cells, more than about 1,000 cells, more than about 5,000 cells, more than about 10,000 cells, more than about 50,000 cells, more than about 100,000 cells, more than about 500,000 cells, or more than about 1,000,000 cells.

In some examples, the number of cells to be sorted is about 100 to about 500 cells, about 200 to about 500 cells, about 300 to about 500 cells, about 350 to about 500 cells, about 400 to about 500 cells, or about 450 to about 500 cells. In some examples, the reservoirs may be milliliter scale reservoirs. In some examples, the one or more reservoirs are pre-filled with a buffer and the sorted cells are stored in the buffer. Using the buffer helps to increase the volume of the cells, which may then be easily handled, for example a pipetted. In some examples, the buffer is a phosphate buffer, for example phosphate-buffered saline (PBS).

In some examples, the system and methods of the present disclosure comprise a cell sorting technique wherein pockets of buffer solution containing no negative objects are sent to the positive output channel in order to push rare objects out of the collection reservoir. In some examples, additional buffer solution is sent to the positive output channel to flush out all positive objects at the end of a run, once the channel is flushed clean (e.g., using the flush mechanism as disclosed herein).

In some examples, the system and methods of the present disclosure comprise a cell retrieving technique, wherein sorted cells may be retrieved for downstream analysis (e.g., molecular analysis). Non-limiting examples of the cell retrieving technique may include: retrieval by centrifugation; direct retrieval by pipetting; direct lysis of cells in well; sorting in a detachable tube; feeding into a single cell dispenser to be deposited into 96 or 384 well plates; etc.

In some examples, the system and methods of the present disclosure comprise a combination of techniques, wherein a graphics processing unit (GPU) and a digital signal processor (DSP) are used to run artificial intelligence (AI) algorithms and apply classification results in real-time to the system. In some examples, the system and methods of the present disclosure comprise a hybrid method for real-time cell sorting.

In some examples, the system and methods of the present disclosure comprise a feedback loop (e.g., an automatic feedback loop). For example, the system and methods may be configured to (i) monitor the vital signals and (ii) finetune one or more parameters of the system and methods based on the signals being read. At the beginning or throughout the run (e.g., the use of the microfluidic channel for cell imaging, classification, and/or sorting), a processor (e.g., a ML/AI processor as disclosed herein) may specify target values for one or more selected parameters (e.g., flow rate, cell rate, etc.). In another example, other signals that reflect (e.g., automatically reflect) the quality of the run (e.g., the number of cells that are out of focus within the last 100 imaged cells) may be utilized in the feedback loop. The feedback loop may receive (e.g., in real-time) values of the parameters/signals disclosed herein and, based on the predetermined target values and/or one or more general mandates (e.g., the fewer the out-of-focus cells, the better), the feedback loop may facilitate adjustments (e.g., adjustments to pressure systems, illumination, stage, etc.). In some examples, the feedback loop may be designed to monitor and/or handle degenerate scenarios, in which the microfluidic system is not responsive or malfunctioning (e.g., outputting a value read that is out of range of acceptable reads).

In some examples, the system and methods of the present disclosure may adjust a cell classification threshold based on expected true positive rate for a sample type. The expected true positive rate may come from statistics gathered in one or more previous runs from the same or other patients with similar conditions. Such approach may help neutralize run-to-run variations (e.g., illumination, chip fabrication variation, etc.) that would impact imaging and hence any inference therefrom.

In some examples, the systems disclosed herein further comprise a validation unit that detects the presence of a particle without getting detailed information, such as imaging. In some instances, the validation unit may be used for one or more purposes. In some examples, the validation unit detects a particle approaching the bifurcation and enables precise sorting. In some examples, the validation unit detects a particle after the particle has been sorted to one of subchannels in fluid communication with the bifurcation. In some examples, the validation unit provides timing information with a plurality of laser spots, e.g., two laser spots. In some instances, the validation unit provides timing information by referencing the imaging time. In some instances, the validation unit provides precise time delay information and/or flow speed of particles.

In some examples, the particles (e.g., cells) analyzed by the systems and methods disclosed herein are comprised in a sample. The sample may be a biological sample obtained from a subject (e.g., a human or any animal). It should be appreciated that an animal may be a variety of any applicable type, including, but not limited thereto, mammals or non-mammals. For example, the animal may be a veterinarian animal, livestock animal or pet type animal, etc. As an example, the animal may be a laboratory animal specifically selected to have certain characteristics similar to a human (e.g., rat, dog, pig, monkey, or the like). It should be appreciated that the subject may be any applicable human patient, for example. In some examples, the biological sample comprises, or is derived from, a biopsy sample from a subject. In some examples, the biological sample comprises a tissue sample from a subject. In some examples, the biological sample comprises liquid biopsy from a subject. In some examples, the biological sample may be a solid biological sample, e.g., a tumor sample. In some examples, a sample from a subject may comprise at least about 1%, for example at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, at least about 99%, or at least about 100% tumor cells from a tumor.

In some examples, the sample may be, or may be derived from, a liquid biological sample. In some examples, the liquid biological sample may be a blood sample (e.g., whole blood, plasma, or serum). A whole blood sample may be subjected to separation of cellular components (e.g., plasma, serum) and cellular components by use of a Ficoll reagent. In some examples, the liquid biological sample may be a urine sample. In some examples, the liquid biological sample may be a perilymph sample. In some examples, the liquid biological sample may be a fecal sample. In some examples, the liquid biological sample may be saliva. In some examples, the liquid biological sample may be semen. In some examples, the liquid biological sample may be amniotic fluid. In some examples, the liquid biological sample may be cerebrospinal fluid. In some examples, the liquid biological sample may be bile. In some examples, the liquid biological sample may be sweat. In some examples, the liquid biological sample may be tears. In some examples, the liquid biological sample may be sputum. In some examples, the liquid biological sample may be synovial fluid. In some examples, the liquid biological sample may be vomit.

In some examples, samples may be collected over a period of time and the samples may be compared to each other or with a standard sample using the systems and methods disclosed herein. In some examples the standard sample is a comparable sample obtained from a different subject, for example a different subject that is known to be healthy or a different subject that is known to be unhealthy. Samples may be collected over regular time intervals, or may be collected intermittently over irregular time intervals.

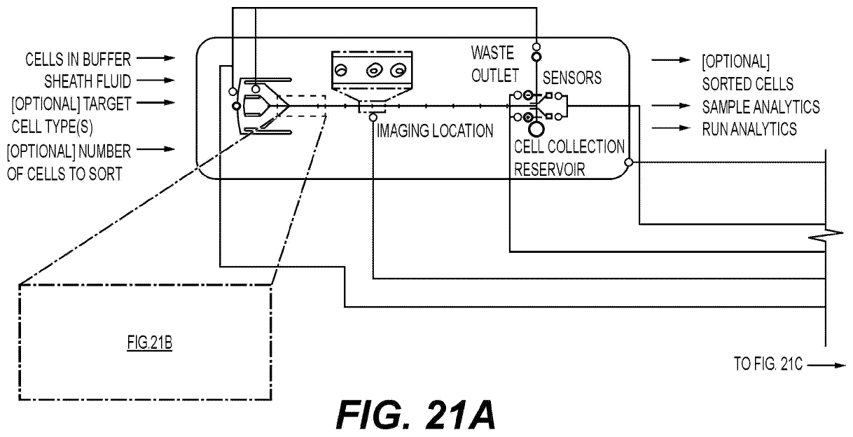

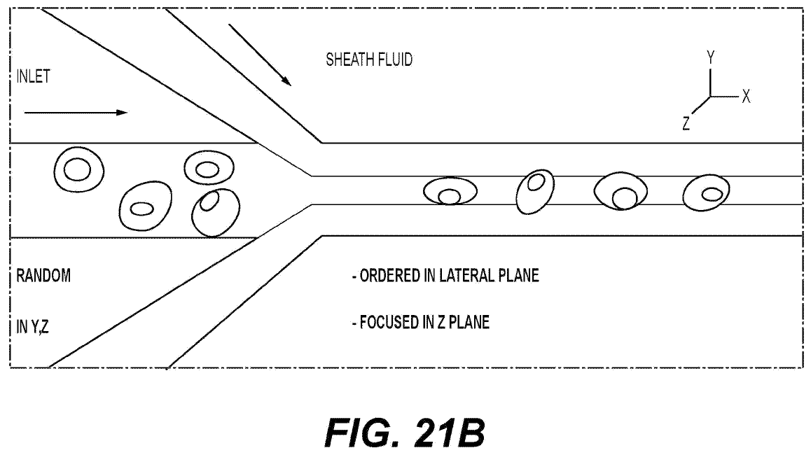

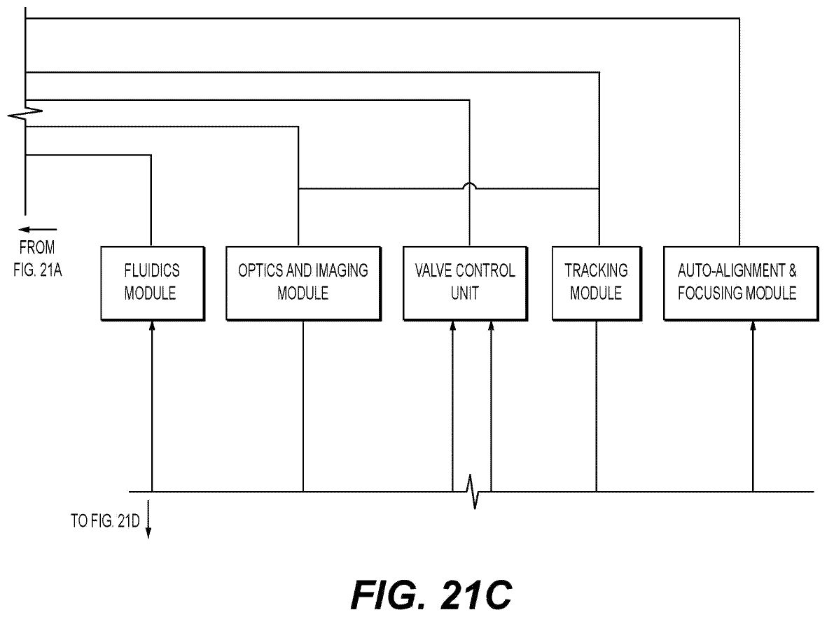

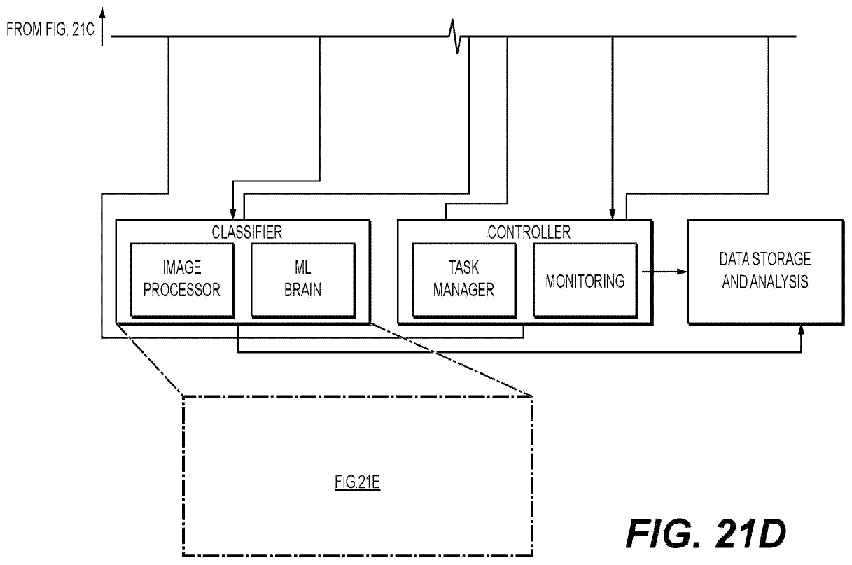

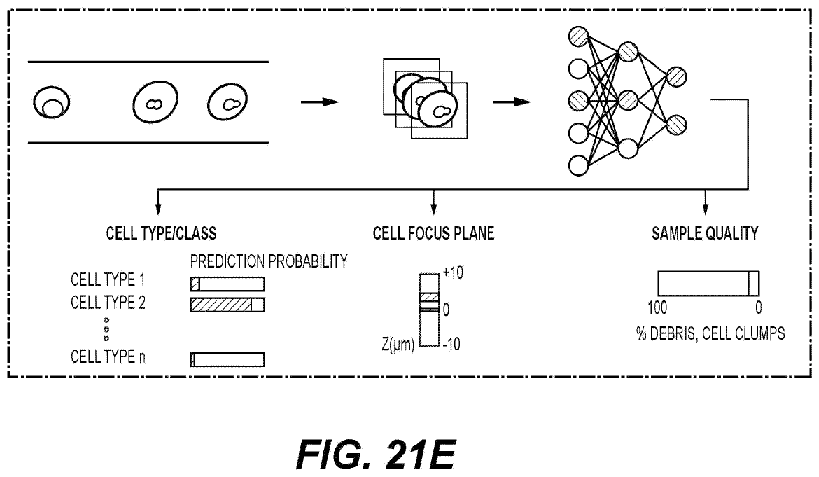

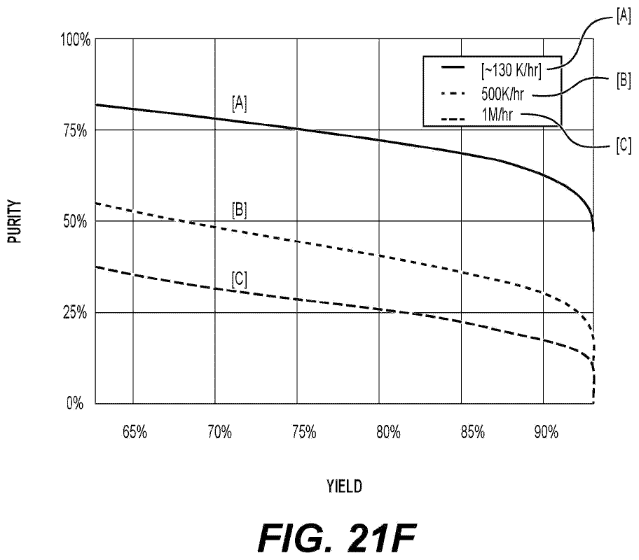

FIGS. 21A-21F schematically illustrate an example system for classifying and sorting one or more cells. The platform as disclosed herein may allow for the input and flow of cells in suspension with confinement along a single lateral trajectory to obtain a narrow band of focus across the z-axis (FIGS. 21A-21E). FIG. 21A shows the microfluidic chip and the inputs and output of the sorter platform according to one example of the present disclosure. Cells in suspension and sheath fluid are inputted, along with run parameters entered by the user: target cell type(s) and a cap on the number of cells to sort, if sorting is of interest. Upon run completion, the system generates reports of the sample composition (number and types of all of the processed cells) and the parameters of the run, including: length of run, number of analyzed cells, quality of imaging, quality of the sample. If sorting option is selected, it outputs isolated cells in a reservoir on the chip as well as a report of the number of sorted cells, purity of the collected cells and yield of the sort. Referring to FIG. 21B, a combination of hydrodynamic focusing and inertial focusing is used to focus the cells on a single z plane and a single lateral trajectory. Referring to FIGS. 21C and 21D, the diagram shows the interplay between different components of the software (FIG. 21C) and hardware pieces (FIG. 21D). The classifier is blown up in FIG. 21E, depicting the process of image collection, and automated real-time assessment of single cells in flow. After the images are taken, individual cell images are cropped using an automated object detection module, the cropped images are then run through a deep neural networks model trained on the relevant cells. For each image, the model generates a prediction vector over the available cell classes and an inference will be made according to a selection rule (e.g., argmax). The model may also infer the z focusing plane of the image. The percentage of debris and cell clumps may also be predicted by the neural network model as a proxy for “sample quality”. FIG. 21F shows an example performance of sorting. In this figure, the tradeoff between purity and yield is shown in three different modes, for profiling as sorting of 130,000 [A], 500,000 [B] or 1,000,000 [C] cells within one hour.

Using a combination of hydrodynamic and inertial focusing, the platform may collect ultra high-speed bright-field images of cells as they pass through the imaging zone of the microfluidic chip (FIGS. 21A and 21B). In order to capture the single cell images for processing, an automated object detection module may be incorporated to crop each image centered around the cell, before feeding the cropped images into a deep convolutional neural network (CNN) based on Inception architecture, which is trained on images of relevant cell types. In addition to classifying cells into categories of interest, the CNN may be trained to assess the focus of each image (in Z plane) and identify debris and cell clusters, thus providing information to assess sample quality (FIG. 21E). A feedback loop may be engineered so that the CNN inferred cell type is used in real time to regulate pneumatic valves for sorting a cell into either the positive reservoir (cell collection reservoir) for a targeted category of interest or a waste outlet (FIG. 21A). Sorted cells in the reservoir may then be retrieved for downstream processing and molecular analysis.

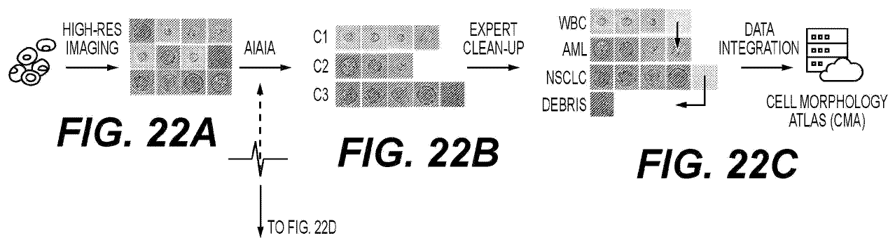

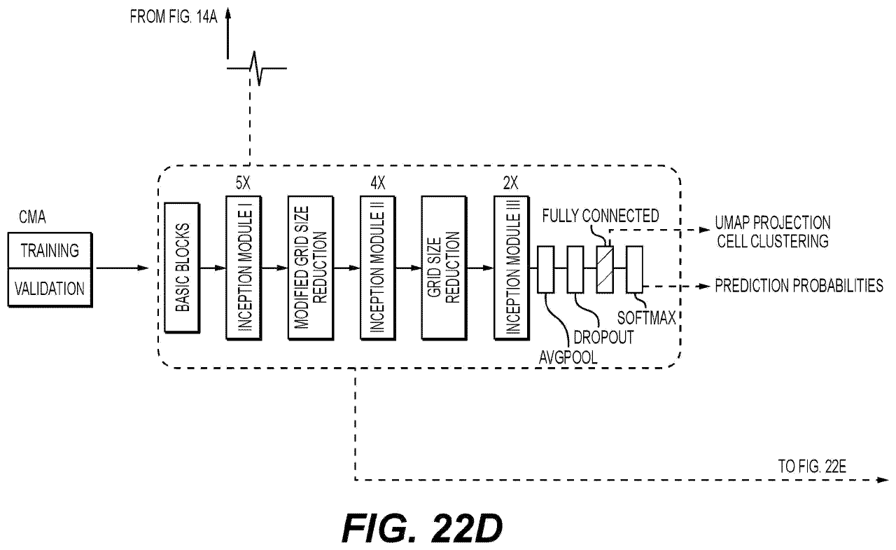

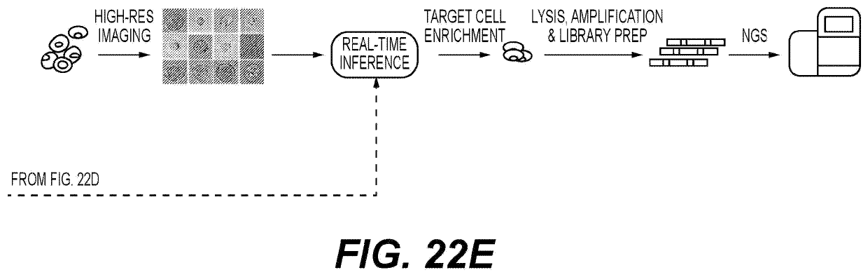

FIGS. 22A-22E schematically illustrate operations that may be performed in an example method. FIG. 22A shows high resolution images of single cells in flow are stored. Referring to FIG. 22B, AIAIA (AI Assisted Image Annotation) is used to cluster individual cell images into morphologically similar groups of cells. In some examples, a user uses the labeling tool to adjust and batch-label the cell clusters. In the nonlimiting example shown, one AML cell is mis-clustered into a group of WBC cells and an image showing a cell clump (debris) is mis-clustered in a NSCLC cell group. These errors are corrected by an “Expert clean-up” step. Referring to FIG. 22C, the annotated cells are then integrated into a Cell Morphology Atlas (CMA). Referring to FIG. 22D, the CMA is used to generate both training and validation sets of the next generation of the models. Referring to FIG. 22E, during a sorting experiment, the pre-trained model shown in FIG. 22D is used to infer the cell type (class) in real-time. The enriched cells are retrieved from the device. The retrieved cells are further processed for molecular profiling.

The platform may be run in multiple different modes. In the training/validation mode (FIGS. 22A to 22C), the collected images of a sample may be fed to the AI-Assisted Image Annotation (AIAIA), which may be configured to use unsupervised learning to group cells into morphologically distinct sub-clusters. Using AIAIA, a user may clean up the sub-clusters by removing cells that are incorrectly clustered and annotates each cluster based on a predefined annotation schema. The annotated cell images are then integrated into the Cell Morphology Atlas (CMA), a growing database of expert-annotated images of single cells. The CMA is broken down into training and validation sets and is used to train and evaluate CNN models aimed at identifying certain cell types and/or states. Under the analysis mode (FIG. 22D), the collected images are fed into models that had been previously trained using the CMA, and a report is generated demonstrating the composition of the sample of interest. A UMAP visualization is used to depict the morphometric map of all the single cells within the sample. A set of prediction probabilities is also generated showing the classifier prediction of each individual cell within the sample belonging to every predefined cell class within the CMA. In the sorting mode (FIG. 22E), the collected images are passed to the CNN in real-time and a decision is made on the fly to assign each single cell to one of the predefined classes within the CMA. Based on the class of interest, the target cells may be sorted in real-time and are outputted for downstream molecular assessment, such as next-generation sequencing (NGS), as illustrated in FIG. 22E.

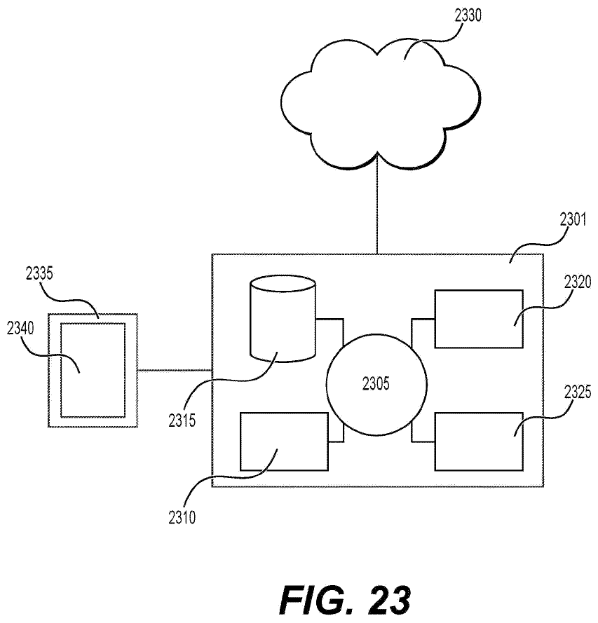

FIG. 23 shows a computer system that is programmed or otherwise configured to implement methods provided herein. For example, the present disclosure provides computer systems that are programmed to implement methods of the disclosure. FIG. 23 shows a computer system 2301 that is programmed or otherwise configured to capture and/or analyze one or more images of the cell. The computer system 2301 may regulate various aspects of components of the cell sorting system of the present disclosure, such as, for example, the pump, the valve, and the imaging device. The computer system 2301 may be an electronic device of a user or a computer system that is remotely located with respect to the electronic device. The electronic device may be a mobile electronic device.

The computer system 2301 includes a central processing unit (CPU, also “processor” and “computer processor” herein) 2305, which may be a single core or multi core processor, or a plurality of processors for parallel processing. The computer system 2301 also includes memory or memory location 2310 (e.g., random-access memory, read-only memory, flash memory), electronic storage unit 2315 (e.g., hard disk), communication interface 2320 (e.g., network adapter) for communicating with one or more other systems, and peripheral devices 2325, such as cache, other memory, data storage and/or electronic display adapters. The memory 2310, storage unit 2315, interface 2320 and peripheral devices 2325 are in communication with the CPU 2305 through a communication bus (solid lines), such as a motherboard. The storage unit 2315 may be a data storage unit (or data repository) for storing data. The computer system 2301 may be operatively coupled to a computer network (“network”) 2330 with the aid of the communication interface 2320. The network 2330 may be the Internet, an internet and/or extranet, or an intranet and/or extranet that is in communication with the Internet. The network 2330 in some cases is a telecommunication and/or data network. The network 2330 may include one or more computer servers, which may enable distributed computing, such as cloud computing. The network 2330, in some cases with the aid of the computer system 2301, may implement a peer-to-peer network, which may enable devices coupled to the computer system 2301 to behave as a client or a server.

The CPU 2305 may execute a sequence of machine-readable instructions, which may be embodied in a program or software. The instructions may be stored in a memory location, such as the memory 2310. The instructions may be directed to the CPU 2305, which may subsequently program or otherwise configure the CPU 2305 to implement methods of the present disclosure. Examples of operations performed by the CPU 2305 may include fetch, decode, execute, and writeback.

The CPU 2305 may be part of a circuit, such as an integrated circuit. One or more other components of the system 2301 may be included in the circuit. In some cases, the circuit is an application specific integrated circuit (ASIC).

The storage unit 2315 may store files, such as drivers, libraries and saved programs. The storage unit 2315 may store user data, e.g., user preferences and user programs. The computer system 2301 in some cases may include one or more additional data storage units that are external to the computer system 2301, such as located on a remote server that is in communication with the computer system 2301 through an intranet or the Internet.

The computer system 2301 may communicate with one or more remote computer systems through the network 2330. For instance, the computer system 2301 may communicate with a remote computer system of a user. Examples of remote computer systems include personal computers (e.g., portable PC), slates, or tablets (e.g., Apple® iPad, Samsung Galaxy Tab), telephones, Smart phones (e.g., Apple® iphone, Android-enabled device, Blackberry®), or personal digital assistants. The user may access the computer system 2301 via the network 2330.

Methods as described herein may be implemented by way of machine (e.g., computer processor) executable code stored on an electronic storage location of the computer system 2301, such as, for example, on the memory 2310 or electronic storage unit 2315. The machine executable or machine readable code may be provided in the form of software. During use, the code may be executed by the processor 2305. In some cases, the code may be retrieved from the storage unit 2315 and stored on the memory 2310 for ready access by the processor 2305. In some situations, the electronic storage unit 2315 may be precluded, and machine-executable instructions are stored on memory 2310.

The code may be pre-compiled and configured for use with a machine having a processor adapted to execute the code, or may be compiled during runtime. The code may be supplied in a programming language that may be selected to enable the code to execute in a pre compiled or as-compiled fashion.

Examples of the systems and methods provided herein, such as the computer system 2301, may be embodied in programming. Various aspects of the technology may be thought of as “products” or “articles of manufacture” typically in the form of machine (or processor) executable code and/or associated data that is carried on or embodied in a type of machine readable medium. Machine-executable code may be stored on an electronic storage unit, such as memory (e.g., read-only memory, random-access memory, flash memory) or a hard disk.

“Storage” type media may include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media (e.g., computer-readable media) include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2301 may include or be in communication with an electronic display 2335 that comprises a user interface (UI) 2340 for providing, for example, the one or more images of the cell that is transported through the channel of the cell sorting system. In some cases, the computer system 2301 may be configured to provide a live feedback of the images. Examples of UIs include, without limitation, a graphical user interface (GUI) and web-based user interface.

Methods and systems of the present disclosure may be implemented by way of one or more algorithms. An algorithm may be implemented by way of software upon execution by the central processing unit 2305. The algorithm may include, for example, the human foundation model.

### NON-LIMITING WORKING EXAMPLES

The following examples are intended to be purely illustrative, and not limiting of the present subject matter.

### Example 1—Evaluation of the Human Foundation Model Using Different Cell Lines

Cancer cells lines A375 and Caov-3, and immune cell line Jurkat were used to evaluate the classification performance of the human foundation model. Polystyrene beads with a size of 6 micrometers (μm) were used as control. The cell lines and polystyrene beads were imaged using the microfluidic platform (e.g., REM-I platform) as described herein and combined in silico to evaluate the performance of the human foundation model. The human foundation model processed the images of the cell lines and polystyrene beads, extracted deep learning and morphometric features. These features were standardized and projected into a lower dimensional principal components analysis (PCA) basis. Nearest neighbors were computed in the PCA space, then used to compute 2D Uniform Manifold Approximation and Projections (UMAP). Table 1 (above) is a panel of deep learning derived features generated using the DL model of the human foundation model and used in the present examples. Table 2 (above) is a panel of morphometric features generated using the computer vision model of the human foundation model and used in the present examples. It should be noted that the number and types of features listed in Tables 1 and 2 are provided only as examples without limiting the scope of the present disclosure. More and/or different features may be included. This example illustrates generated and extracted features using the human foundation model and computer vision model, including aspects that may be referred to as blobs or granules.

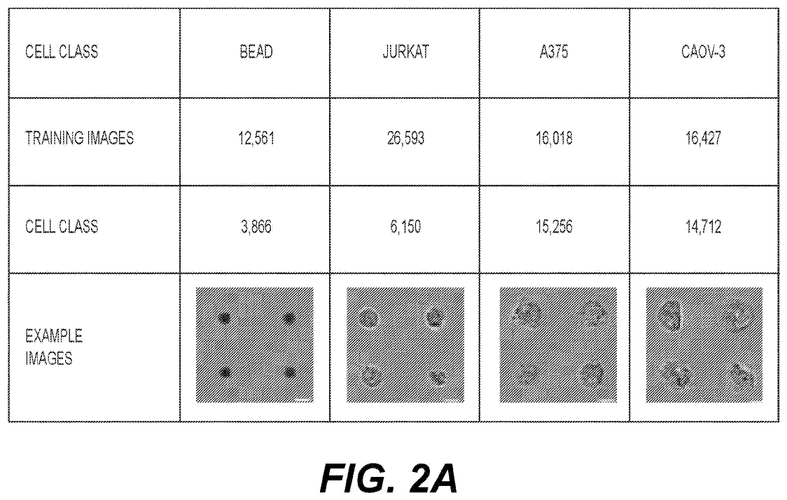

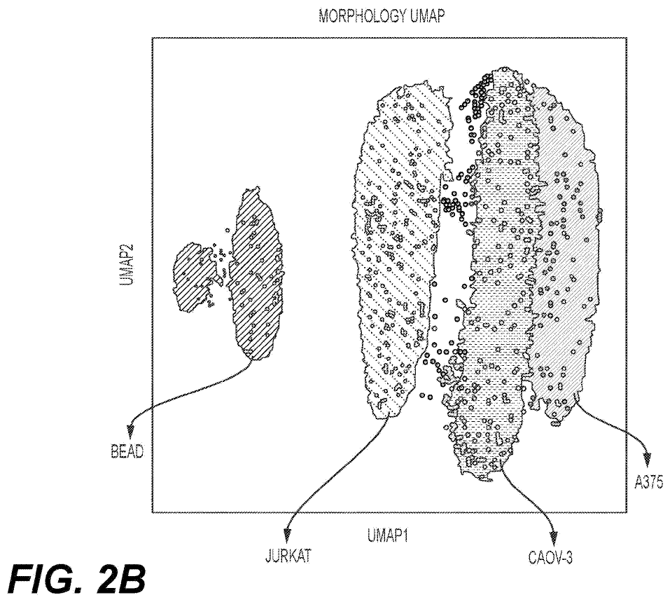

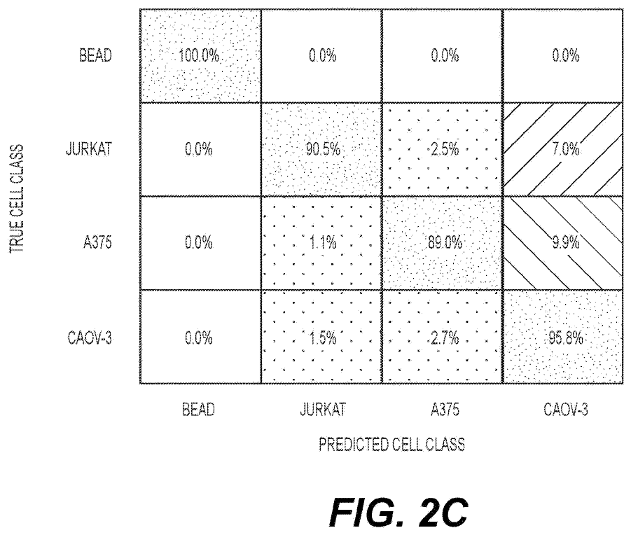

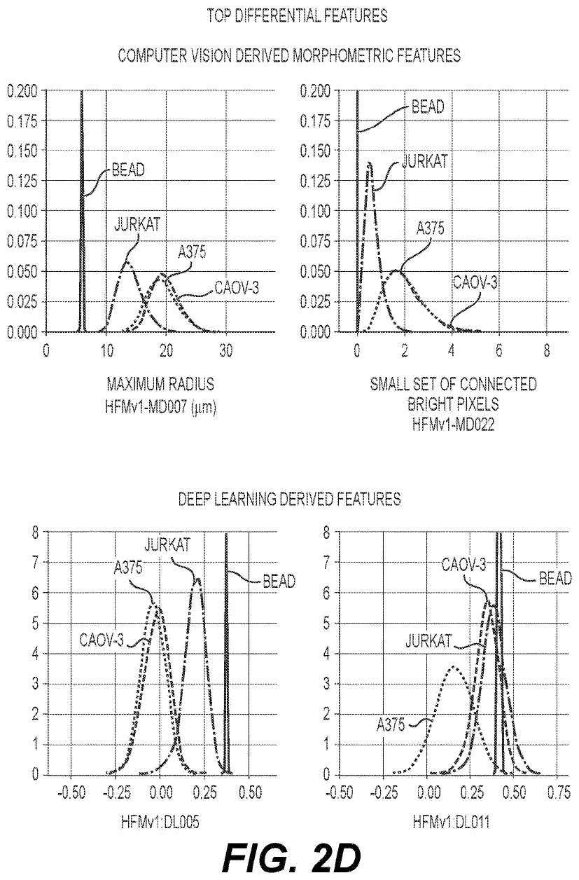

FIG. 2A illustrates cell classes, numbers of images used as training dataset to train a classifier using features extracted using the human foundation model, numbers of images processed by the human foundation model as test dataset, and corresponding representative cell images, in accordance with some examples of the present disclosure. A scale bar of 10 μm is shown on the representative cell images.

FIG. 2B illustrates a morphology UMAP of different cell lines and polystyrene beads as control, in accordance with some examples of the present disclosure. The morphology UMAP shows a clear separation between polystyrene beads and the cell lines. For different cell line populations, the morphology UMAP of the Jurkat immune cell population is clearly distinct from the cancer cell lines A375 and Caov-3, suggesting that the immune and cancer lines are morphologically distinct. The two cancer lines A375 and Caov-3 have an overlap.

FIG. 2C illustrates a confusion matrix between predicted cell classes classified using features extracted using the human foundation model and actual cell classes, in accordance with some examples of the present disclosure. As illustrated, the human foundation model predicts cell classes with a high accuracy. The accuracy for predicting the Jurkat cell line, A375 cell line, and Caov-3 cell line is 90.5%, 89%, and 95.8%, respectively. The accuracy for predicting polystyrene beads is 100%.

FIG. 2D illustrates density plots of four differential features generated by the human foundation model for different cell lines and polystyrene beads as control. As illustrated, the differential features comprise computer vision derived morphometric features in the top row of FIG. 2D, including maximum radius (“HFMv1: MD007” on the top left panel), and small set of connected bright pixels (“HFMv1: MD022” on the top right panel). The differential features also comprise deep learning derived features in the bottom row of FIG. 2D (“HFMv1: DL005” and “HFMv1: DL011”). Interestingly, the differential features of A375 and Caov-3 cancer cell lines are nearly identical. For example, the size by maximum radius (“HFMv1: MD007” on the top left panel), small set of connected bright pixels (“HFMv1: MD022” on the top right panel), and deep learning feature 5 (“HFMv1: DL005” on the bottom left panel) for the two cancer cell lines are substantially similar. The similarity indicates that cell features other than size may contribute to differentiating the A375 and Caov-3 cancer cell lines, for example, deep learning feature (“HFMv1: DL011” on the bottom right panel).

### Example 2—System for Cell Morphology Analysis

Table 3 in this example lists parameters and specifications of an example system such as described with reference to FIGS. 3-5 (e.g., The Deepcell® REM-I system by Deepcell, Inc., Menlo Park) for cell morphology analysis as well as image analysis generally, cell sorting, and other operations described herein. Table 4 lists the example components of one example system. From this example, it may be understood that the present system may be constructed using commercially available components.

TABLE 3
Parameters and specifications of REM-I
system for cell morphology analysis.

| Category | Parameter | Specification |
|---|---|---|
| Facilities | Instrument dimensions | H: 29.5 in/75 cm |
| | | W: 35.5 in/90 cm |
| | | D: 29.5 in/75 cm |
| | Included ancillary equipment | Computer tower |
| | | Monitor |
| | | Keyboard |
| | | Mouse |
| | Electrical | 3 × 100-240 V |
| | | surge-protected outlets |
| | Network connection | 1 Gbps ethernet with >150 |
| | | Mbps upload bandwidth |
| | Clean dry air connection | 0.55-0.72 MPa/80-105 psi |
| | Temperature operation ranges | 59-86° F./15-30° C. |
| | Operating relative | 15-70, non-condensing |
| | humidity (%) | |
| Instrument | Input cell size (pm) | 6-25 |
| | Output cell viability | >95* |
| | (% of input viability) | |
| | Output collection | 6x positive outlet wells |
| | | 1x negative outlet tube |
| | | 1x waste bottle |
| Instrument | Positive outlet capacity | Up to 3,000 |
| | (cells/well) | |
| | Recommended run time (min) | Live cells: Up to 180 |
| | | Fixed cells: Up to 600 |
| | Image resolution (pm/pixel) | 0.16 |
| | Image size (pixels) | 256 × 256 |
| | Imaging throughput (events/s) | Up to 1,000 |
| | Sorting throughput (cells/s) | Up to 30 |

*in Table 3 denotes the specification is dependent on sample characteristics and/or sorting configurations.

TABLE 4
Components of the REM-I system.

| | Description |
|---|---|
| REM-I Instrument | Microfluidic instrument |
| REM-I Imaging Kit | Reagents and consumables |
| | for imaging workflow |
| REM-I Sorting Kit | Reagents and consumables |
| | for imaging plus sorting |
| | workflow |
| Human Foundation | Artificial intelligence |
| Model (HFM) | (AI) model for high-dimensional |
| | single-cell morphology analysis |
| Data Suite | Data suite for visualizing, |
| | analyzing, and storing data |

### Example 3—Characterization of Tumor Cell Population Composition by Morphology

This example evaluated the performance of the cell morphology profiling platform as described herein in differentiating different types of cells. Melanoma lesions are generally composed of primary tumor cells as well as a diverse set of immune cells in various activation states. To simulate these tumors, an in-silico mixture of cell types was generated. The mixture of cell types, typically represented in solid tumors, comprised human melanoma cell lines (e.g., SK-MEL-1, SK-MEL-3, MNT-1), in vitro activated T cells from peripheral blood mononuclear cells (PBMCs), plasma cells from purified bone marrow, stromal cells from patient lymph nodes, and CD45+ immune cells (e.g., activated T cells, T cells, B cells, and NK cells), and macrophages isolated from metastatic melanoma biopsies.

The mixture of cell types was loaded onto the microfluidic platform. A total of 2.12×10⁶ cell images were captured. The human foundation model analyzed the cell images and extracted deep learning and morphometric features for embedding analysis. The features were standardized and projected into a lower dimensional principal component analysis (PCA) basis. Nearest neighbors were computed in the PCA space, and were used to identify clusters via e.g., Leiden algorithm and compute 2D Uniform Manifold Approximation and Projections (UMAP).

FIG. 8A illustrates an example morphology UMAP from cell image feature embeddings colored by cell types, in accordance with some implementations of the present disclosure. The cells were a heterogeneous collection of melanoma, immune, and stromal cells derived from cell lines and patient biopsies. As illustrated, melanoma cells were morphologically distinct. The cluster corresponding to the melanoma cells was separate from non-tumor cells.

FIG. 8B illustrates an example morphology UMAP colored by clusters imputed using Leiden algorithm, with randomly selected representative images from each cluster shown, in accordance with some implementations of the present disclosure. As illustrated, tumor cell lines SK-MEL-1 and SK-MEL-3 (cluster 10) are distinct from MNT-1 cells (cluster 3). For example, tumor cell lines SK-MEL-1 and SK-MEL-3 (cluster 10) exhibit a smoother appearance, whereas MNT-1 cells (cluster 3) show higher granularity. Furthermore, distinct immune cell types are variably located in the morphology UMAP, indicating cells have subtle but separable morphologies. For example, larger immune cells with more granular features (e.g., macrophages) are clustered toward the top of the morphology UMAP, while smaller cells with no granularity (e.g., activated T cells and plasma cells) are located in the lower clusters of the UMAP. Together, FIGS. 8A and 8B suggest the platform for cell morphology profiling may differentiate cell types represented in melanoma tumors based solely on multi-dimensional morphological profiles. The cell type differentiation includes differentiating tumor versus non-tumor cells, activated versus quiescent lymphocytes, and different immune cells (e.g., plasma cells, macrophages, and lymphocytes) with varying granularity features. From this example, it may be understood that the present platform may be used to differentiate different cell types from one another.

### Example 4—Computer Vision Morphometrics Reveals Differential Cell Features in Melanoma Cell Lines

Skin and hair pigmentation is the result of melanosome melanin biosynthesis in epidermal melanocytes. The multi-step melanin biosynthesis process is highly regulated, and has recently been implicated in melanoma progression. Despite the implications of melanin biosynthesis with melanoma and melanoma pathogenesis, current technologies rely on pathway biomarkers to measure pigmentation levels rather than a direct quantification of melanin granules in melanocytes. It is challenging to non-destructively sort cells with pigmentation. One option is to utilize intracellular biomarkers followed by FACS. However, this method is not commonly used and may render cells incompatible for additional functional studies.

Example 4 evaluated the performance of the platform as described herein in differentiating melanoma cell features. The data suite was used to analyze the cell images and isolate three established melanoma cell lines with varying degrees of pigmentation from the larger dataset as shown in FIGS. 8A and 8B. The human foundation model was used to extract pigmentation features.

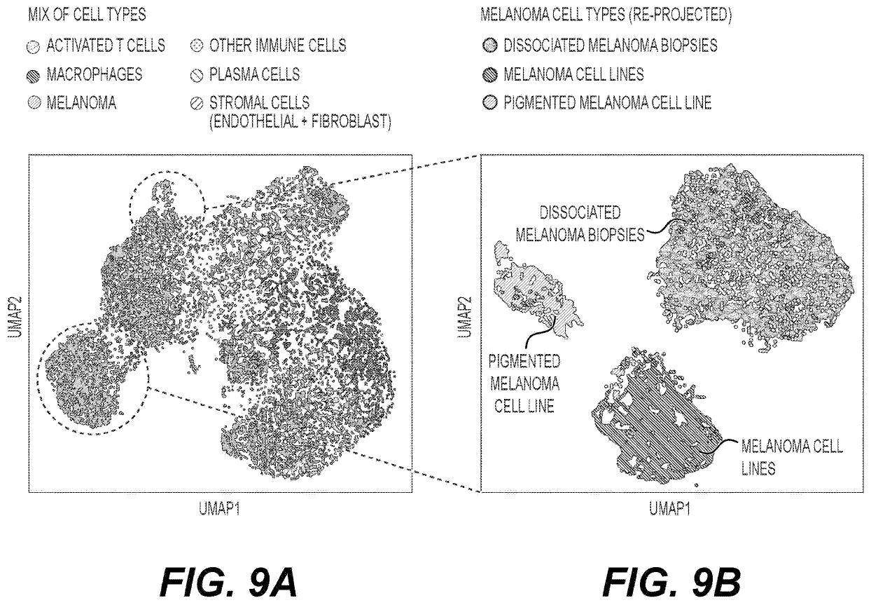

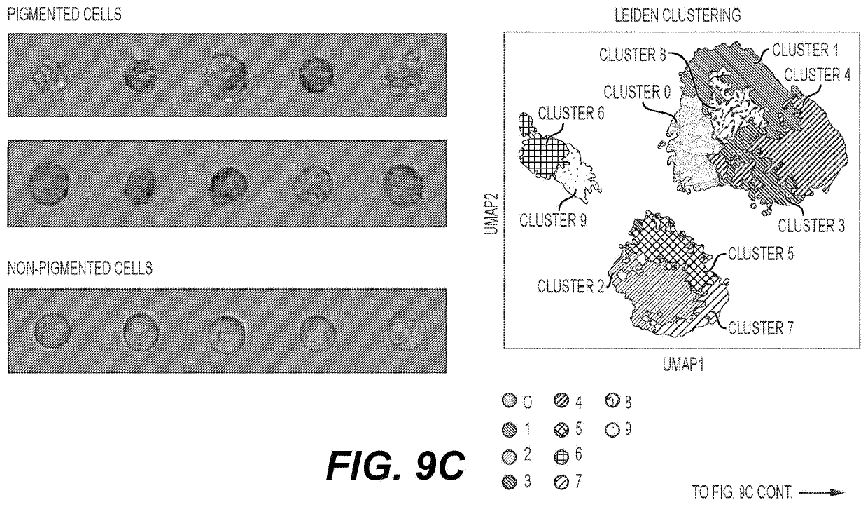

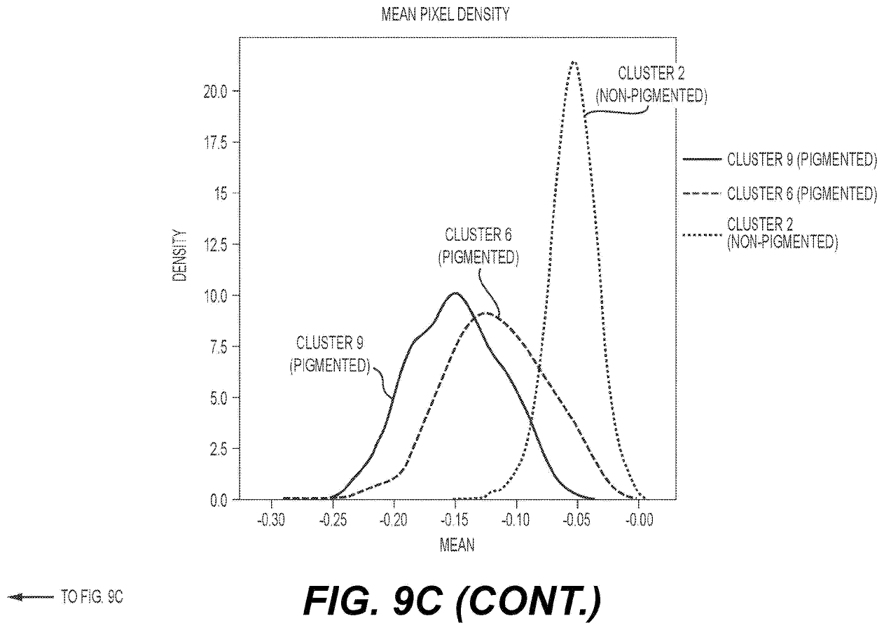

FIG. 9A illustrates an example morphology UMAP of a heterogeneous collection of melanoma cell lines and immune/stromal cells derived from patient biopsies, in consistency with FIG. 8A, in accordance with some implementations of the present disclosure. FIG. 4B illustrates a re-projected morphology UMAP using filtered data from FIG. 9A showing only melanoma cells colored by cell lines, in accordance with some implementations of the present disclosure. As shown in FIGS. 9A and 9B, pigmented melanoma cells (e.g., MNT-1) are morphologically distinct and clustered separately from other melanoma cells (e.g., SK-MEL-1 and SK-MEL-3) with low levels of melanin.

FIG. 9C illustrates an example morphology UMAP colored by clusters imputed using Leiden algorithm, with randomly selected representative images from each cluster shown and pixel density plot of three selected clusters, in accordance with some implementations of the present disclosure. The left panel of FIG. 9C shows representative images of pigmented cells in clusters 6 and 9, respectively, as well as representative images of non-pigmented cells in cluster 2. The density plot in the right panel of FIG. 9C shows the mean pixel intensity of clusters 2, 6, and 9, respectively. A lower mean value (i.e., darker pixels) is linked to more pigmentation. The morphometric analysis further demonstrates the population of highly pigmented cells exhibits heterogeneity with differing levels of pigmentation, as shown by the quantification of the morphological feature. These results indicate the platform for cell morphology profiling as described herein may clearly detect pigmented cells and different levels of pigmentation, and allow for subsequent cell sorting based on user interest for downstream studies (e.g., cell culture, drug studies, and treatment response).

### Example 5—User-Defined Multi-Dimensional Morphology Clusters have Distinct Molecular Profiles

Lung cancer is highly heterogeneous, and generally divided into two groups: small cell lung cancer (SCLC) and non-small cell lung cancer (NSCLC). SCLC makes up approximately 15% of lung cancer, while NSCLC comprises 85%. This example evaluated the performance of the platform for cell morphology profiling in NSCLC, based on pure cell populations derived from dissociated tumor cells (DTC) biopsies. User-defined clusters were sorted and subjected to copy number variation (CNV) analysis and bulk RNA-Sequencing (RNA-Seq).

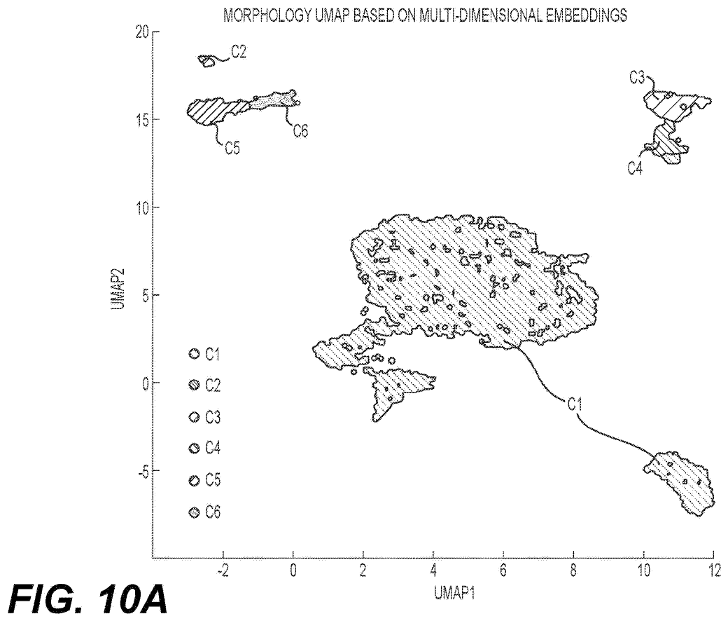

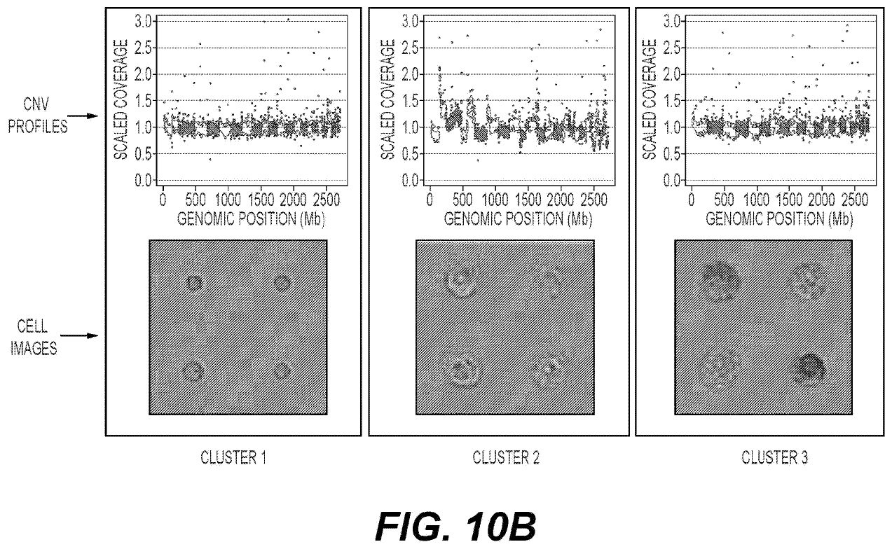

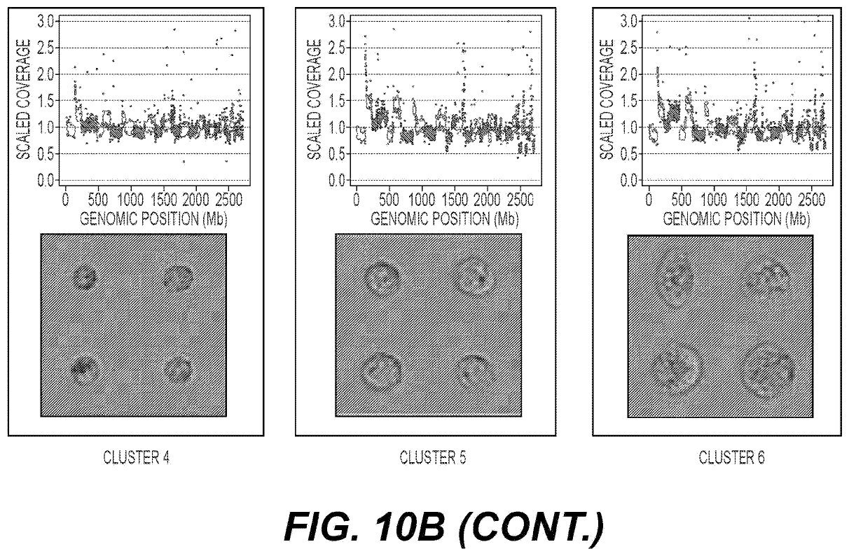

FIGS. 10A and 10B show example morphologically distinct cell clusters from human NSCLC tissue. In particular, FIG. 10A illustrates a morphology UMAP of cells based on multi-dimensional embeddings where the cells resided in a NSCLC DTC biopsy sample, in accordance with some implementations of the present disclosure. Six morphologically distinct clusters (i.e., cluster 1, 2, 3, 4, 5, and 6) were identified and colored by the assigned cluster number. FIG. 10B illustrates six morphologically distinct clusters isolated by the platform as described herein via user-defined sorting and processed for CNV profiling, in accordance with some implementations of the present disclosure. As illustrated, sorted morphology clusters exhibited distinct CNV patterns, consistent with cancer cell profiles in clusters 2, 5, and 6.

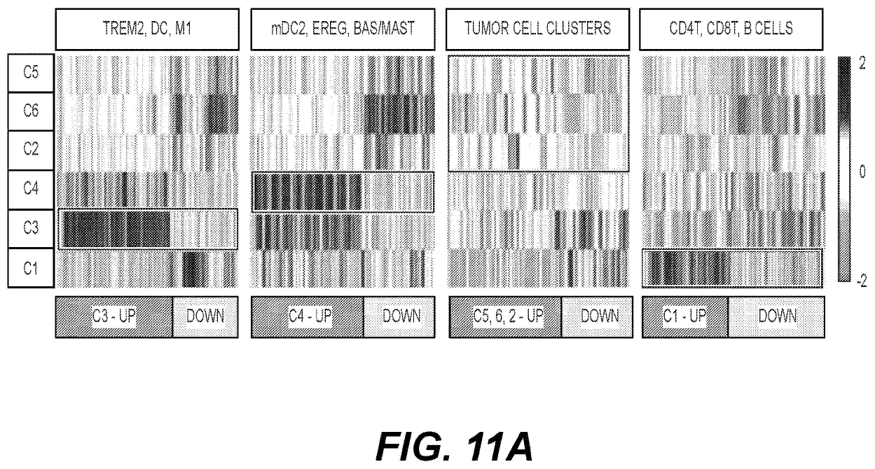

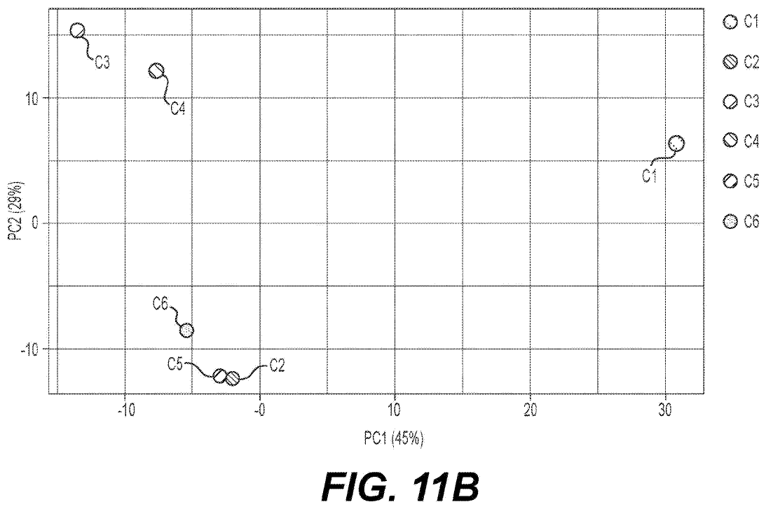

FIGS. 11A and 11B demonstrate example transcriptomic characterization of morphology clusters. In particular, FIG. 11A illustrates bulk RNA-sequence analysis of cells resided in a NSCLC DTC biopsy sample, in accordance with some implementations of the present disclosure. FIG. 11B illustrates principal component analysis (PCA) performed on each morphology cluster, in accordance with some implementations of the present disclosure. As illustrated, isolated morphology clusters are viable and show high concordance with CNV and bulk RNA-Seq expression profiles. Notably, sorted morphology clusters comprise increased populations of respective cell classes. For example, as illustrated in FIGS. 11A and 11B, clusters 2, 5, and 6 show enrichment of tumor cells while clusters 1, 3, and 4 show enrichment of immune cells, indicating morphology may be reflective of cell identity and function. The detection of multiple cancer cell clusters based on multi-dimensional morphology may be reflective of the heterogeneous nature of the tumor sample, which may not have been revealed by a constrained panel of biomarkers. This example demonstrates cell morphology may be leveraged to characterize and isolate cells of interest based on morphology and enable integrative multi-omics analysis workflows.

While certain examples of the present subject matter have been shown and described herein, it will be obvious to those skilled in the art that such examples are purely illustrative. It is not intended that the invention be limited by the specific examples provided within the specification. While nonlimiting examples of the invention has been described with reference to the aforementioned specification, the descriptions and illustrations of the examples herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the examples described herein may be employed in practicing the invention. It is therefore contemplated that the claims shall also cover any such alternatives, modifications, variations, or equivalents.

1.-84. (canceled)

85. A method of processing images, the method comprising:
providing one or more cell images to a plurality of encoders comprising a machine learning encoder and a computer vision encoder;
extracting a set of machine learning (ML)-based features from the one or more cell images using the machine learning encoder, and extracting a set of cell morphometric features from the one or more cell images using the computer vision encoder; and
using the machine learning encoder and the computer vision encoder to respectively encode the set of ML-based features and the set of cell morphometric features into a plurality of multi-dimensional vectors that represent morphology of at least one cell in the one or more cell images.

86. The method of claim 85, wherein the machine learning encoder comprises a deep learning encoder.

87. The method of claim 85, wherein the ML-based features are not human-interpretable.

88. The method of claim 85, wherein cells in the one or more cell images are unstained.

89. The method of claim 85, wherein the machine learning encoder uses a convolutional neural network or a vision transformer.

90. The method of claim 85, wherein the machine learning encoder extracts n ML-based features, wherein the computer vision encoder extracts m cell morphometric features, wherein the multi-dimensional vectors have n+m dimensions, and wherein n and m are positive integers.

91. The method of claim 85, wherein the ML-based features are orthogonal to one another.

92. The method of claim 85, wherein the cell morphometric features comprise position features, cell shape features, pixel intensity features, texture features, focus features, or any combination thereof.

93. The method of claim 85, wherein the plurality of multi-dimensional vectors comprises different numbers of the ML-based features and the cell morphometric features.

94. The method of claim 85, wherein the ML-based features are orthogonal to the cell morphometric features.

95. A method of processing a cell image, the method comprising:
using a machine learning encoder to extract a set of machine learning (ML)-based features from a cell image;
using a computer vision encoder to extract a set of cell morphometric features from the cell image; and
using the set of ML-based features and the set of cell morphometric features to generate a feature vector that represents morphology of the cell.

96. The method of claim 95, wherein the feature vector comprises a same number of the ML-based features and the cell morphometric features.

97. The method of claim 95, wherein the cell morphometric features are human-interpretable.

98. The method of claim 97, wherein the cell morphometric features comprise cell position features, cell shape features, pixel intensity features, texture features, focus features, or any combination thereof.

99. The method of claim 98, wherein the position features comprise centroid X axis or centroid Y axis,
wherein the cell shape features are selected from the group consisting of area, perimeter, maximum caliper distance, minimum caliper distance, maximum radius, minimum radius, long ellipse axis, short ellipse axis, ellipse elongation, ellipse similarity, roundness, circle similarity, and convex shape,
wherein the pixel intensity features are selected from the group consisting of mean pixel intensity, standard deviation of pixel intensity, pixel intensity 25th percentile, pixel intensity 75th percentile, positive fraction, and negative fraction, and
wherein the texture features are selected from the group consisting of small set of connected bright pixels, integral; small set of connected dark pixels, integral; large set of connected bright pixels, integral; large set of connected dark pixels, integral; image moments; local binary patterns—center; local binary patterns—periphery; image sharpness; image focus; ring width; and ring intensity.

100. The method of claim 95, wherein the cell image is a brightfield cell image.

101. The method of claim 95, wherein the computer vision encoder uses a human-constructed algorithm.

102. The method of claim 95, wherein the machine learning encoder extracts n ML-based features, wherein the computer vision encoder extracts m cell morphometric features, wherein the feature vector has n+m dimensions, wherein each dimension of the n+m dimensions is an element of the feature vector, and wherein n and m are positive integers.

103. The method of claim 102, wherein the element is a numeric value.

104. The method of claim 95, wherein, within the feature vector, a number of the ML-based features differs from a number of the cell morphometric features.
